(19) United States
(12) Patent Application Publication
(10) Pub. No.: US 2014/0085418 A1
(43) Pub. Date: Mar. 27, 2014

(54) IMAGE PROCESSING DEVICE AND IMAGE PROCESSING METHOD

(71) Applicants: Yoshitomo Takahashi, Kanagawa (JP); Shinobu Hattori, Tokyo (JP)

(72) Inventors: Yoshitomo Takahashi, Kanagawa (JP); Shinobu Hattori, Tokyo (JP)

(73) Assignee: Sony Corporation, Tokyo (JP)

(21) Appl. No.: 14/116,400

(22) PCT Filed: May 1, 2012
(86) PCT No.: PCT/JP2012/061521

§ 371 Date: Nov. 8, 2013

(30) Foreign Application Priority Data
May 16, 2011 (JP) 2011-109800

(51) Int. Cl. H04N 7/32; H04N 7/36

(52) U.S. Cl. CPC H04N 19/00769; H04N 19/00587
USPC 348/43

(57) ABSTRACT

The present technology relates to an image processing device and image processing method whereby prediction efficiency of disparity prediction can be improved. A resolution converting device converts images of two viewpoints or more, out of images of three viewpoints or more, into a packed image, by performing packing following a packing pattern in which images of two viewpoints or more are packed into one viewpoint worth of image, in accordance with a predetermined encoding mode at the time of encoding an image to be encoded which is to be encoded. An encoding device generates a prediction image of the image to be encoded, by performing disparity compensation with the packed image as the image to be encoded or a reference image, and encodes the image to be encoded in the predetermined encoding mode, using the prediction image. The present technology can be applied to encoding and decoding of images of multiple viewpoints, for example.

### TECHNICAL FIELD

The present invention relates to an image processing device and image processing method, and relates to an image processing device and an image processing method enabling improvement of prediction efficiency of disparity prediction performed in encoding and decoding images with multiple viewpoints.

### BACKGROUND ART

Examples of encoding formats to encode images with multiple viewpoints, such as 3D (Dimension) images and the like include MVC (Multiview video Coding) which is an extension of AVC (Advanced Video Coding) (H.264/AVC), and so forth.

With MVC, images to be encoded are color images having values corresponding to light from a subject, as pixel values, with each color image of the multiple viewpoints being encoded, referencing color images of other viewpoints as well as to the color images of those viewpoints as necessary.

That is to say, with MVC, of the color images of the multiple viewpoints, the color image of one viewpoint is taken as a base view (Base View) image, and the color images of the other viewpoints are taken as non base view (Non Base View) images.

The base view color image is then encoded referencing only that base view color image itself, while the non base view color images are encoding referencing images of other views as necessary, besides the color image of that non base view.

That is to say, regarding the non base view color images, disparity prediction is performed as necessary, where a prediction image is generated referencing a color image of another view (viewpoint), and encoding is performed using that prediction image.

Now, as of recent, with regard to images of multiple viewpoints, there has been proposed a method to employ besides color images of each viewpoint, a disparity information image (depth image) having, as pixel values thereof, disparity information (depth information) relating to disparity for each pixel of the color images of the viewpoints, and encoding the color images of the viewpoints and the disparity information images of the viewpoints separately (e.g., see NPL 1).

### CITATION LIST

### Non Patent Literature

NPL 1: Draft Call for Proposals on 3D Video Coding Technology”, INTERNATIONAL ORGANISATION FOR STANDARDISATION ORGANISATION INTERNATIONALE DE NORMALISATION ISO/IEC JTC1/SC29/WG11 CODING OF MOVING PICTURES AND AUDIO, MPEG2010/N11679 Guangzhou, China, October 2010

### SUMMARY OF INVENTION

### Technical Problem

As described above, with images of multiple viewpoints, disparity prediction can be performed for an image of a certain viewpoint where an image of another viewpoint is referenced in encoding (and decoding) thereof, so prediction efficiency (prediction precision) of the disparity prediction affects encoding efficiency.

The present technology has been made in light of this situation, and aims to enable improvement in prediction efficiency of disparity prediction.

### Solution to Problem

An image processing device according to a first aspect of the present technology includes: a converting unit configured to convert images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded; a compensating unit configured to generate a prediction image of the image to be encoded, by performing disparity compensation with the packed image converted by the converting unit as the image to be encoded or a reference image; and an encoding unit configured to encode the image to be encoded in the encoding mode, using the prediction image generated by the compensating unit.

An image processing method according to the first aspect of the present technology includes the steps of: converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded; generating a prediction image of the image to be encoded, by performing disparity compensation with the packed image as the image to be encoded or a reference image; and encoding the image to be encoded in the encoding mode, using the prediction image.

With the first aspect such as described above, images of two viewpoints or more, out of images of three viewpoints or more, are converted into a packed image, by being packed following a packing pattern in which images of two viewpoints or more are packed into one viewpoint worth of image, in accordance with an encoding mode at the time of encoding an image to be encoded which is to be encoded. A prediction image of the image to be encoded is then generated by performing disparity compensation with the packed image as the image to be encoded or a reference image, and the image to be encoded is encoded in the encoding mode, using the prediction image.

An image processing device according to a second aspect of the present technology includes: a compensating unit configured to generate, by performing disparity compensation, a prediction image of an image to be decoded which is to be decoded, used to decode an encoded stream obtained by converting images of two viewpoints or more, out of images of viewpoints or more, into a packed image, by performing packing following a packing pattern in which images of two viewpoints or more are packed into one viewpoint worth of image, in accordance with an encoding mode at the time of encoding an image to be encoded which is to be encoded, generating a prediction image of the image to be encoded, by performing disparity compensation with the packed image as the image to be encoded or a reference image, and encoding the image to be encoded in the encoding mode, using the prediction image; a decoding unit configured to decode the encoded stream in the encoding mode, using the prediction image generated by the compensating unit; and an inverse converting unit configured to, in the event that the image to decode obtained by decoding the encoded stream is a packed image, perform inverse conversion of the packed image into the original images of two viewpoints or more by separating following the packing pattern.

An image processing method according to the second aspect of the present technology includes the steps of: generating, by performing disparity compensation, a prediction image of an image to be decoded which is to be decoded, used to decode an encoded stream obtained by converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded, generating a prediction image of the image to be encoded, by performing disparity compensation with the packed image as the image to be encoded or a reference image, and encoding the image to be encoded in the encoding mode, using the prediction image; decoding the encoded stream in the encoding mode, using the prediction image; and in the event that the image to decode obtained by decoding the encoded stream is a packed image, performing inverse conversion of the packed image into the original images of two viewpoints or more by separating following the packing pattern.

With the second aspect such as described above, a prediction image of an image to be decoded which is to be decoded is generated, by performing disparity compensation, the prediction image being used to decode an encoded stream obtained by converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded, generating a prediction image of the image to be encoded, by performing disparity compensation with the packed image as the image to be encoded or a reference image, and encoding the image to be encoded in the encoding mode, using the prediction image. The encoded stream is decoded in the encoding mode, using the prediction image, and in the event that the image to decode obtained by decoding the encoded stream is a packed image, inverse conversion is performed of the packed image into the original images of two viewpoints or more by separating following the packing pattern.

Note that the image processing device may be a standalone device, or may be an internal block configuring one device.

Also, the image processing device can be realized by causing a computer to execute a program, and the program can be provided by being transmitted via a transmission medium or recorded in a recoding medium.

### Advantageous Effects of Invention

According to the present invention, prediction efficiency of disparity prediction can be improved.

### BRIEF DESCRIPTION OF DRAWINGS

FIG. 1 is a block diagram illustrating a configuration example of an embodiment of a transmission system to which the present technology has been applied.

FIG. 2 is a block diagram illustrating a configuration example of a transmission device 11.

FIG. 3 is a block diagram illustrating a configuration example of a reception device 12.

FIG. 4 is a diagram for describing resolution conversion which a resolution conversion device 21C performs.

FIG. 5 is a block diagram illustrating a configuration example of the encoding device 22C.

FIG. 6 is a diagram for describing a picture reference when generating a prediction image (reference image) with MVC prediction encoding.

FIG. 7 is a diagram for describing an order of picture encoding (and decoding) with MVC.

FIG. 8 is a diagram for describing temporal prediction and disparity prediction performed at encoders 41 and 42.

FIG. 9 is a block diagram illustrating a configuration example of the encoder 42.

FIG. 10 is a diagram for describing macro block types in MVC (AVC).

FIG. 11 is a diagram for describing prediction vectors (PMV) in MVC (AVC).

FIG. 12 is a block diagram illustrating a configuration example of an inter prediction unit 123.

FIG. 13 is a block diagram illustrating a configuration example of a disparity prediction unit 131.

FIG. 14 is a block diagram illustrating a configuration example of a decoding device 32C.

FIG. 15 is a block diagram illustrating a configuration example of a decoder 212.

FIG. 16 is a block diagram illustrating a configuration example of an inter prediction unit 250.

FIG. 17 is a block diagram illustrating a configuration example of a disparity prediction unit 261.

FIG. 18 is a block diagram illustrating another configuration example of the transmission device 11.

FIG. 19 is a block diagram illustrating another configuration example of the reception device 12.

FIG. 20 is a diagram for describing resolution conversion which a resolution conversion device 321C performs, and inverse resolution conversion which an inverse resolution conversion device 333C performs.

FIG. 21 is a flowchart for describing processing of the transmission device 11.

FIG. 22 is a flowchart for describing processing of the reception device 12.

FIG. 23 is a block diagram illustrating a configuration example of an encoding device 322C.

FIG. 24 is a block diagram illustrating a configuration example of an encoder 342.

FIG. 25 is a diagram for describing resolution conversion SEI generated at a SEI generating unit 351.

FIG. 26 is a diagram describing values set to parameters num_views_minus_{—}1, view_id[i], frame_packing_info[i], frame_field_coding, and view_id_in_frame[i].

FIG. 27 is a diagram for describing disparity prediction of pictures (fields) of a packed color image performed by the disparity prediction unit 131.

FIG. 28 is a flowchart for describing encoding processing to encode a packed color image, which the encoder 342 performs.

FIG. 29 is a flowchart for describing disparity prediction processing which the disparity prediction unit 131 performs.

FIG. 30 is a block diagram illustrating a configuration example of a decoding device 332C.

FIG. 31 is a block diagram illustrating a configuration example of a decoder 412.

FIG. 32 is a flowchart for describing decoding processing which the decoder 412 performs to decode encoded data of a packing color image.

FIG. 33 is a flowchart for describing disparity prediction processing which the disparity prediction unit 261 performs.

FIG. 34 is a block diagram illustrating another configuration example of the encoding device 322C.

FIG. 35 is a block diagram illustrating a configuration example of an encoder 542.

FIG. 36 is a diagram for describing disparity prediction of pictures (fields) of a middle viewpoint color image performed by the disparity prediction unit 131.

FIG. 37 is a flowchart for describing encoding processing to encode a packed color image, which the encoder 542 performs.

FIG. 38 is a flowchart for describing disparity prediction processing which the disparity prediction unit 131 performs.

FIG. 39 is a block diagram illustrating a configuration example of the decoding device 332C.

FIG. 40 is a block diagram illustrating a configuration example of a decoder 612.

FIG. 41 is a flowchart for describing decoding processing to decode encoded data of a middle viewpoint color image, which the decoder 612 performs.

FIG. 42 is a flowchart for describing disparity prediction processing which the disparity prediction unit 261 performs.

FIG. 43 is a block diagram illustrating yet another configuration example of the transmission device 11.

FIG. 44 is a block diagram illustrating a configuration example of an encoding device 722C.

FIG. 45 is a block diagram illustrating a configuration example of an encoder 842.

FIG. 46 is a diagram for describing perspective and depth.

FIG. 47 is a block diagram illustrating a configuration example of an embodiment of a computer to which the present technology has been applied.

FIG. 48 is a diagram illustrating a schematic configuration example of a TV to which the present technology has been applied.

FIG. 49 is a diagram illustrating a schematic configuration example of a cellular telephone to which the present technology has been applied.

FIG. 50 is a diagram illustrating a schematic configuration example of a recording/playback device to which the present technology has been applied.

FIG. 51 is a diagram illustrating a schematic configuration example of an imaging apparatus to which the present technology has been applied.

### DESCRIPTION OF EMBODIMENTS

### Description of Depth Image

### Disparity Information Image in Present Specification

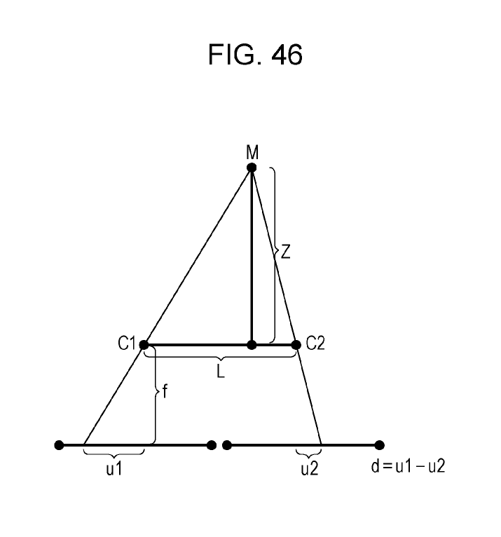

FIG. 46 is a diagram for describing disparity and depth.

As illustrated in FIG. 46, in the event that a color image of a subject M is to be shot by a camera c1 situated at a position C1 and a camera c2 situated at a position C2, depth Z which is the distance from the subject M in the depth direction from the camera c1 (camera c2) is defined with the following Expression (a).

Z=(L/d)×f (a)

Note that L is the distance between the position C1 and position C2 in the horizontal direction (hereinafter referred to as inter-camera distance). Also, d is a value obtained by subtracting a distance u2 of the position of the subject M on the color image shot by the camera c2, in the horizontal direction from the center of the color image, from a distance u1 of the position of the subject M on the color image shot by the camera c1, in the horizontal direction from the center of the color image, i.e., disparity. Further, f is the focal distance of the camera c1, with Expression (a) assuming that the focal distance of camera c1 and camera c2 are the same.

As illustrated in Expression (a), the disparity d and depth Z are uniquely convertible. Accordingly, with the Present Specification, an image representing disparity d of the two-viewpoint color image shot by camera c1 and camera c2, and an image representing depth Z, will be collectively referred to as depth image (disparity information image).

Note that it is sufficient for the depth image (disparity information image) to be an image representing disparity d or depth Z, and a value where disparity d has been normalized, a value where the inverse of depth Z, 1/Z, has been normalized, etc., may be used for pixel values of the depth image (disparity information image), rather than disparity d or depth Z themselves.

A value I where disparity d has been normalized at 8 bits (0 through 255) can be obtained by the following expression (b). Note that the number of bits for normalization of disparity d is not restricted to 8 bits, and may be another number of bits such as 10 bits, 12 bits, or the like.

$$\begin{matrix}[ Math . 4 ] & \\ I = \frac{255 \times ( d - {D}_{min} )}{{D}_{max} - {D}_{min}} & ( b )\end{matrix}$$

Note that in Expression (b), Dₘₐₓ is the maximal value of disparity d, and Dₘᵢₙ is the minimal value of disparity d. The maximum value Dₘₐₓ and the minimum value Dₘᵢₙ may be set in increments of single screens, or may be set in increments of multiple screens.

Also, a value y obtained by normalization of the inverse of depth Z, 1/Z, at 8 bits (0 through 255) can be obtained by the following expression (c). Note that the number of bits for normalization of inverse of depth Z, 1/Z, is not restricted to 8 bits, and may be another number of bits such as 10 bits, 12 bits, or the like.

$$\begin{matrix}[ Math . 5 ] & \\ y = 255 \times \frac{\frac{1}{Z} - \frac{1}{{Z}_{far}}}{\frac{1}{{Z}_{near}} - \frac{1}{{Z}_{far}}} & ( c )\end{matrix}$$

Note that in Expression (c), Z_{far} is the maximal value of depth Z, and Zₙₑₐᵣ is the minimal value of depth Z. The maximum value Z_{far} and the minimum value Zₙₑₐᵣ may be set in increments of single screens, or may be set in increments of multiple screens.

This, with the Present Specification, taking into consideration that disparity d and depth Z are uniquely convertible, an image having as the pixel value thereof the value I where disparity d has been normalized, and an image having as the pixel value thereof the a value y where 1/Z which is the inverse of depth Z has been normalized, will be collectively referred to as depth image (disparity information image). Here, we will say that the color format of the depth image (disparity information image) is YUV420 or YUV400, but those may be another color format.

Note that in the event of looking at the information of the value I or value y itself rather than the pixel value of the depth image (disparity information image), the value I or value y is taken as the depth information (disparity information). Further the value I or value y mapped is taken as a depth map.

### Embodiment of Transmission System to which Image Processing Device of Present Technology has been Applied

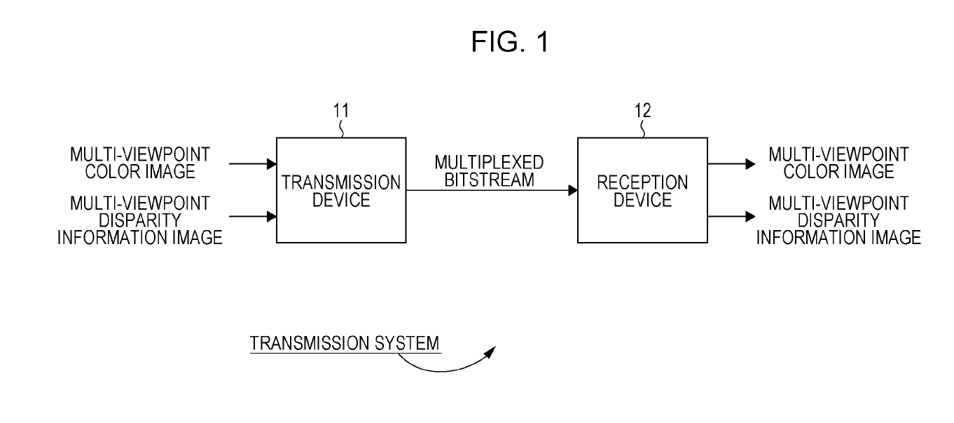

FIG. 1 is a block diagram illustrating a configuration example of an embodiment of a transmission system to which the present technology has been applied.

In FIG. 1, the transmission system has a transmission device 11 and a reception device 12.

The transmission device 11 is provided with a multi-viewpoint color image and a multi-viewpoint disparity information image (multi-viewpoint depth image).

Here, a multi-viewpoint color image includes color images of multiple viewpoints, and a color image of a predetermined one viewpoint of these multiple viewpoints is specified as being a base view image. The color images of the viewpoints other than the base view image are handled as non base view images.

A multi-viewpoint disparity information image includes a disparity information image of each viewpoint of the color images configuring the multi-viewpoint color image, with a disparity information image of a predetermined one viewpoint, for example, being specified as a base view image. The disparity information images of viewpoints other than the base view image are handled as non base view images in the same way as with the case of color images.

The transmission device 11 encodes and multiplexes each of the multi-viewpoint color images and multi-viewpoint disparity information images supplied thereto, and outputs a multiplexed bitstream obtained as a result thereof.

The multiplexed bitstream output from the transmission device 11 is transmitted via an unshown transmission medium, or is recorded in an unshown recording medium.

The multiplexed bitstream output from the transmission device 11 is provided to the reception device 12 via the unshown transmission medium or recording medium.

The reception device 12 receives the multiplexed bitstream, and performs inverse multiplexing on the multiplexed bitstream, thereby separating encoded data of the multi-viewpoint color images and encoded data of the multi-viewpoint disparity information images from the multiplexed bitstream.

Further, the reception device 12 decodes each of the encoded data of the multi-viewpoint color images and encoded data of the multi-viewpoint disparity information images, and outputs the multi-viewpoint color images and multi-viewpoint disparity information images obtained as a result thereof.

Now, MPEG3DV, of which a primary application is display of naked eye 3D (dimension) images which can be viewed with the naked eye, is being formulated as a standard for transmitting multi-viewpoint color images which are color images of multiple viewpoints, and multi-viewpoint disparity information images which are disparity information images of multiple viewpoints, for example.

With MPEG3DV, besides images (color images, disparity information images) of two viewpoints, there is discussion about transmission of images with three viewpoints or four viewpoints for example, greater than two viewpoints.

With naked eye 3D image (3D images which can be viewed without so-called polarized glasses) display, the greater the number of (image) viewpoints, the higher the quality of images that can be displayed, and the stronger the stereoscopic effect can be made to be. Accordingly, having a greater number of viewpoints is preferable from the perspective of image quality and stereoscopic effect.

However, increasing the number of viewpoints makes the amount of data handled at baseband to be immense.

That is to say, in the event of transmitting a so-called full-HD (High Definition) resolution image with color images and disparity information images of three viewpoints for example, the data amount thereof is six times that of the data amount of a full-HD 2D image (data amount of an image of one viewpoint).

There is, as a baseband transmission standard, HDMI (High-Definition Multimedia Interface) for example, but even the newest HDMI standard can only handle data amount equivalent to 4K (four times that of full HD), so color images and disparity information images of three viewpoints cannot be transmitted at baseband in the current state.

Accordingly, in order to transmit full-HD color images and disparity information images of three viewpoints at baseband, there is the need to reduce the resolution of the images at baseband for example, or the like, to reduce the data amount (at baseband) of the multi-viewpoint color images and multi-viewpoint disparity information images.

On the other hand, with the transmission device 11, multi-viewpoint color images and multi-viewpoint disparity information images are encoded, but the bitrate of the multiplexed bitstream which the transmission device 11 outputs is restricted, so the bit amount of encoded data allocated to images of one viewpoint (color image and disparity information image) in encoding is also restricted.

When encoding, in the event that the bit amount of encoded data which can be allocated to an image is smaller than the data amount of that image at baseband, encoding noise such as block noise becomes conspicuous, and as a result, the image quality of the decoded image obtained by decoding at the reception device 12 deteriorates.

Accordingly, there is the need to reduce the data amount (at baseband) of multi-viewpoint color images and multi-viewpoint disparity information images, from the perspective of suppressing deterioration in image quality of decoded images, as well.

Accordingly, the transmission device 11 performs encoding after having reduced the data amount of multi-viewpoint color images and multi-viewpoint disparity information images (at baseband).

Now, for disparity information, which is pixel values of a disparity information image, a disparity value (value I) representing disparity between a subject in each pixel of a color image as to a reference viewpoint taking a certain viewpoint as a reference, or a depth value (value y) representing distance (depth) to the subject in each pixel of the color image, can be used.

If the positional relations of the cameras shooting the color images at multiple viewpoints is known, the disparity value and depth value are mutually convertible, and accordingly are equivalent information.

Hereinafter, a disparity information image (depth image) having disparity values as pixel values will also be referred to as a disparity image, and a disparity information image (depth image) having depth values as pixel values will also be referred to as a depth image.

Hereinafter, of the disparity images and depth images, depth images will be used for disparity information images for example, but disparity images can be used for disparity information images as well.

### Configuration Example of Transmission Device 11

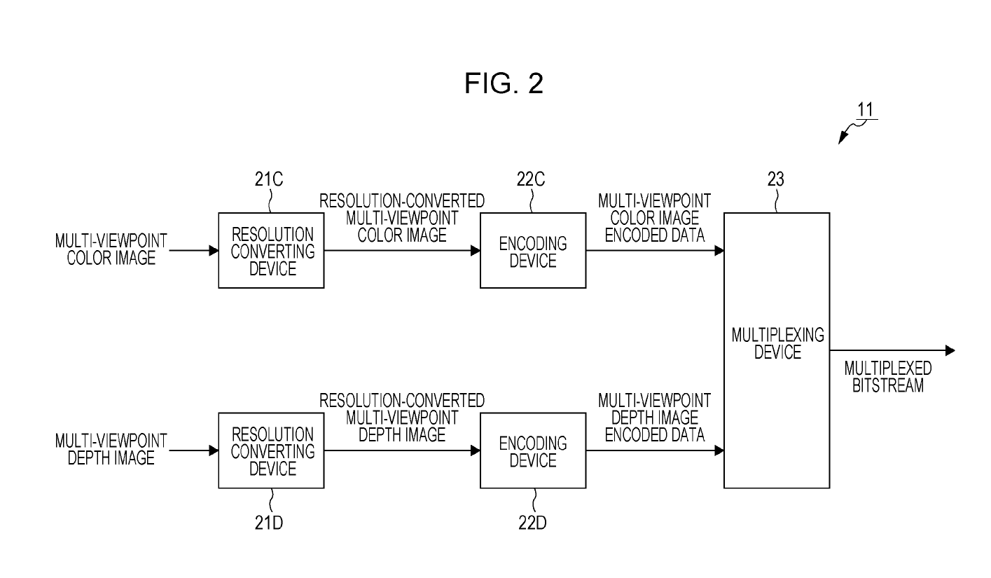

FIG. 2 is a block diagram illustrating a configuration example of the transmission device 11 in FIG. 1.

In FIG. 2, the transmission device 11 has resolution converting devices 21C and 21D, encoding devices 22C and 22D, and a multiplexing device 23.

Multi-viewpoint color images are supplied to the resolution converting device 21C.

The resolution converting device 21C performs resolution conversion to convert a multi-viewpoint color image supplied thereto into a resolution-converted multi-viewpoint color image having lower resolution than the original resolution, and supplies the resolution-converted multi-viewpoint color image obtained as a result thereof to the encoding device 22C.

The encoding device 22C encodes the resolution-converted multi-viewpoint color image supplied from the resolution converting device 21C with MVC, for example, which is a standard for transmitting images of multiple viewpoints, and supplies multi-viewpoint color image encoded data which is encoded data obtained as a result thereof, to the multiplexing device 23.

Now, MVC is an extended profile of AVC, and according to MVC, efficient encoding featuring disparity prediction can be performed for non base view images, as described above.

Also, with MVC, base view images are encoded AVC-compatible. Accordingly, encoded data where a base view image has been encoded with MVC can be decoded with an AVC decoder.

The resolution converting device 21D is supplied with a multi-viewpoint depth image which is a depth images of each viewpoint, having, as pixel values, depth values for each pixel of the color images of each viewpoint making up the multi-viewpoint color image.

In FIG. 2, the resolution converting device 21D and encoding device 22D each perform the same processing as the resolution converting device 21C and encoding device 22C, on depth images (multi-viewpoint depth images) instead of color images (multi-viewpoint color images) as objects to be processed.

That is to say, the resolution converting device 21D performs resolution conversion of a multi-viewpoint depth image supplied thereto into a resolution-converted multi-viewpoint depth image of a low-resolution lower than the original resolution, and supplies this to the encoding device 22D.

The encoding device 22D encodes the resolution-converted multi-viewpoint depth image supplied from the resolution converting device 21D with MVC, and supplies multi-viewpoint depth image encoded data which is encoded data obtained as a result thereof, to the multiplexing device 23.

The multiplexing device 23 multiplexes the multi-viewpoint color image encoded data from the encoding device 22C with the multi-viewpoint depth image encoded data from the encoding device 22D, and outputs a multiplexed bitstream obtained as a result thereof.

### Configuration Example of Reception Device 12

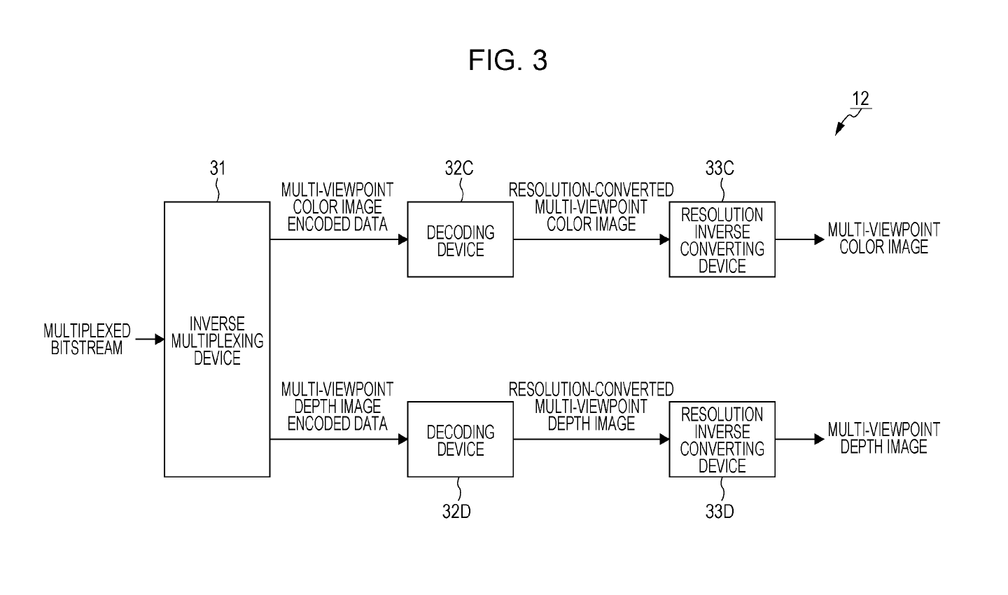

FIG. 3 is a block diagram illustrating a configuration example of the reception device 12 in FIG. 1.

In FIG. 3, the reception device 12 has an inverse multiplexing device 31, decoding devices 32C and 32D, and resolution inverse converting devices 33C and 33D.

A multiplexed bitstream output from the transmission device 11 (FIG. 2) is supplied to the inverse multiplexing device 31.

The inverse multiplexing device 31 receives the multiplexed bitstream supplied thereto, and performs inverse multiplexing of the multiplexed bitstream, thereby separating the multiplexed bitstream into the multi-viewpoint color image encoded data and multi-viewpoint depth image encoded data.

The inverse multiplexing device 31 then supplies the multi-viewpoint color image encoded data to the decoding device 32C, and the multi-viewpoint depth image encoded data to the decoding device 32D.

The decoding device 32C decodes the multi-viewpoint color image encoded data supplied from the inverse multiplexing device 31 by MVC, and supplies the resolution-converted multi-viewpoint color image obtained as a result thereof to the resolution inverse converting device 33C.

The resolution inverse converting device 33C performs resolution inverse conversion to (inverse) convert the resolution-converted multi-viewpoint color image from the decoding device 32C into the multi-viewpoint color image of the original resolution, and outputs the multi-viewpoint color image obtained as the result thereof.

The decoding device 32D and resolution inverse converting device 33D each perform the same processing as decoding device 32C and resolution inverse converting device 33C, on multi-viewpoint depth image encoded data (resolution-converted multi-viewpoint depth images) instead of multi-viewpoint color image encoded data (resolution-converted multi-viewpoint color images) as objects to be processed.

That is to say, the decoding device 32D decodes the multi-viewpoint depth image encoded data supplied from the inverse multiplexing device 31 by MVC, and supplies the resolution-converted multi-viewpoint depth image obtained as the result thereof to the resolution inverse converting device 33D.

The resolution inverse converting device 33D performs resolution inversion conversion of the resolution-converted multi-viewpoint depth image from the decoding device 32D to the multi-viewpoint depth image of the original resolution, and outputs.

Note that with the present embodiment, depth images are subjected to the same processing as with color images, so description of processing of depth images will be omitted hereinafter as appropriate.

### Resolution Conversion

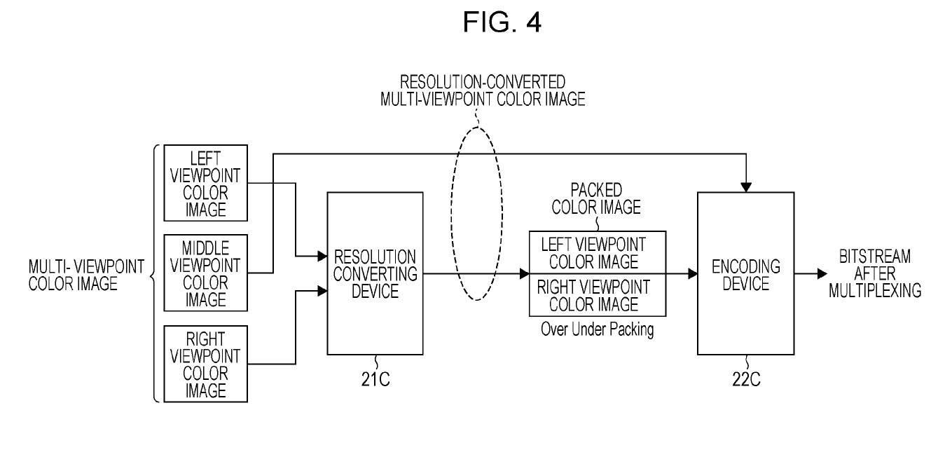

FIG. 4 is a diagram for describing resolution conversion which the resolution converting device 21C in FIG. 2 performs.

Note that hereinafter, we will assume that a multi-viewpoint color image (the same for multi-viewpoint depth images as well) is a color image of three viewpoints, which are a middle viewpoint color image, left viewpoint color image, and right viewpoint color image, for example.

The three viewpoints of middle viewpoint color image, left viewpoint color image, and right viewpoint color image, which are color images, are images obtained by situating three cameras, at a position to the front of the subject, at a position to the left of the subject facing the subject, and at a position to the right of the subject facing the subject, and shooting the subject.

Accordingly, the middle viewpoint color image is an image of which the viewpoint is a position to the front of the subject. Also, the left viewpoint color image is an image of which the viewpoint is a position to the left (left viewpoint) of the viewpoint of the middle viewpoint color image (middle viewpoint), and the right viewpoint color image (right viewpoint) is an image of which the viewpoint is a position to the right of the middle viewpoint.

Note that a multi-viewpoint color image (and multi-viewpoint depth image) may be an image with two viewpoints, or an image with four or more viewpoints.

The resolution converting device 21C outputs, of the middle viewpoint color image, left viewpoint color image, and right viewpoint color image, which are the multi-viewpoint color image supplied thereto, the middle viewpoint color image for example, as it is (without performing resolution conversion).

Also, the resolution converting device 21C converts the remaining left viewpoint color image and right viewpoint color image of the multi-viewpoint color image so that the resolution of the images of the two viewpoints is low resolution, and performs packing where these are combined into one viewpoint worth of image, thereby generating a packed color image which is output.

That is to say, the resolution converting device 21C changes the vertical direction resolution (number of pixels) of each of the left viewpoint color image and right viewpoint color image to ½, and vertically arrays the left viewpoint color image and right viewpoint color image of which the vertical direction resolution (vertical resolution) has been made to be ½, thereby generating a packed color image which is one viewpoint worth of image.

Now, with the packed color image in FIG. 4, the left viewpoint color image is situated above, and the right viewpoint color image is situated below.

The middle viewpoint color image and packed color image output from the resolution converting device 21C are supplied to the encoding device 22C as a resolution-converted multi-viewpoint color image.

Now, the multi-viewpoint color image supplied to the resolution converting device 21C is an image of the three viewpoints worth of the middle viewpoint color image, left viewpoint color image, and right viewpoint color image, but the resolution-converted multi-viewpoint color image output from the resolution converting device 21C is an image of the two viewpoints worth of the middle viewpoint color image and packed color image, so data amount at the baseband has been reduced.

Now, in FIG. 4, while of the middle viewpoint color image, left viewpoint color image, and right viewpoint color image, configuring the multi-viewpoint color image, the left viewpoint color image and right viewpoint color image have been packed into one viewpoint worth of packed color image, packing can be performed on color images of any two viewpoints of the middle viewpoint color image, left viewpoint color image, and right viewpoint color image.

Note however, that, in the event that a 2D image is to be displayed at the reception device 12 side, it is predicted that of the middle viewpoint color image, left viewpoint color image, and right viewpoint color image, making up the multi-viewpoint color image, the middle viewpoint color image will be used. Accordingly, with FIG. 4, the middle viewpoint color image is not subjected to packing in where the resolution is converted to low resolution, so as to enable a 2D image to be displayed with high image quality.

That is to say, at the reception device 12 side, all of the middle viewpoint color image, left viewpoint color image, and right viewpoint color image, configuring the multi-viewpoint color image, are used for display of a 3D image, but for display of a 2D image, only the middle viewpoint color image, for example, out of the middle viewpoint color image, left viewpoint color image, and right viewpoint color image, is used. Accordingly, of the middle viewpoint color image, left viewpoint color image, and right viewpoint color image, making up the multi-viewpoint color image, the left viewpoint color image and right viewpoint color image are used at the reception device 12 side only for 3D image display, so in FIG. 4, the left viewpoint color image and right viewpoint color image which are only used for this 3D image display are subjected to packing.

### Configuration Example of Encoding Device 22C

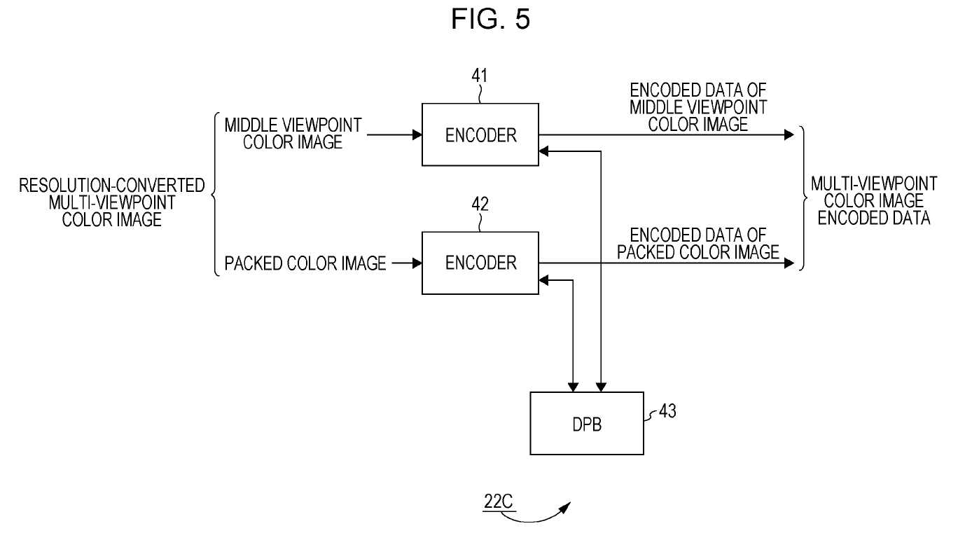

FIG. 5 is a block diagram illustrating a configuration example of the encoding device 22C in FIG. 2.

The encoding device 22C in FIG. 5 encodes the middle viewpoint color image and packed color image which are the resolution-converted multi-viewpoint color image from the resolution converting device 21C (FIG. 2, FIG. 4) by MVC.

Now hereinafter, unless specifically stated otherwise, the middle viewpoint color image will be taken as the base view image, and the other viewpoint images, i.e., the packed color image here, will be handled as non base view images.

In FIG. 5, the encoding device 22C has encoders 41, 42, and a DPB (Decode Picture Buffer) 43.

The encoder 41 is supplied with, of the middle viewpoint color image and packed color image configuring the resolution-converted multi-viewpoint color image from the resolution converting device 21C, the middle viewpoint color image.

The encoder 41 takes the middle viewpoint color image as the base view image and encodes by MVC (AVC), and outputs encoded data of the middle viewpoint color image obtained as a result thereof.

The encoder 42 is supplied with, of the middle viewpoint color image and packed color image configuring the resolution-converted multi-viewpoint color image from the resolution converting device 21C, the packed color image.

The encoder 42 takes the packed color image as a non base view image and encodes by MVC, and outputs encoded data of the packed color image obtained as a result thereof.

Note that the encoded data of the middle viewpoint color image output from the encoder 41 and the encoded data of the packed color image output from the encoder 42, are supplied to the multiplexing device 23 (FIG. 2) as multi-viewpoint color image encoded data.

The DPB 43 temporarily stores a post-local-decoded image obtained by encoding images to be encoded at each of the encoders 41 and 42 and locally decoding (decoded image), as (a candidate for) a reference image to be referenced at the time of generating a prediction image.

That is to say, the encoders 41 and 42 perform prediction encoding of the image to be encoded. Accordingly, in order to generate a prediction image to be used for prediction encoding, the encoders 41 and 42 encode the image to be encoded, and thereafter perform local decoding, thereby obtaining a decoded image.

The DPB 43 is a shared buffer, as if it were, for temporarily storing decoded images obtained at each of the encoders 41 and 42, with the encoders 41 and 42 each selecting reference images to reference when encoding images to encode, from decoded images stored in the DPB 43. The encoders 41 and 42 then each generate prediction images using reference images, and perform image encoding (prediction encoding) using these prediction images.

The DPB 43 is shared between the encoders 41 and 42, so each of the encoders 41 and 42 can reference, in addition to decoded images obtained at itself, decoded images obtained at the other encoder.

Note however, the encoder 41 encodes the base view image, and accordingly only references a decoded image obtained at the encoder 41.

### Overview of MVC

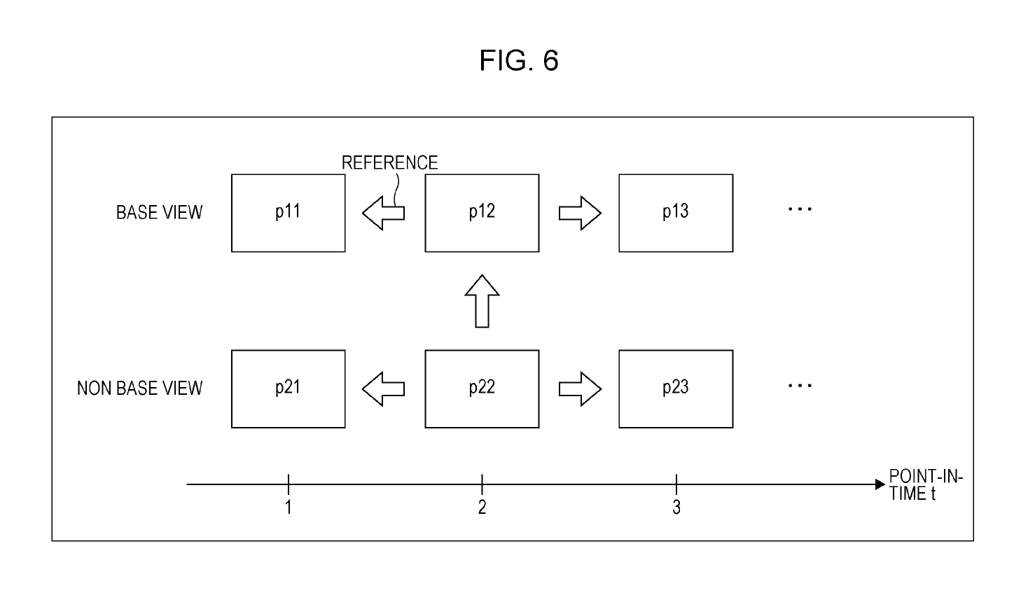

FIG. 6 is a diagram for describing pictures (reference images) referenced when generating a prediction image, in MVC prediction encoding.

Let us express pictures of base view images as p11, p12, p13, . . . in the order of display point-in-time, and pictures of non base view images as p21, p22, p23, . . . in the order of display point-in-time.

For example, picture p12 which is a base view picture, is prediction-encoded referencing pictures p11 or p13, for example, which are base view pictures thereof, as necessary.

That is to say, with regard to the base view picture p12, prediction (generating of prediction image) can be performed referencing only pictures p11 or p13, which are base view pictures at other display points-in-time.

Also, for example, picture p22 which is a non base view picture is prediction encoded referencing pictures p21 or p23, for example, which are non base view pictures thereof, and further the base view picture p12 which is a different view, as necessary.

That is to say, the non base view picture p22 can reference, in addition to the referencing pictures p21 or p23 which are non base view pictures thereof at other display points-in-time, the base view picture p12 which is a picture of a different view, and perform prediction.

Note that prediction performed referencing pictures in the same view as the picture to be encoded (at a different display point-in-time) is also called temporal prediction, and prediction performed referencing a picture of a different view from the picture to be encoded is also called disparity prediction.

As described above, with MVC, only temporal prediction can be performed for base view pictures, and temporal prediction and disparity prediction can be performed for non base view pictures.

Note that with MVC, a picture of a different view from the picture to be encoded which is reference in disparity prediction, must be a picture of the same point-in-time as the picture to be encoded.

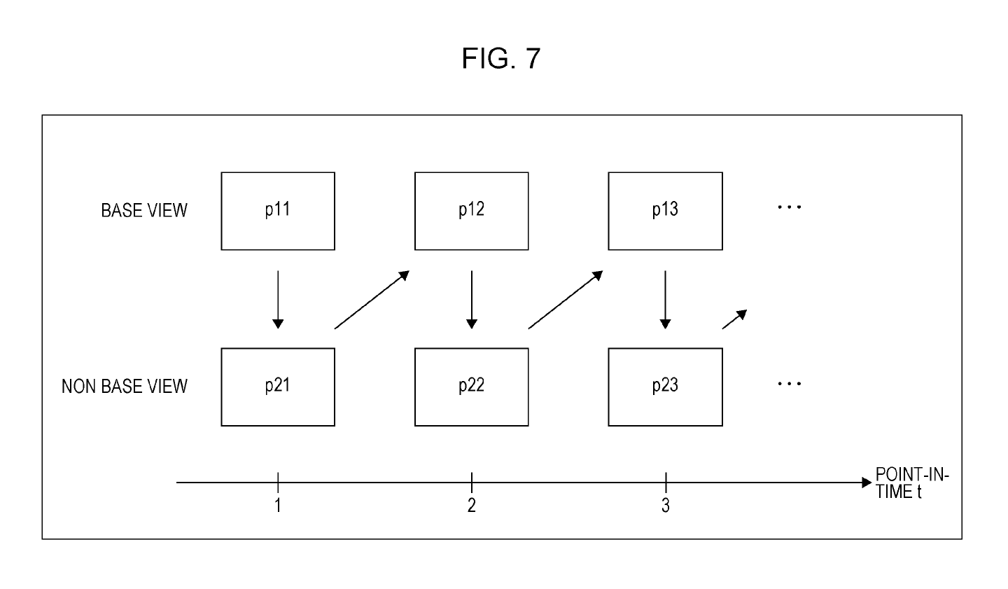

FIG. 7 is a diagram describing the order of encoding (and decoding) of pictures with MVC.

In the same way as with FIG. 6, let us express pictures of base view images as p11, p12, p13, . . . in the order of display point-in-time, and pictures of non base view images as p21, p22, p23, . . . in the order of display point-in-time.

Now, to simplify description, assuming that the pictures of each view are encoded in the order of the display point-in-time, first, the first picture p11 at point-in-time t=1 of the base view is encoded, following which the picture p21 at the same point-in-time t=1 of the non base view is encoded.

Upon encoding of (all) non base view pictures at the same point-in-time t=1 ending, the next picture p12 at point-in-time t=2 of the base view is encoded, following which the picture p22 at the same point-in-time t=2 of the non base view is encoded.

Thereafter, base view pictures and non base view pictures are encoded in similar order.

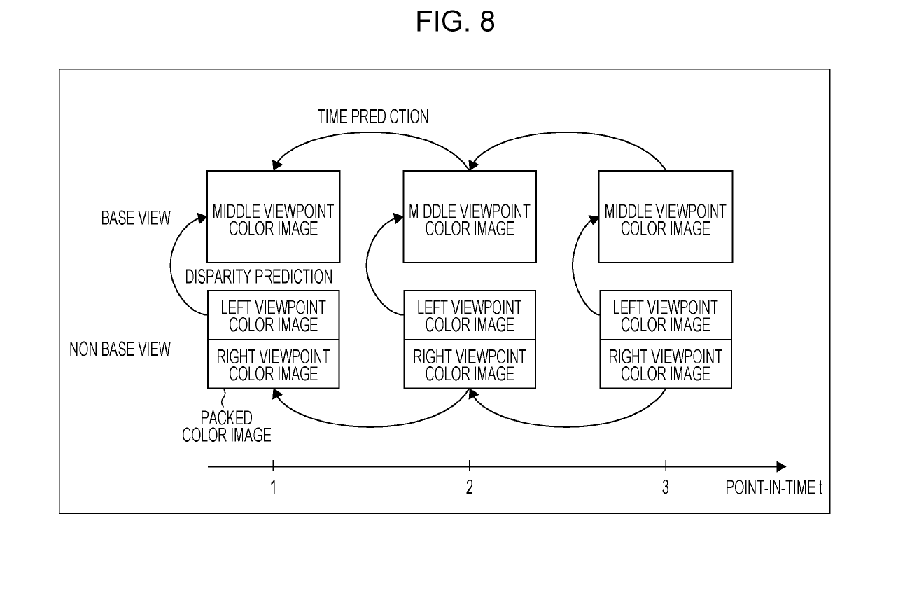

FIG. 8 is a diagram for describing temporal prediction and disparity prediction performed at the encoders 41 and 42 in FIG. 5.

Note that in FIG. 8, the horizontal axis represents the point-in-time of encoding (decoding).

In prediction encoding of a picture of the middle viewpoint color image which is the base view image, the encoder 41 which encodes the base view image can perform temporal prediction, in which another picture of the middle viewpoint color image that has already been encoded is referenced.

In prediction encoding of a picture of the packed color image which is a non base view image, the encoder 42 which encodes the non base view image can perform temporal prediction, in which another picture of the packed color image that has already been encoded is referenced, and disparity prediction referencing an (already encoded) picture of the middle viewpoint color image (a picture with the same point-in-time (same POC (Picture Order Count)) as the pictures of the packed color image to be encoded).

### Configuration Example of Encoder 42

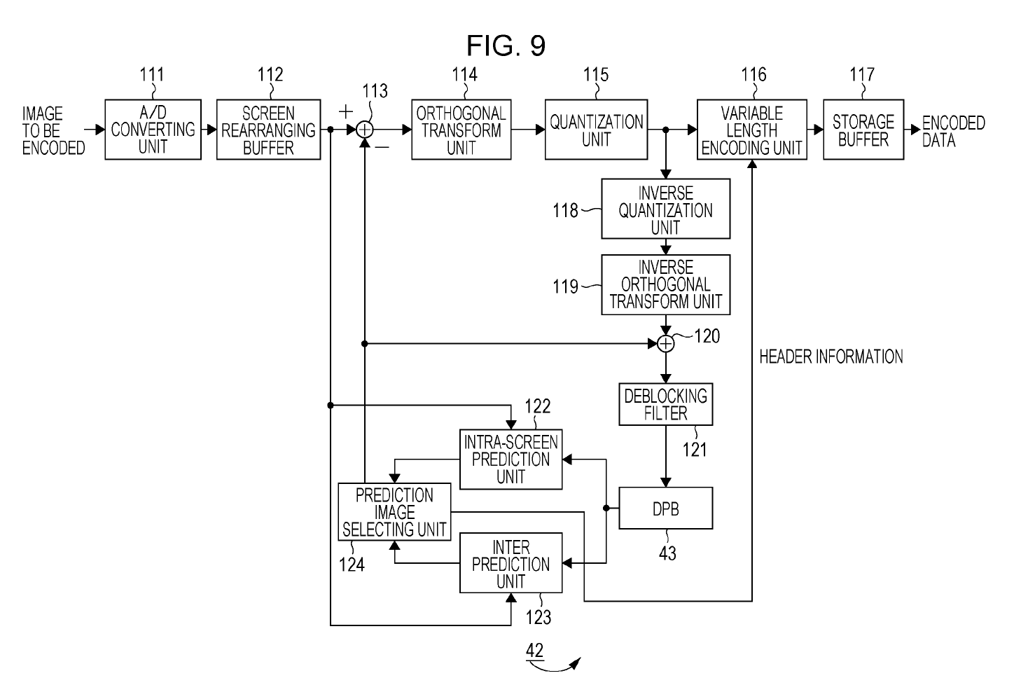

FIG. 9 is a block diagram illustrating a configuration example of the encoder 42 in FIG. 5.

In FIG. 9, the encoder 42 has an A/D (Analog/Digital) converting unit 111, a screen rearranging buffer 112, a computing unit 113, an orthogonal transform unit 114, a quantization unit 115, a variable length encoding unit 116, a storage buffer 117, an inverse quantization unit 118, an inverse orthogonal transform unit 119, a computing unit 120, a deblocking filter 121, an intra-screen prediction unit 122, an inter prediction unit 123, and a prediction image selecting unit 124.

Packed color image pictures which are images to be encoded (moving image) are sequentially supplied in display order to the A/D converting unit 111.

In the event that the pictures supplied thereto are analog signals, the A/D converting unit 111 performs A/D conversion of the analog signals, and supplies to the screen rearranging buffer 112.

The screen rearranging buffer 112 temporarily stores the pictures from the A/D converting unit 111, and reads out the pictures in accordance with a GOP (Group of Pictures) structure determined beforehand, thereby performing rearranging where the order of the pictures is rearranged from display order to encoding order (decoding order).

The pictures read out from the screen rearranging buffer 112 are supplied to the computing unit 113, the intra-screen prediction unit 122, and the inter prediction unit 123.

Pictures are supplied from the screen rearranging buffer 112 to the computing unit 113, and also, prediction images generated at the intra-screen prediction unit 122 or inter prediction unit 123 are supplied from the prediction image selecting unit 124.

The computing unit 113 takes a picture read out from the screen rearranging buffer 112 to be a current picture to be encoded, and further sequentially takes a macroblock making up the current picture to be a current block to be encoded.

The computing unit 113 then computes a subtraction value where a pixel value of a prediction image supplied from the prediction image selecting unit 124 is subtracted from a pixel value of the current block, as necessary, and supplies to the orthogonal transform unit 114.

The orthogonal transform unit 114 subjects (the pixel value, or the residual of the prediction image having been subtracted, of) the current block from the computing unit 113 to orthogonal transform such as discrete cosine transform or Karhunen-Loéve transform or the like, and supplies transform coefficients obtained as a result thereof to the quantization unit 115.

The quantization unit 115 quantizes the transform coefficients supplied from the orthogonal transform unit 114, and supplies quantization values obtained as a result thereof to the variable length encoding unit 116.

The variable length encoding unit 116 performs lossless encoding such as variable-length coding (e.g., CAVLC (Context-Adaptive Variable Length Coding) or the like) or arithmetic coding (e.g., CABAC (Context-Adaptive Binary Arithmetic Coding) or the like) on the quantization values from the quantization unit 115, and supplies the encoded data obtained as a result thereof to the storage buffer 117.

Note that in addition to quantization values being supplied to the variable length encoding unit 116 from the quantization unit 115, header information to be included in the header of the encoded data is also supplied from the prediction image selecting unit 124.

The variable length encoding unit 116 encodes the header information from the prediction image selecting unit 124, and includes in the header of the encoded data.

The storage buffer 117 temporarily stores the encoded data from the variable length encoding unit 116, and outputs (transmits) at a predetermined data rate.

Quantization values obtained at the quantization unit 115 are supplied to the variable length encoding unit 116, and also supplied to the inverse quantization unit 118 as well, and local decoding is performed at the inverse quantization unit 118, inverse orthogonal transform unit 119, and computing unit 120.

That is to say, the inverse quantization unit 118 performs inverse quantization of the quantization values from the quantization unit 115 into transform coefficients, and supplies to the inverse orthogonal transform unit 119.

The inverse orthogonal transform unit 119 performs inverse orthogonal transform of the transform coefficients from the inverse quantization unit 118, and supplies to the computing unit 120.

The computing unit 120 adds pixel values of a prediction image supplied from the prediction image selecting unit 124 to the data supplied from the inverse orthogonal transform unit 119 as necessary, thereby obtaining a decoded image where the current block has been decoded (locally decoded), which is supplied to the deblocking filter 121.

The deblocking filter 121 performs filtering of the decoded image from the computing unit 120, thereby removing (reducing) block noise occurring in the decoded image, and supplies to the DPB 43 (FIG. 5).

Now, the DPB 43 stores a decoded image from the deblocking filter 121, i.e., a picture of a packed color image encoded at the encoder 42 and locally decoded, as (a candidate for) a reference image to be reference when generating a prediction image to be used for prediction encoding (encoding where subtraction of a prediction image is performed at the computing unit 113) later in time.

As described with FIG. 5, the DPB 43 is shared between the encoders 41 and 42, so besides packed color image pictures encoded at the encoder 42 and locally decoded, the picture of the middle viewpoint color image encoded at the encoder 41 and locally decoded is also stored.

Note that local decoding by the inverse quantization unit 118, inverse orthogonal transform unit 119, and computing unit 120 is performed on referenceable I pictures, P pictures, and Bs pictures which can be reference images (reference pictures), for example, and the DPB 43 stores decoded images of the I pictures, P pictures, and Bs pictures.

In the event that the current picture is an I picture, P picture, or B picture (including Bs picture) which can be intra-predicted (intra-screen predicted), the intra-screen prediction unit 122 reads out, from the DPB 43, the portion of the current picture which has already been locally decoded (decoded image). The intra-screen prediction unit 122 then takes the part of the decoded image of the current picture read out from the DPB 43 as a prediction image of the current block of the current picture supplied from the screen rearranging buffer 112.

Further, the intra-screen prediction unit 122 obtains an encoding cost necessary to encode the current block using the prediction image, i.e., an encoding cost necessary to encode the residual of the current block as to the prediction image and so forth, and supplies this to the prediction image selecting unit 124 along with the prediction image.

In the event that the current picture is a P picture or B picture (including Bs picture) which can be inter-predicted, the inter prediction unit 123 reads out from the DPB 43 a picture which has been encoded and locally decoded before the current picture, as a reference image.

Also, the inter prediction unit 123 employs ME (Motion Estimation) using the current block of the current picture from the screen rearranging buffer 112 and the reference image, to detect a shift vector representing shift (disparity, motion) between the current block and a corresponding block in the reference image corresponding to the current block (e.g., a block which minimizes the SAD (Sum of Absolute Differences) or the like as to the current block).

Now, in the event that the reference image is a picture of the same view as the current picture (of a different point-in-time as the current picture), the shift vector detected by ME using the current block and the reference image will be a motion vector representing the motion (temporal shift) between the current block and reference image.

Also, in the event that the reference image is a picture of a different view as the current picture (of the same point-in-time as the current picture), the shift vector detected by ME using the current block and the reference image will be a disparity vector representing the disparity (spatial shift) between the current block and reference image.

The inter prediction unit 123 generates a prediction image by performing shift compensation which is MC (Motion Compensation) of the reference image from the DPB 43 (motion compensation to compensate for motion shift or disparity compensation to compensate for disparity shift), in accordance with the shift vector of the current block.

That is to say, the inter prediction unit 123 obtains a corresponding block, which is a block (region) at a position that has moved (shifted) from the position of the current block in the reference image, in accordance with the shift vector of the current block, as a prediction image.

Further, the inter prediction unit 123 obtains the encoding cost necessary to encode the current block using the prediction image, for each inter prediction mode of which the later-described macroblock type differs.

The inter prediction unit 123 then takes the inter prediction mode of which the encoding cost is the smallest as the optimal inter prediction mode which is the inter prediction mode that is optimal, and supplies the prediction image and encoding cost obtained in that optimal inter prediction mode to the prediction image selecting unit 124.

Now, generating a prediction image based on a shift vector (disparity vector, motion vector) will also be called shift prediction (disparity prediction, temporal prediction (motion prediction)) or shift compensation (disparity compensation, motion compensation). Note that shift prediction includes detection of shift vectors as necessary.

The prediction image selecting unit 124 selects the one of the prediction images from each of the intra-screen prediction unit 122 and inter prediction unit 123 of which the encoding cost is smaller, and supplies to the computing units 113 and 120.

Note that the intra-screen prediction unit 122 supplies information relating to intra prediction (prediction mode related information) to the prediction image selecting unit 124, and the inter prediction unit 123 supplies information relating to inter prediction (prediction mode related information including information of shift vectors and reference indices assigned to the reference image, and so forth) to the prediction image selecting unit 124.

The prediction image selecting unit 124 selects, of the information from each of the intra-screen prediction unit 122 and inter prediction unit 123, the information by which a prediction image with smaller encoding cost has been generated, and provides to the variable length encoding unit 116 as header information.

Note that the encoder 41 in FIG. 5 also is configured in the same way as with the encoder 42 in FIG. 9. However, the encoder 41 which encodes base view images performs temporal prediction alone in the inter prediction, and does not perform disparity prediction.

[Macro Block Type]

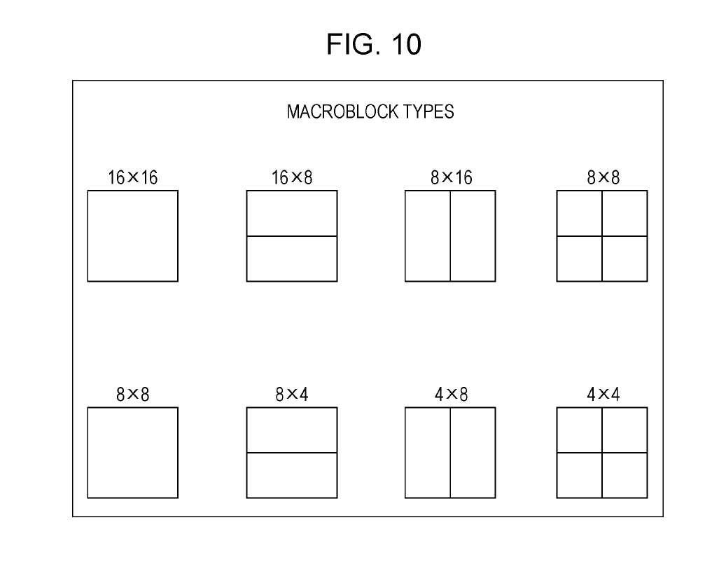

FIG. 10 is a diagram for describing macroblock types in MVC (AVC).

With MVC, a macroblock serving as a current block is a 16×16 pixel block horizontal×vertical, but a macroblock can be divided into partitions and ME (and generating of prediction images) be performed on each partition.

That is to say, with MVC, a macroblock can further be divided into any partition of 16×16 pixels, 16×8 pixels, 8×16 pixels, or 8×8 pixels, with ME performed on each partition to detect shift vectors (motion vectors or disparity vectors).

Also, with MVC, a partition of 8×8 pixels can be divided into any sub-partition of 8×8 pixels, 8×4 pixels, 4×8 pixels, or 4×4 pixels, with ME performed on each partition to detect shift vectors (motion vectors or disparity vectors).

Macroblock type represents what sort of partitions (or further sub-partitions) a macroblock is to be divided into.

With the inter prediction of the inter prediction unit 123 (FIG. 9), the encoding cost of each macroblock types is calculated as the encoding cost of each inter prediction mode, for example, with the inter prediction mode (macro block type) of which the encoding cost is the smallest being selected as the optimal inter prediction mode.

### Prediction Vector

### PMV Predicted Motion Vector

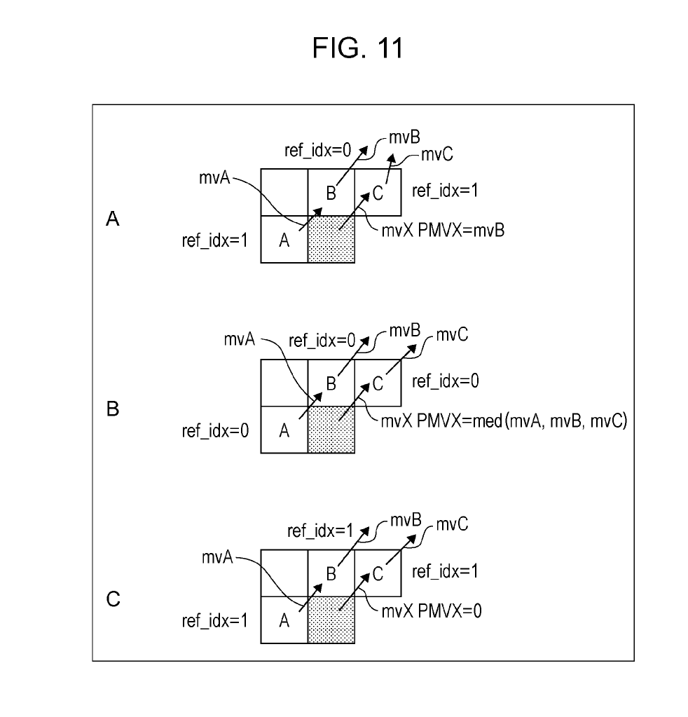

FIG. 11 is a diagram for describing prediction vectors (PMV) with MVC (AVC).

With the inter prediction of the inter prediction unit 123 (FIG. 9), shift vectors (motion vectors or disparity vectors) of the current block are detected by ME, and a prediction image is generated using these shift vectors.

While shift vectors are necessary to decode an image at the decoding side, and thus information of shift vectors needs to be encoded and included in encoded data, but encoding shift vectors as they are results in the amount of code of shift vectors being great, which may deteriorate encoding efficiency.

That is to say, with MVC, a macroblock may be divided into 8×8 pixel partitions, and each of the 8×8 pixel partitions may further be divided into 4×4 pixel sub-partitions, as described with FIG. 10. In this case, one macroblock is ultimately divided into 4×4 sub-partitions, meaning that each macroblock may have 16 (=4×4) shift vectors, and encoding the shift vectors as they are results in the amount of code great, deteriorating encoding efficiency.

Accordingly, with MVC (AVC), vector prediction to predict shift vectors is performed, and the residual of shift vectors as to prediction vectors obtained by the vector prediction (residual vectors) are encoded.

Note however, that prediction vectors generated with MVC differ according to reference indices (hereinafter also referred to as reference index for prediction) assigned to reference images used to generate prediction images of macroblocks in the periphery of the current block.

Now, (a picture which can serve as) a reference image in MVC (AVC), and a reference index, will be described.

With AVC, multiple pictures can be taken as reference images when generating a prediction image.

Also, with an AVC codec, reference images are stored in a buffer called a DPB, following decoding (local decoding).

With the DPB, pictures referenced short term are each marked as being short-term reference images (used for short-term reference), pictures referenced long term as being long-term reference images (used for long-term reference), and pictures not referenced as being unreferenced images (unused for reference).

There are two types of management methods for managing the DPB, which are the sliding window memory management format (Sliding window process) and the adaptive memory management format (Adaptive memory control process).

With the sliding window memory management format, the DPB is managed by FIFO (First In First Out) format, and pictures stored in the DPB are released (become unreferenced) in order from pictures of which the frame_num is small.

That is to say, with the sliding window memory management format, I (Intra) pictures, P (Predictive) pictures, and Bs pictures which are referable B (Bi-directional Predictive) pictures, are stored in the DPB as short-term reference images.

After the DPB has then stored all the (reference images that can become) reference images as it can store reference images, the earliest (oldest) short-term reference image of the short-term reference images stored in the DPB is released.

Note that in the event that long-term reference images are stored in the DPB, the sliding window memory management format does not affect the long-term reference images stored in the DPB. That is to say, with the sliding window memory management format, the only reference images managed by FIFO format are short-term reference images.

With the adaptive memory management format, pictures stored in the DPB are managed using commands called MMCO (Memory management control operation).

MMCO commands enable with regard to reference images stored in the DPB, setting short-term reference images to unreferenced images, setting short-term reference images to long-term reference images by assigning a long-term frame index which is a reference index for managing long-term reference images to short-term reference images, setting the maximum value of long-term frame index, setting all reference images to unreferenced images, and so forth.

With AVC, motion compensation (shift compensation) of reference images stored in the DPB is performed, thereby performing inter prediction where a prediction image is generated, and a maximum of two pictures worth of reference images can be used for inter prediction of B pictures (including Bs pictures). Inter prediction using the reference images of these two pictures are called L0 (List 0) prediction and L1 (List 1) prediction, respectively.

With regard to B pictures (including Bs pictures), L0 prediction, or L1 prediction, or both L0 prediction and L1 prediction are used for inter prediction. With regard to P pictures, only L0 prediction is used for inter prediction.

In inter prediction, reference images to be reference to generate a prediction image are managed by a reference list (Reference Picture List).

With a reference list, a reference index (Reference Index) which is an index for specifying (reference images that can become) reference images referenced to generate a prediction image is assigned to (pictures that can become) reference images stored in the DPB.

In the event that the current picture is a P picture, only L0 prediction is used with P pictures for inter prediction as described above, so assigning of the reference index is performed only regarding L0 prediction.

Also, in the event that the current picture is a B picture (including Bs picture), both L0 prediction and L1 prediction may be used with B pictures for inter prediction as described above, so assigning of the reference index is performed regarding L0 prediction and L1 prediction.

Now, a reference index regarding L0 prediction is also called an L0 index, and a reference index regarding L1 prediction is also called an L1 index.

In the event that the current picture is a P picture, with AVC default (default value) site later in decoding order the reference image is, the smaller a number reference index (L0 index) is assigned to the reference images stored in the DPB.

A reference index is an integer value of 0 or greater, with 0 being the minimal value. Accordingly, in the event that the current picture is a P picture, 0 is assigned to the reference image decoded immediately prior to the current picture, as an L0 index.

In the event that the current picture is a B picture (including Bs picture), with AVC default, a reference index (L0 index and L1 index) is assigned to the reference images stored in the DPB in POC (Picture Order Count) order, i.e., in display order.

That is to say, with regard to L0 prediction, the closer to the current picture a reference image is, the smaller the value of L0 index is that is assigned to reference images temporally before the current picture in display order, and thereafter, the closer to the current picture a reference image is, the smaller the value of L0 index is that is assigned to reference images temporally after the current picture in display order.

Also, with regard to L1 prediction, the closer to the current picture a reference image is, the smaller the value of L1 index is that is assigned to reference images temporally after the current picture in display order, and thereafter, the closer to the current picture a reference image is, the smaller the value of L1 index is that is assigned to reference images temporally before the current picture in display order.

Note that default assignment of the reference index (L0 index and L1 index) with AVC described above is performed as to short-term reference images. Assigning reference indices to long-term reference images is performed after assigning reference indices to the short-term reference images.

Accordingly, by default with AVC, long-term reference images are assigned reference indices with grater values that short-term reference images.

With AVC, assigning of reference indices can be performed as with the default method described above, or optional assigning may be performed using a command called Reference Picture List Reordering (hereinafter also referred to as RPLR command).

Note that in the event that the RPLR command is used to assign reference indices, and thereafter there is a reference image to which a reference index has not been assigned, a reference index is assigned to the reference image by the default method.

With MVC (AVC), as illustrated in FIG. 11, a prediction vector PMVX of a shift vector mvX of the current block X is obtained differently for each reference index for prediction of the macroblock A adjacent to the current block X to the left, macroblock adjacent above, and macroblock C adjacent to the oblique upper right (reference indices assigned to reference images used for generating the prediction images of each of the macroblocks A, B, and C).

That is, let us now say that a reference index ref_idx for prediction of the current block X is, for example, 0.

As illustrated in A in FIG. 11, in the event that there is only one macroblock of the three macroblocks A through C adjacent to the current block X where the reference index ref_idx for prediction is 0, the same as with the current block X, the shift vector of that one macroblock (the macroblock of which the reference index ref_idx for prediction is 0) is taken as the prediction vector PMVX of the shift vector mvX of the current block X.

Note that here, with A in FIG. 11, only macroblock B of the three macroblocks A through C adjacent to the current block X has a reference index ref_idx for prediction of 0, and accordingly, the shift vector mvB of macroblock A is taken as the prediction vector PMVX (of the shift vector mvX) of the current block X.

Also, as illustrated in B in FIG. 11, in the event that there are two or more macroblocks of the three macroblocks A through C adjacent to the current block X where the reference index ref_idx for prediction is 0, the same as with the current block X, the median of the shift vectors of the two or more macroblocks where the reference index ref_idx for prediction is taken as the prediction vector PMVX of the current block X.

Note that here, with B in FIG. 11, all three macroblocks A through C adjacent to the current block X are macroblocks having a reference index ref_idx for prediction of 0, and accordingly, the median med(mvA, mvB, mvC) of the shift vector mvA of macroblock A, the shift vector mvB of macroblock B, and the shift vector mvC of macroblock C, is taken as the prediction vector PMVX of the current block X. Note that calculation of the median med(mvA, mvB, mvC) is performed separately (independently) for x component and y component.

Also, as illustrated in C in FIG. 11, in the event that there is not even one macroblock of the three macroblocks A through C adjacent to the current block X where the reference index ref_idx for prediction is 0, the same as with the current block X, a 0 vector is taken as the prediction vector PMVX of the current block X.

Note that here, with C in FIG. 11, there is no macroblock of the three macroblocks A through C adjacent to the current block X has a reference index ref_idx for prediction of 0, and accordingly, a 0 vector is taken as the prediction vector PMVX of the current block X.

Note that with MVC (AVC), in the event that the reference index ref_idx for prediction of the current block X is 0, the current block X can be encoded as a skip macroblock (skip mode).

With regard to a skip macroblock, neither residual of the object block nor residual vector is encoded. At the time of decoding, the prediction vector is employed as the shift vector of the skip macroblock without change, and a copy of a block (current block) at a position in the reference image shifted from the position of the skip macroblock by an amount equivalent to the shift vector (prediction vector) is taken as the decoding results of the skip macroblock.

Whether or not to take a current block as a skip macroblock depends on the specifications of the encoder, and is decided (determined based on, for example, amount of code of the encoded data, encoding cost of the current block, and so forth.

### Configuration Example of Inter Prediction Unit 123

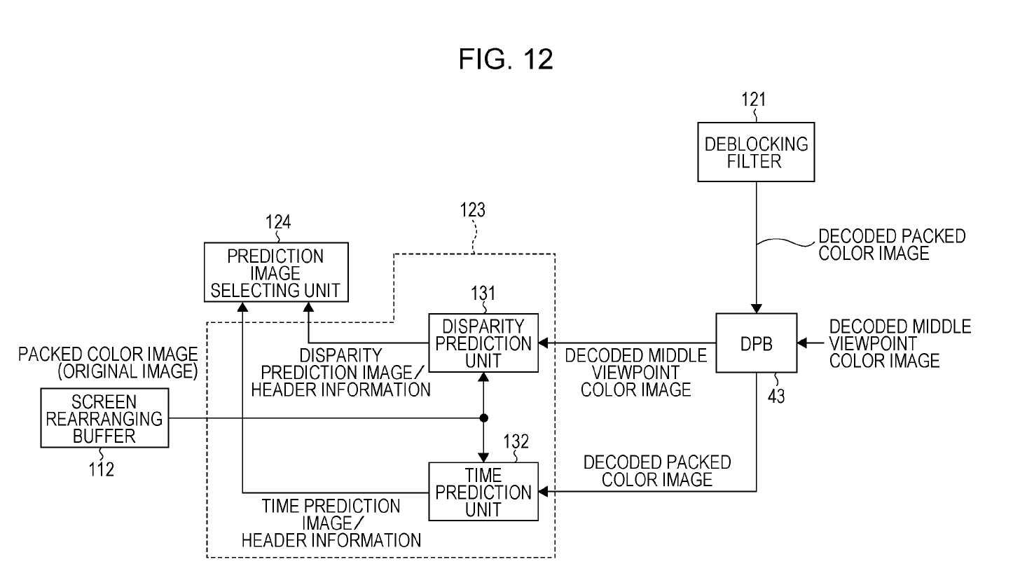

FIG. 12 is a block diagram illustrating a configuration example of the inter prediction unit 123 of the encoder 42 in FIG. 9.

The inter prediction unit 123 has a disparity prediction unit 131 and a temporal prediction unit 132.

Now, in FIG. 12, the DPB 43 is supplied from the deblocking filter 121 with a decoded image, i.e., a picture of a packed color image encoded at the encoder 42 and locally decoded (hereinafter also referred to as decoded packed color image), and stored as (a picture that can become) a reference image.

Also, as described with FIG. 5 and FIG. 9, a picture of a multi-viewpoint color image encoded at the encoder 41 and locally decoded (hereinafter also referred to as decoded middle viewpoint color image) is also supplied to the DPB 43 and stored.

At the encoder 42, in addition to the picture of the decoded packed color image from the deblocking filter 121, the picture of the decoded middle viewpoint color image obtained at the encoder 41 is used (to generate a prediction image) to encode the packed color image to be encoded. Accordingly, in FIG. 12, an arrow is shown illustrating that the decoded middle viewpoint color image obtained at the encoder 41 is to be supplied to the DPB 43.

The disparity prediction unit 131 is supplied with the current picture of the packed color image from the screen rearranging buffer 112.

The disparity prediction unit 131 performs disparity prediction of the current block of the current picture of the packed color image from the screen rearranging buffer 112, using the picture of the decoded middle viewpoint color image stored in the DPB 43 (picture of same point-in-time as current picture) as a reference image, and generates a prediction image of the current block.

That is to say, the disparity prediction unit 131 performs ME with the picture of the decoded middle viewpoint color image stored in the DPB 43 as a reference image, thereby obtaining a disparity vector of the current block.

Further, the disparity prediction unit 131 performs MC following the disparity vector of the current block, with the picture of the decoded middle viewpoint color image stored in the DPB 43 as a reference image, thereby generating a prediction image of the current block.

Also, the disparity prediction unit 131 calculates encoding cost needed for encoding of the current block using the prediction image obtained by disparity prediction from the reference image (prediction encoding), for each macroblock type.

The disparity prediction unit 131 then selects the macroblock type of which the encoding cost is smallest, as the optimal inter prediction mode, and supplies a prediction image generated in that optimal inter prediction mode (disparity prediction image) to the prediction image selecting unit 124.

Further, the disparity prediction unit 131 supplies information of the optimal inter prediction mode and so forth to the prediction image selecting unit 124 as header information.

Note that as described above, reference indices are assigned to reference images, with a reference index assigned to a reference image referred to at the time of generating a prediction image generated in the optimal inter prediction mode being selected at the disparity prediction unit 131 as the reference index for prediction of the current block, and supplied to the prediction image selecting unit 124 as one of header information.

The temporal prediction unit 132 is supplied from the screen rearranging buffer 112 with the current picture of the packed color image.

The temporal prediction unit 132 performs temporal prediction of the current block of the current picture of the packed color image from the screen rearranging buffer 112, using the picture of the decoded packed color image stored in the DPB 43 (picture at different point-in-time as current picture) as a reference, and generates a prediction image of the current block.

That is to say, the temporal prediction unit 132 performs ME with the picture of the decoded packed color image stored in the DPB 43 as a reference image, thereby obtaining a motion vector of the current block.

Further, the temporal prediction unit 132 performs MC following the motion vector of the current block, with the picture of the decoded packed color image stored in the DPB 43 as a reference image, thereby generating a prediction image of the current block.

Also, the temporal prediction unit 132 calculates encoding cost needed for encoding of the current block using the prediction image obtained by temporal prediction from the reference image (prediction encoding), for each macroblock type.

The temporal prediction unit 132 then selects the macroblock type of which the encoding cost is smallest, as the optimal inter prediction mode, and supplies a prediction image generated in that optimal inter prediction mode (temporal prediction image) to the prediction image selecting unit 124.

Further, the temporal prediction unit 132 supplies information of the optimal inter prediction mode and so forth to the prediction image selecting unit 124 as header information.

Note that as described above, reference indices are assigned to reference images, with a reference index assigned to a reference image referred to at the time of generating a prediction image generated in the optimal inter prediction mode being selected at the temporal prediction unit 132 as the reference index for prediction of the current block, and supplied to the prediction image selecting unit 124 as one of header information.

At the prediction image selecting unit 124, of the prediction images from the intra-screen prediction unit 122, and the disparity prediction unit 131 and temporal prediction unit 132 making up the inter prediction unit 123, for example, the prediction image of which the encoding cost is smallest is selected, and supplied to the computing units 113 and 120.

Now, with the present embodiment, we will say that a reference index of a value 1 is assigned to a reference image referred to in disparity prediction (here, the picture of the decoded middle viewpoint color image), for example, and a reference index of a value 0 is assigned to a reference image referred to in temporal prediction (here, the picture of the decoded packed color image).

### Configuration Example of Disparity Prediction Unit 131

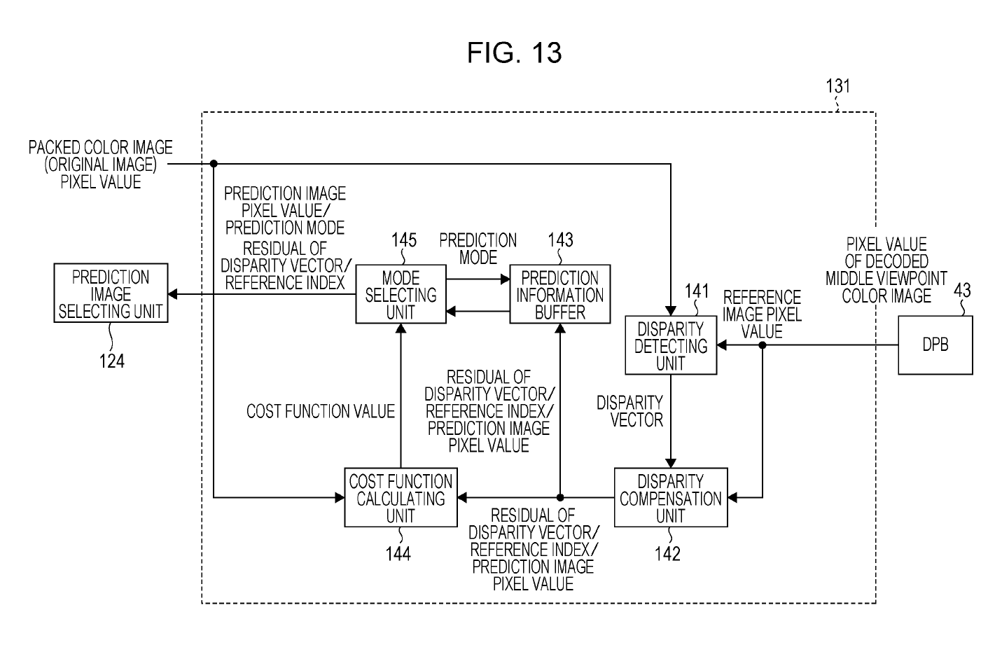

FIG. 13 is a block diagram illustrating a configuration example of the disparity prediction unit 131 in FIG. 12.

In FIG. 13, the disparity prediction unit 131 has a disparity detecting unit 141, a disparity compensation unit 142, a prediction information buffer 143, a cost function calculating unit 144, and a mode selecting unit 145.

The picture of the decoded middle viewpoint color image serving as the reference image is supplied from the DPB 43 to the disparity detecting unit 141, and also the picture of the packed color image to be encoded (current picture) is also supplied thereto from the screen rearranging buffer 112.

The disparity detecting unit 141 performs ME using the current block and the picture of the decoded middle viewpoint color image which is the reference image, thereby detecting, at the current block and picture of decoded middle viewpoint color image, a disparity vector my representing the shift as to the current block, which maximizes encoding efficiency such as minimizing SAD or the like as to the current block or the like for example, for each macroblock type, which are supplied to the disparity compensation unit 142.

The disparity compensation unit 142 is supplied from the disparity detecting unit 141 with disparity vectors mv, and also is supplied with the picture of the decoded middle viewpoint color image serving as the reference image from the DPB 43.

The disparity compensation unit 142 performs disparity compensation of the reference image from the DPB 43 using the disparity vectors my of the current block from the disparity detecting unit 141, thereby generating a prediction image of the current block, for each macroblock type.

That is to say, the disparity compensation unit 142 obtains a corresponding block which is a block (region) in the picture of the decoded middle viewpoint color image serving as the reference image, shifted by an amount equivalent to the disparity vector my from the position of the current block, as a prediction image.

Also, the disparity compensation unit 142 uses disparity vectors of macroblocks at the periphery of the current block, that have already been encoded, as necessary, thereby obtaining a prediction vector PMV of the disparity vector my of the current block.

Further, the disparity compensation unit 142 obtains a residual vector which is the difference between the disparity vector my of the current block and the prediction vector PMV.

The disparity compensation unit 142 then correlates the prediction image of the current block for each prediction mode, such as macroblock type, with the prediction mode, along with the residual vector of the current block and the reference index assigned to the reference image (here, the picture of the decoded middle viewpoint color image) used for generating the prediction image, and supplies to the prediction information buffer 143 and the cost function calculating unit 144.

The prediction information buffer 143 temporarily stores the prediction image correlated with the prediction mode, residual vector, and reference index, from the disparity compensation unit 142, along with the prediction mode thereof, as prediction information.

The cost function calculating unit 144 is supplied from the disparity compensation unit 142 with the prediction image correlated with the prediction mode, residual vector, and reference index, and is supplied from the screen rearranging buffer 112 with the current picture of the packed color image.

The cost function calculating unit 144 calculates the encoding cost needed to encode the current block of the current picture from the screen rearranging buffer 112 following a predetermined cost function for calculating encoding cost, for each macroblock type (FIG. 10) serving as prediction mode.

That is to say, the cost function calculating unit 144 obtains a value MV corresponding to the code amount of residual vector from the disparity compensation unit 142, and also obtains a value IN corresponding to the code amount of reference index (reference index for prediction) from the disparity compensation unit 142.

Further, the cost function calculating unit 144 obtains a SAD which is a value D corresponding to the code amount of residual of the current block, as to the prediction image from the disparity compensation unit 142.

The cost function calculating unit 144 then obtains the encoding cost (cost function value of the cost function) COST for each macroblock type, following an expression COST=D+λ1×MV+λ2×IN, weighted by λ1 and λ2, for example.

Upon obtaining the encoding cost (cost function value) for each macroblock type, the cost function calculating unit 144 supplies the encoding cost to the mode selecting unit 145.

The mode selecting unit 145 detects the smallest cost which is the smallest value, from the encoding costs for each macroblock type from the cost function calculating unit 144.

Further, the mode selecting unit 145 selects the macroblock type of which the smallest cost has been obtained, as the optimal inter prediction mode.

The mode selecting unit 145 then reads out the prediction image correlated with the prediction mode which is the optimal inter prediction mode, residual vector, and reference index, from the prediction information buffer 143, and supplies to the prediction image selecting unit 124 along with the prediction mode which is the optimal inter prediction mode.

Now, the prediction mode (optimal inter prediction mode), residual vector, and reference index (reference index for prediction), supplied from the mode selecting unit 145 to the prediction image selecting unit 124, are prediction mode related information related to inter prediction (disparity prediction here), and at the prediction image selecting unit 124, the prediction mode related information relating to this inter prediction is supplied to the variable length encoding unit 116 (FIG. 9) as header information, as necessary.

Note that the temporal prediction unit 132 in FIG. 12 performs the same processing as with the disparity prediction unit 131 in FIG. 13, except for that the reference image is a picture of a decoded packed color image rather than a picture of a decoded middle viewpoint color image.

### Configuration Example of Decoding Device 32C

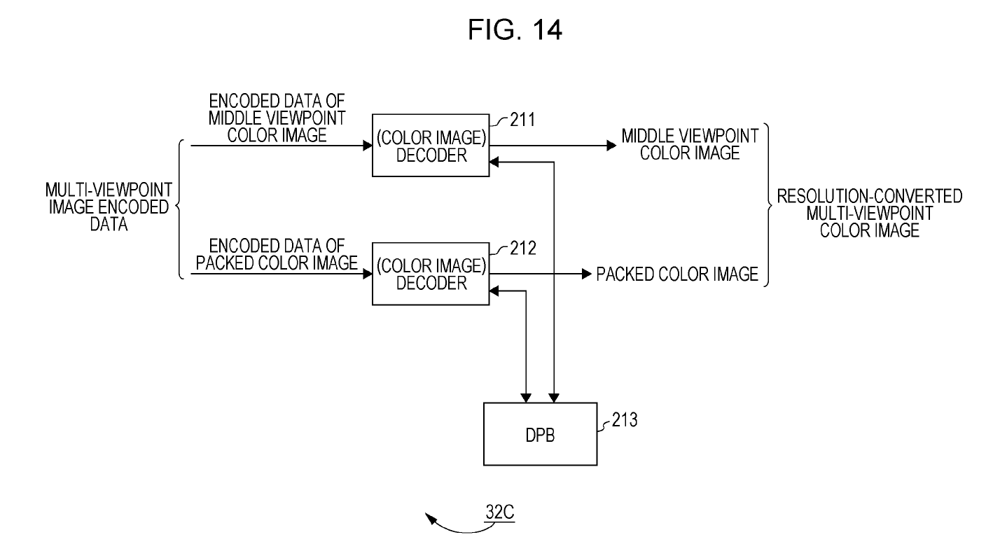

FIG. 14 is a block diagram illustrating a configuration example of the decoding device 32C in FIG. 3.

The decoding device 32C in FIG. 14 decodes, with MVC, a middle viewpoint color image which is multi-viewpoint color image encoded data from the inverse multiplexing device 31 (FIG. 3), and encoded data of a packed color image.

In FIG. 14, the decoding device 32C has decoders 211 and 212, and a DPB 213.

The decoder 211 is supplied with the encoded data of a middle viewpoint color which is a base view image, of multi-viewpoint color image encoded data from the inverse multiplexing device 31 (FIG. 3).

The decoder 211 decodes the encoded data of the middle viewpoint color image supplied thereto with MVC, and outputs the middle viewpoint color image obtained as the result thereof.

The decoder 212 is supplied with, of the multi-viewpoint color image encoded data from the inverse multiplexing device 31 (FIG. 3), encoded data of the packed color image which is a non base view image.

The decoder 212 decodes the encoded data of the packed color image supplied thereto, by MVC, and outputs a packed color image obtained as the result thereof.

Now, the multi-viewpoint color image which the decoder 211 outputs and the packed color image which the decoder 212 outputs are supplied to the resolution inverse converting device 33C (FIG. 3) as a resolution-converted multi-viewpoint color image.

The DPB 213 temporarily stores the images after decoding (decoded images) obtained by decoding the images to be decoded at each of the decoders 211 and 212 as (candidates of) reference images to be referenced at the time of generating a prediction image.

That is to say, the decoders 211 and 212 each encode images subjected to prediction encoding at the encoders 41 and 42 in FIG. 5.

In order to decode an image subjected to prediction encoding, the prediction image used for the prediction encoding is necessary, so the decoders 211 and 212 decode the images to be decoded, and thereafter temporarily store the decoded images to be used for generating of a prediction image, in the DPB 213, to generate the prediction image used in the prediction encoding.

The DPB 213 is a shared buffer to temporarily store images after decoding (decoded images) obtained at each of the decoders 211 and 212, with each of the decoders 211 and 212 selecting a reference image to reference to decode the image to e decoded, from the decoded images stored in the DPB 213, and generating prediction images using the reference images.

The DPB 213 is shared between the decoders 211 and 212, so the decoders 211 and 212 can each reference, besides decoded images obtained from itself, decoded images obtained at the other decoder as well.

Note however, the decoder 211 decodes base view images, so only references decoded images obtained at the decoder 211.

### Configuration Example of Decoder 212

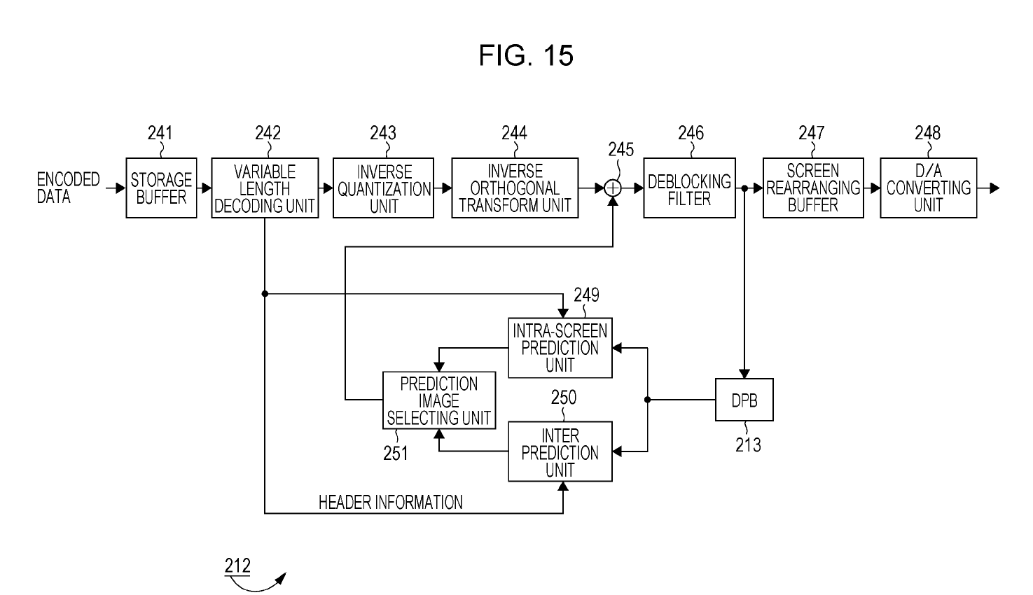

FIG. 15 is a block diagram illustrating a configuration example of the decoder 212 in FIG. 14.

In FIG. 15, the decoder 212 has a storage buffer 241, a variable length decoding unit 242, an inverse quantization unit 243, an inverse orthogonal transform unit 244, a computing unit 245, a deblocking filter 246, a screen rearranging buffer 247, a D/A conversion unit 248, an intra-screen prediction unit 249, an inter prediction unit 250, and a prediction image selecting unit 251.

The storage buffer 241 is supplied from the inverse multiplexing device 31 with, of the encoded data of the middle viewpoint color image and packed color image configuring the multi-viewpoint color image encoded data, the encoded data of the packed color image.

The storage buffer 241 temporarily stores the encoded data supplied thereto, and supplies to the variable length decoding unit 242.

The variable length decoding unit 242 performs variable length decoding of the encoded data from the storage buffer 241, thereby restoring quantization values and prediction mode related information which has been header information. The variable length decoding unit 242 then supplies quantization values to the inverse quantization unit 243, and supplies header information (prediction mode related information) to the intra-screen prediction unit 249 and inter prediction unit 250.

The inverse quantization unit 243 performs inverse quantization of the quantization values from the variable length decoding unit 242 into transform coefficients, and supplies to the inverse orthogonal transform unit 244.

The inverse orthogonal transform unit 244 performs inverse orthogonal transform of the transform coefficients from the inverse quantization unit 243 in increments of macroblocks, and supplies to the computing unit 245.

The computing unit 245 takes a macroblock supplied from the inverse orthogonal transform unit 244 as a current block to be decoded, and adds the prediction image supplied from the prediction image selecting unit 251 to the current block as necessary, thereby obtaining a decoded image, which is supplied to the deblocking filter 246.

The deblocking filter 246 performs filtering on the decoded image from the computing unit 245 in the same way as with the deblocking filter 121 in FIG. 9 for example, and supplies a decoded image after this filtering to the screen rearranging buffer 247.

The screen rearranging buffer 247 temporarily stores and reads out pictures of decoded images from the deblocking filter 246, thereby rearranging the order of pictures in the original order (display order) and supplies to the D/A (Digital/Analog) conversion unit 248.

In the event that a picture from the screen rearranging buffer 247 needs to be output as analog signals, the D/A conversion unit 248 D/A converts the picture and outputs.

Also, the deblocking filter 246 supplies, of the decoded images after filtering, the decoded images of I picture, P pictures, and Bs pictures that are referable pictures, to the DPB 213.

Now, the DPB 213 stores pictures of decoded images from the deblocking filter 246, i.e., pictures of packed color images, as reference images to be referenced at the time of generating prediction images, to be used in decoding performed later in time.

As described with FIG. 14, the DPB 213 is shared between the decoders 211 and 212, and accordingly stores, besides pictures of packed color image (decoded packed color images) decoded at the decoder 212, pictures of middle viewpoint color images (decoded middle viewpoint color images) decoded at the decoder 211.

The intra-screen prediction unit 249 recognizes whether or not the current block has been encoded using a prediction image generated by intra prediction (intra-screen prediction), based on header information from the variable length decoding unit 242.

In the event that the current block has been encoded using a prediction image generated by intra prediction, in the same way as with the intra-screen prediction unit 122 in FIG. 9, the intra-screen prediction unit 249 reads out the already-decoded portion (decoded image) of the picture including the current block (current picture) from the DPB 213. The intra-screen prediction unit 249 then supplies the portion of the decoded image from the current picture that has been read out from the DPB 213 to the prediction image selecting unit 251, as a prediction image of the current block.

The inter prediction unit 250 recognizes whether or not the current block has been encoded using the prediction image generated by inter prediction, based on the header information from the variable length decoding unit 242.

In the event that the current block has been encoded using a prediction image generated by inter prediction, the inter prediction unit 250 recognizes a reference index for prediction, i.e., the reference index assigned to the reference image used to generate the prediction image of the current block, based on the header information (prediction mode related information) from the variable length decoding unit 242.

The inter prediction unit 250 then reads out, from the picture of the decoded packed color image and picture of the decoded middle viewpoint color image, stored in the DPB 213, the picture to which the reference index for prediction has been assigned, as the reference image.

Further, the inter prediction unit 250 recognizes the shift vector (disparity vector, motion vector) used to generate the prediction image of the current block, based on the header information from the variable length decoding unit 242, and in the same way as with the inter prediction unit 123 in FIG. 9 performs shift compensation of the reference image (motion compensation to compensate for shift equivalent to an amount moved, or disparity compensation to compensate for shift equivalent to amount of disparity) following the shift vector, thereby generating a prediction image.

That is to say, the inter prediction unit 250 acquires a block (current block) at a position moved (shifted) from the position of the current block in the reference image, in accordance with the shift vector of the current block, as a prediction image.

The inter prediction unit 250 then supplies the prediction image to the prediction image selecting unit 251.

In the event that the prediction image is supplied from the intra-screen prediction unit 249, the prediction image selecting unit 251 selects that prediction image, and in the event that the prediction image is supplied from the inter prediction unit 250, selects that prediction image, and supplies to the computing unit 245.

### Configuration Example of Inter Prediction Unit 250

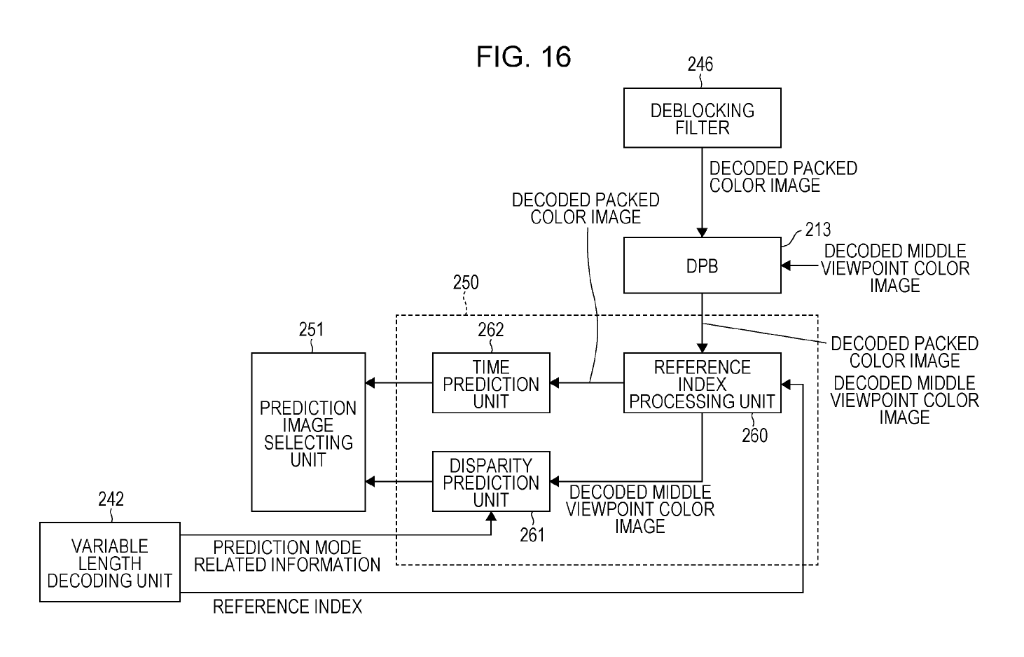

FIG. 16 is a block diagram illustrating a configuration example of the inter prediction unit 250 of the decoder 212 in FIG. 15.

In FIG. 16, the inter prediction unit 250 has a reference index processing unit 260, a disparity prediction unit 261, and a time prediction unit 262.

Now, in FIG. 16, the DPB 213 is supplied with a decoded image, i.e., the picture of a decoded packed color image decoded at the decoder 212, from the deblocking filter 246, which is stored as a reference image.

Also, as described with FIG. 14 and FIG. 15, the DPB 213 is supplied with the picture of a decoded middle viewpoint color image decoded at the decoder 211, and this is stored. Accordingly, in FIG. 16, an arrow is illustrated indicating that the decoded middle viewpoint color image obtained at the decoder 211 is supplied to the DPB 213.

The reference index processing unit 260 is supplied with, of the prediction mode related information which is header information from the variable length decoding unit 242, the reference index (for prediction) of the current block.

The reference index processing unit 260 reads out the picture of the decoded middle viewpoint color image to which the reference index for prediction of the current block from the variable length decoding unit 242 has been assigned, or decoded packed color image, from the DPB 213, and supplies to the disparity prediction unit 261 or the time prediction unit 262.

Now, with the present embodiment, a reference index of value 1 is assigned at the encoder 42 to a picture) of the decoded middle viewpoint color image which is the reference image referenced in disparity prediction, and a reference index of value 0 is assigned to a picture of the decoded packed color image which is the reference image referenced in temporal prediction, as described with FIG. 12.

Accordingly, whether the reference image to be used for generating a prediction image of the current block is a picture of the decoded middle viewpoint color image or a picture of the decoded packed color image can be recognized by the reference index for prediction of the current block, and further, which of temporal prediction and disparity prediction the shift prediction is to be performed when generating a prediction image for the current block can also be recognized.

In the event that the picture to which the reference index for prediction of the current block has been assigned, from the variable length decoding unit 242, is a picture of the decoded middle viewpoint color image (in the event that the reference index for prediction is 1), the prediction image of the current block is generated by disparity prediction, so the reference index processing unit 260 reads out the picture of the decoded middle viewpoint color image to which (the reference index matching) the reference index for prediction has been assigned from the DPB 213 as a reference image, and supplies this to the disparity prediction unit 261.

Also, in the event that the picture to which the reference index for prediction of the current block has been assigned, from the variable length decoding unit 242, is a picture of the decoded packed color image (in the event that the reference index for prediction is 0), the prediction image of the current block is generated by temporal prediction, so the reference index processing unit 260 reads out the picture of the decoded packed color image to which (the reference index matching) the reference index for prediction has been assigned from the DPB 213 as a reference image from the DPB 213, and supplies this to the time prediction unit 262.

The disparity prediction unit 261 is supplied with prediction mode related information which is header information from the variable length decoding unit 242.

The disparity prediction unit 261 recognizes whether the current block has been encoded using a prediction image generated by disparity prediction, based on the header information from the variable length decoding unit 242.

In the event that the current block is encoded using the prediction image generated with disparity prediction, the disparity prediction unit 261 restores the disparity vector used for generating the prediction image of the current block, based on the header information from the variable length decoding unit 242, and in the same way as with the disparity prediction unit 131 in FIG. 12, generates a prediction image by performing disparity prediction (disparity compensation) in accordance with that disparity vector.

That is to say, in the event that the current block has been encoded using a prediction image generated by disparity prediction, the disparity prediction unit 261 is supplied from the reference index processing unit 260 with a picture of the decoded middle viewpoint color image as a reference image, as described above.

The disparity prediction unit 261 acquires a block (corresponding block) at a position moved (shifted) from the position of the current block in the picture of the decoded middle viewpoint color image serving as the reference image from the reference index processing unit 260, in accordance with the shift vector of the current block, as a prediction image.

The disparity prediction unit 261 then supplies the prediction image to the prediction image selecting unit 251.

The time prediction unit 262 is supplied with prediction mode related information which is header information from the variable length decoding unit 242.

The time prediction unit 262 recognizes whether the current block has been encoded using a prediction image generated by temporal prediction, based on the header information from the variable length decoding unit 242.

In the event that the current block is encoded using the prediction image generated with temporal prediction, the time prediction unit 262 restores the motion vector used for generating the prediction image of the current block, based on the header information from the variable length decoding unit 242, and in the same way as with the temporal prediction unit 132 in FIG. 12, generates a prediction image by performing temporal prediction (motion compensation) in accordance with that motion vector.

That is to say, in the event that the current block has been encoded using a prediction image generated by temporal prediction, the time prediction unit 262 is supplied from the reference index processing unit 260 with a picture of the decoded packed color image as a reference image, as described above.

The time prediction unit 262 acquires a block (corresponding block) at a position moved (shifted) from the position of the current block in the picture of the decoded packed color image serving as the reference image from the reference index processing unit 260, in accordance with the shift vector of the current block, as a prediction image.

The time prediction unit 262 then supplies the prediction image to the prediction image selecting unit 251.

### Configuration Example of Disparity Prediction Unit 261

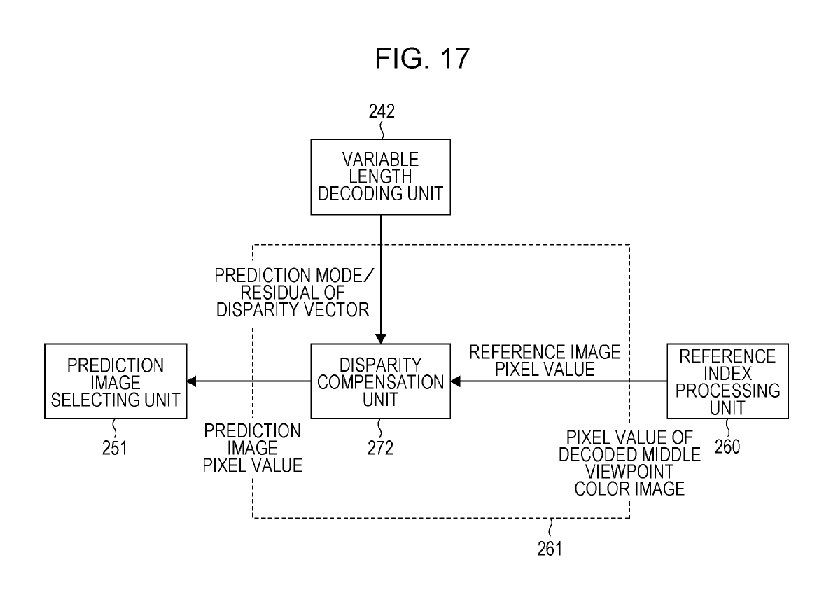

FIG. 17 is a block diagram illustrating a configuration example of the disparity prediction unit 261 in FIG. 16.

In FIG. 17, the disparity prediction unit 261 has a disparity compensation unit 272.

The disparity compensation unit 272 is supplied from the reference index processing unit 260 with a picture of the decoded middle viewpoint color image serving as the reference image, and with the prediction mode and residual vector included in the mode related information serving as the header information from the variable length decoding unit 242.

The disparity compensation unit 272 obtains the prediction vector of the disparity vector of the current block, using the disparity vectors of macroblocks already decoded as necessary, and adds the prediction vector to the residual vector of the current block from the variable length decoding unit 242, thereby restoring the disparity vector my of the current block.

Further, the disparity compensation unit 272 performs disparity compensation of the picture of the decoded middle viewpoint color image serving as the reference image from the reference index processing unit 260 using the disparity vector my of the current block, thereby generating a prediction image of the current block for the macroblock type that the prediction mode from the variable length decoding unit 242 indicates.

That is to say, the disparity compensation unit 272 acquires the current block which is a block in the picture of the decoded middle viewpoint color image at a position shifted from the current block position by an amount equivalent to the disparity vector mv, as the prediction image.

The disparity compensation unit 272 then supplies the prediction image to the prediction image selecting unit 251.

Note that, with the time prediction unit 262 in FIG. 16, processing the same as with the disparity prediction unit 261 in FIG. 17 is performed, except that the reference image is a picture of a decoded packed color image, rather than a picture of the decoded middle viewpoint color image.

As described above, with MVC, disparity prediction can also be performed for non base view images besides temporal prediction, so encoding efficiency can be improved.

However, as described above, in the event that the non base view image is a packed color image, and the base view image which is referenced (can be referenced) in disparity prediction is a middle viewpoint color image, the prediction precision (prediction efficiency) of disparity prediction may deteriorate.

Accordingly, to simplify description, let us say now that the horizontal and vertical resolution ratio (the ratio of the number of horizontal pixels and the number of vertical pixels) of the middle viewpoint color image, left viewpoint color image, and right viewpoint color image, is 1:1.

As described with FIG. 4 for example, a packed color image is one viewpoint worth of image, where the vertical resolution of each of the left viewpoint color image and right viewpoint color image have been made to be ½, and the left viewpoint color image and right viewpoint color image of which the resolution has been made to be ½ are vertically arrayed.

Accordingly, at the encoder 42 (FIG. 9), the resolution ratio of the packed color image to be encoded (image to be encoded), and the resolution ratio of the middle viewpoint color image (decoded middle viewpoint color image) which is a reference image of a different viewpoint from the packed color image, to be referenced in disparity prediction at the time of generating a prediction image of that packed color image, do not agree (match).

That is to say, with the packed color image, the resolution in the vertical direction (vertical resolution) of each of the left viewpoint color image and right viewpoint color image is ½ of the original, and accordingly, the resolution ratio of the left viewpoint color image and right viewpoint color image that are the packed color image is 2:1.

On the other hand, the resolution ratio of the middle viewpoint color image serving as the reference image is 1:1, and this does not agree with resolution ratio of 2:1 of the left viewpoint color image and right viewpoint color image that are the packed color image.

In the event that the resolution ratio of the packed color image and the resolution ratio of the middle viewpoint color image do not agree, i.e., in the event that the resolution ratio of the left viewpoint color image and right viewpoint color image that are the packed color image and the resolution ratio of the middle viewpoint color image serving as the reference image do not agree, the prediction precision of disparity prediction deteriorates (the residual between the prediction image generated in disparity prediction and the current block becomes great), and encoding efficiency deteriorates.

### Configuration Example of Transmission Device 11

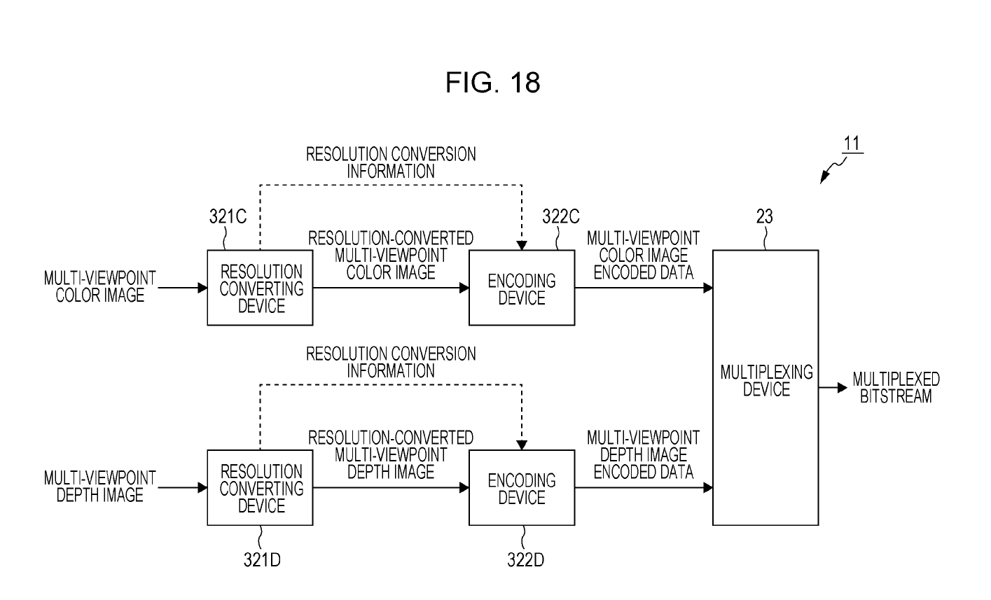

Accordingly, FIG. 18 is a block diagram illustrating another configuration example of the transmission device 11 in FIG. 1.

Note that portions corresponding to the case in FIG. 2 are denoted with the same symbols, and description hereinafter will be omitted as appropriate.

In FIG. 18, the transmission device 11 has resolution converting devices 321C and 321D, encoding devices 322C and 322D, and a multiplexing device 23.

Accordingly, the transmission device 11 in FIG. 18 has in common with the case in FIG. 2 the point of having the multiplexing device 23, and differs from the case in FIG. 2 regarding the point that the resolution converting devices 321C and 321D and encoding devices 322C and 322D have been provided instead of the resolution converting devices 21C and 21D and encoding devices 22C and 22D.

A multi-viewpoint color image is supplied to the resolution converting device 321C.

The resolution converting device 321C performs processing the same as each of the resolution converting device 21C in FIG. 2, for example.

That is to say, the resolution converting device 321C performs resolution conversion of converting a multi-viewpoint color image supplied thereto into a resolution-converted multi-viewpoint color image having a low resolution lower than the original resolution, and supplies the resolution-converted multi-viewpoint color image obtained as a result thereof to the encoding device 322C.

Further, the resolution converting device 321C generates resolution conversion information, and supplies to the encoding device 322C.

Now, the resolution conversion information which the resolution converting device 321C generates is information relating to resolution conversion of the multi-viewpoint color image into a resolution-converted multi-viewpoint color image performed at the resolution converting device 321C, and includes resolution information relating to (the left viewpoint color image and right viewpoint color image configuring) the packed color image which is the image to be encoded at the downstream encoding device 322C, to be encoded using disparity prediction, and the middle viewpoint color image which is a reference image of a different viewpoint from the image to be encoded, referenced in the disparity prediction of that image to be encoded.

That is to say, with the encoding device 322C, the resolution-converted multi-viewpoint color image obtained as the result of resolution conversion at the resolution converting device 321C is encoded, and the resolution-converted multi-viewpoint color image to be encoded is the middle viewpoint color image and packed color image, as described with FIG. 4.

Of the middle viewpoint color image and packed color image, the image to be encoded using disparity prediction is the packed color image which is a non base view image, and the reference image referenced in the disparity prediction of the packed color image is the middle viewpoint color image.

Accordingly, the resolution conversion information which the resolution converting device 321C generates includes information relating to the resolution of the packed color image and the middle viewpoint color image.

The encoding device 322C encodes the resolution-converted multi-viewpoint color image supplied from the resolution converting device 321C with an extended format where a standard such as MVC or the like, which is a standard for transmitting images of multiple viewpoints, has been extended, for example, and middle viewpoint color image encoded data which is encoded data obtained as the result thereof is supplied to the multiplexing device 23.

Note that for the standard to serve as the basis for the extended format which is the encoding format of the encoding device 322C, besides MVC, a standard such as HEVC (High Efficiency Video Coding) or the like, which can transmit images of multiple viewpoints, can be employed.

A multi-viewpoint color image is supplied to the resolution converting device 321D.

The resolution converting device 321D and encoding device 322D each perform the same processing as the resolution converting device 321C and encoding device 322C, except that processing is performed on depth images (multi-viewpoint depth images), rather than color images (multi-viewpoint color images).

### Configuration Example of Reception Device 12

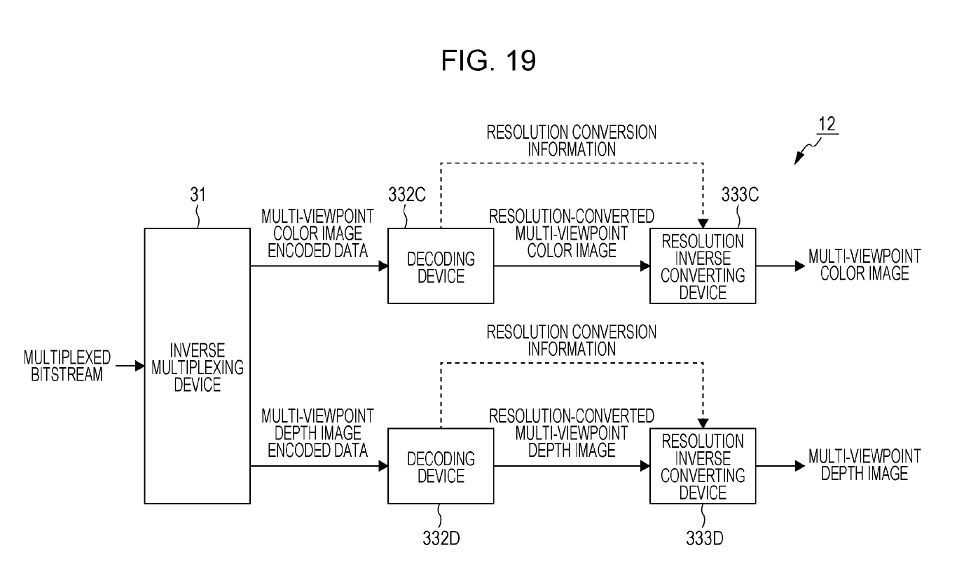

FIG. 19 is a diagram illustrating another configuration example of the reception device 12 in FIG. 1.

That is to say, FIG. 19 illustrates a configuration example of the reception device 12 in FIG. 1 in a case where the transmission device 11 in FIG. 1 has been configured as illustrated in FIG. 18.

Note that portions corresponding to the case in FIG. 3 are denoted with the same symbols, and description hereinafter will be omitted as appropriate.

In FIG. 19, the reception device 12 has an inverse multiplexing device 31, decoding devices 332C and 332D, and resolution inverse converting devices 333C and 333D.

Accordingly, the reception device 12 in FIG. 19 has in common with the case in FIG. 3 the point of having the inverse multiplexing device 31, and differs from the case in FIG. 3 that decoding devices 332C and 332D and resolution inverse converting devices 333C and 333D have been provided instead of the decoding devices 32C and 32D and resolution inverse converting devices 33C and 33D.

The decoding device 332C decodes the multi-viewpoint color image encoded data supplied from the inverse multiplexing device 31 with an extended format, and supplies the resolution-converted multi-viewpoint color image and resolution conversion information obtained as a result thereof to the resolution inverse converting device 333C.

The resolution inverse converting device 333C performs inverse resolution conversion to (inverse) convert the resolution-converted multi-viewpoint color image from the decoding device 332C into the original resolution, based on the resolution conversion information also from the decoding device 332C, and outputs the multi-viewpoint color image obtained as a result thereof.

The decoding device 332D and resolution inverse converting device 333D each perform the same processing as the decoding device 332C and resolution inverse converting device 333C, except that processing is performed on multi-viewpoint depth image encoded data (resolution-converted multi-viewpoint depth image) from the inverse multiplexing device 31 rather than multi-viewpoint color image encoded data (resolution-converted multi-viewpoint color image).

### Resolution Conversion and Resolution Inverse Conversion

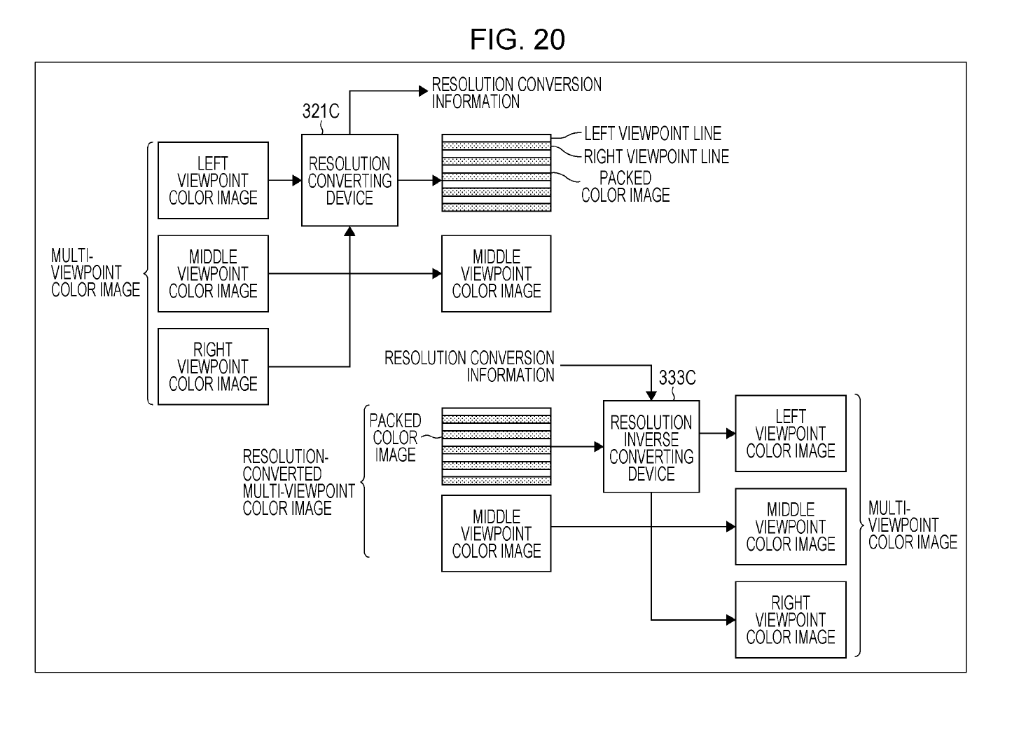

FIG. 20 is a diagram for describing resolution conversion which the resolution converting device 321C (and 321D) in FIG. 18 performs, and the resolution inverse conversion which the resolution inverse converting device 333C (and 333D) in FIG. 19 performs.

In the same way as with the resolution converting device 21C in FIG. 2 for example, the resolution converting device 321C (FIG. 18) outputs, of the middle viewpoint color image, left viewpoint color image, and right viewpoint color image, which are the multi-viewpoint color image supplied thereto, the middle viewpoint color image for example, as it is (without performing resolution conversion).

Also, the resolution converting device 321C converts the resolution of the two of the remaining left viewpoint color image and right viewpoint color image of the multi-viewpoint color image to lower resolution, and packs by combining into one viewpoint worth of image, thereby generating and outputting a packed color image.

That is to say, the resolution converting device 321C converts the vertical resolution (number of pixels) of each of (the frame of) the left viewpoint color image and (the frame of) the right viewpoint color image, for example, to ½, and for example vertically arrays the lines (horizontal lines) of each of the left viewpoint color image and right viewpoint color image, each of which the vertical resolution has been made to be ½, thereby generating a packed color image which is (a frame of) one viewpoint worth of image.

Now, in FIG. 20, at the resolution converting device 321C, the vertical resolution of the left viewpoint color image is made to be ½ (of the original) by extracting only odd lines, for example, which are one of odd lines and even lines of the left viewpoint color image, from the left viewpoint color image.

Further, at the resolution converting device 321C, the vertical resolution of the right viewpoint color image is made to be ½ by extracting only even lines, for example, which are one of odd lines and even lines of the right viewpoint color image, from the right viewpoint color image.

The resolution converting device 321C then disposes the lines of the left viewpoint color image (hereinafter also referred to as left viewpoint lines) of which the vertical resolution has be made to be ½ (odd lines of the original left viewpoint color image) as lines of the top field which is the field of odd lines, and the lines of the right viewpoint color image (hereinafter also referred to as right viewpoint lines) of which the vertical resolution has be made to be ½ (even lines of the original right viewpoint color image) as lines of the bottom field which is the field of even lines, thereby generating (a frame of) a packed color image.

Now, while left viewpoint lines are employed as odd lines of the packed color image and right viewpoint lines are employed as even lines of the packed color image in FIG. 20, right viewpoint lines may be employed as odd lines of the packed color image and left viewpoint lines employed as even lines of the packed color image.

Also, the resolution converting device 321C may extract just even lines of the left viewpoint color image and make the vertical resolution to be ½. Further, just odd lines of the right viewpoint color image may be extracted in the same way, so as to make the vertical resolution to be ½.

The resolution converting device 321C further generates resolution conversion information indicating that the resolution of the middle viewpoint color image is unchanged, that the packed color image is one viewpoint worth of image where left viewpoint lines of the left viewpoint color image and right viewpoint lines of the right viewpoint color image (of which the vertical resolution has been made to be ½) alternately arrayed, and so forth.

On the other hand, the resolution inverse converting device 333C (FIG. 19) recognizes, from the resolution conversion information supplied thereto, that the resolution of the middle viewpoint color image is unchanged, that the packed color image is one viewpoint worth of image where the left viewpoint lines of the left viewpoint color image and the right viewpoint lines of the right viewpoint color image have been arrayed vertically, and so forth.

The resolution inverse converting device 333C then outputs, of the middle viewpoint color image and packed color image which are the multi-viewpoint color image supplied thereto, the middle viewpoint color image as it is, based on the information recognized from the resolution conversion information.

Also, the resolution inverse converting device 333C separates, of the middle viewpoint color image and packed color image which are the multi-viewpoint color image supplied thereto, the packed color image into odd lines which are lines of the top field and even lines which are the lines of the bottom field, based on the information that has been recognized from the resolution conversion information.

Further, the resolution inverse converting device 333C restores, to the original resolution, the vertical resolution of the left viewpoint color image and right viewpoint color image obtained by separating into odd lines and even lines the packed color image of which the vertical resolution had been made to be ½, by interpolation or the like, and outputs.

Note that the multi-viewpoint color image (and multi-viewpoint depth image) may be an image of four or more viewpoints. In the event that the multi-viewpoint color image is an image of four or more viewpoints, two or more packed color images, where two viewpoint color images of which the vertical resolution has been made to be ½ are packed into one image worth (of data amount) as described above, can be generated. Also, a packed color image may be generated where an image of which lines of K viewpoints of which the vertical resolution has been made to be 1/K are repeatedly arrayed in order, so as to be packed in one viewpoint worth of image.

### Processing of Transmission Device 11

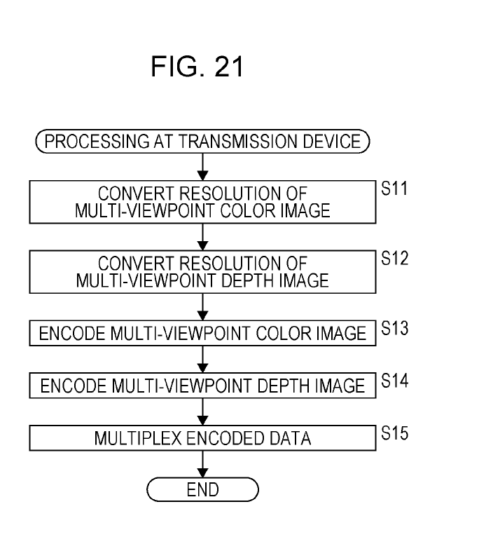

FIG. 21 is a flowchart for describing the processing of the transmission device 11 in FIG. 18.

In step S11, the resolution converting device 321C performs resolution conversion of a multi-viewpoint color image supplied thereto, and supplies the resolution-converted multi-viewpoint color image which is the middle viewpoint color image and packed color image obtained as a result thereof, to the encoding device 322C.

Further, the resolution converting device 321C generates resolution conversion information regarding the resolution-converted multi-viewpoint color image, supplies this to the encoding device 322C, and the flow advances from step S11 to step S12.

In step S12, the resolution converting device 321D performs resolution conversion of a multi-viewpoint depth image supplied thereto, and supplies the resolution-converted multi-viewpoint depth image which is the middle viewpoint depth image and packed depth image obtained as a result thereof, to the encoding device 322D.

Further, the resolution converting device 321D generates resolution conversion information regarding the resolution-converted multi-viewpoint depth image, supplies this to the encoding device 322D, and the flow advances from step S12 to step S13.

In step S13, the encoding device 322C uses the resolution conversion information from the resolution converting device 321C as necessary to encode the resolution-converted multi-viewpoint color image from the resolution converting device 321C with an extended format, supplies multi-viewpoint color image encoded data which is the encoded data obtained as a result thereof to the multiplexing device 23, and the flow advances to step S14.

In step S14, the encoding device 322D uses the resolution conversion information from the resolution converting device 321D as necessary to encode the resolution-converted multi-viewpoint depth image from the resolution converting device 321D with an extended format, supplies multi-viewpoint depth image encoded data which is the encoded data obtained as a result thereof to the multiplexing device 23, and the flow advances to step S15.

In step S15, the multiplexing device 23 multiplexes the multi-viewpoint color image encoded data from the encoding device 322C and the multi-viewpoint depth image encoded data from the encoding device 322D, and outputs a multiplexed bitstream obtained as the result thereof.

### Processing of Reception Device 12

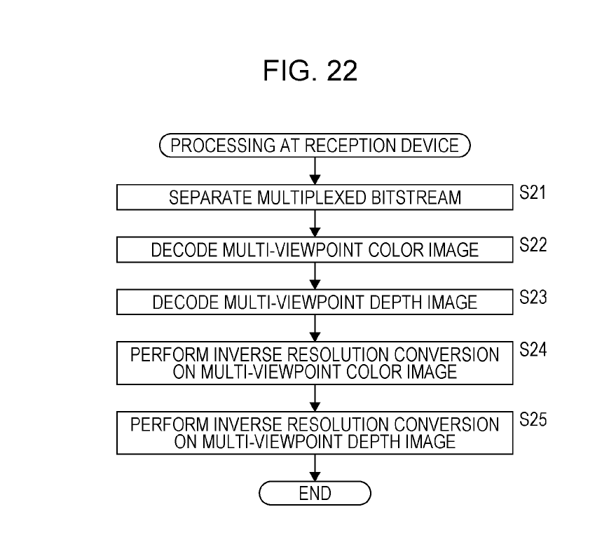

FIG. 22 is a flowchart for describing the processing of the reception device 12 in FIG. 19.

In step S21, the inverse multiplexing device 31 performs inverse multiplexing of the multiplexed bitstream supplied thereto, thereby separating the multiplexed bitstream into the multi-viewpoint color image encoded data and multi-viewpoint depth image encoded data.

The inverse multiplexing device 31 then supplies the multi-viewpoint color image encoded data to the decoding device 332C, supplies the multi-viewpoint depth image encoded data to the decoding device 332D, and the flow advances from step S21 to step S22.

In step S22, the decoding device 332C decodes the multi-viewpoint color image encoded data from the inverse multiplexing device 31 with an extended format, supplies the resolution-converted multi-viewpoint color image obtained as a result thereof, and resolution conversion information about the resolution-converted multi-viewpoint color image, to the resolution inverse converting device 333C, and the flow advances to step S23.

In step S23, the decoding device 332D decodes the multi-viewpoint depth image encoded data from the inverse multiplexing device 31 with an extended format, supplies the resolution-converted multi-viewpoint depth image obtained as a result thereof, and resolution conversion information about the resolution-converted multi-viewpoint depth image, to the resolution inverse converting device 333D, and the flow advances to step S24.

In step S24, the resolution inverse converting device 333C performs resolution inverse conversion to inverse-convert the resolution-converted multi-viewpoint color image from the decoding device 332C to the multi-viewpoint color image of the original resolution, based on the resolution conversion information also from the decoding device 332C, outputs the multi-viewpoint color image obtained as a result thereof, and the flow advances to step S25.

In step S25, the resolution inverse converting device 333D performs resolution inverse conversion to inverse-convert the resolution-converted multi-viewpoint depth image from the decoding device 332D to the multi-viewpoint depth image of the original resolution, based on the resolution conversion information also from the decoding device 332D, and outputs the multi-viewpoint depth image obtained as a result thereof.

### Configuration Example of Encoding Device 322C

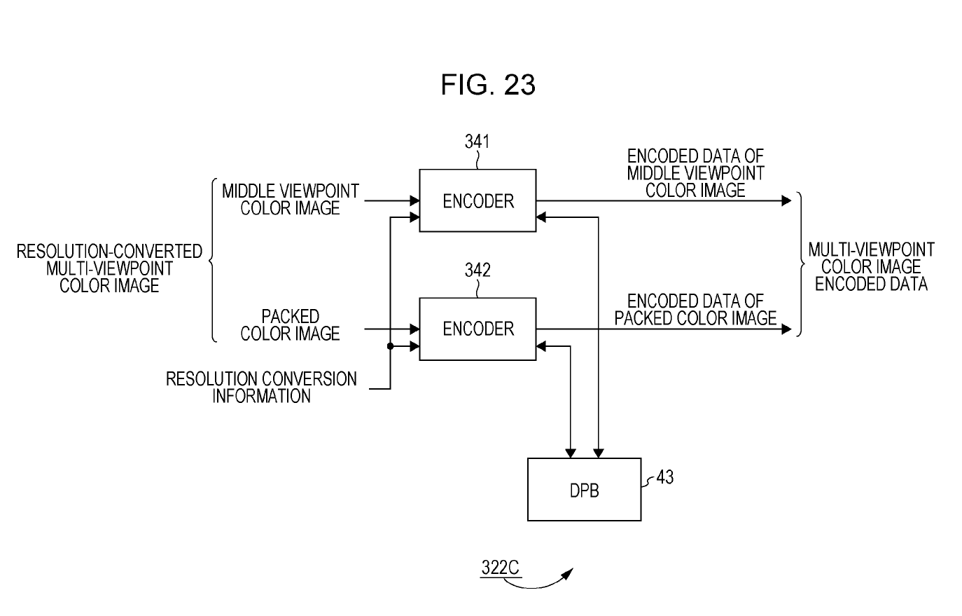

FIG. 23 is a block diagram illustrating a configuration example of the encoding device 322C in FIG. 18.

Note that portions corresponding to the case in FIG. 5 are denoted with the same symbols, and description hereinafter will be omitted as appropriate.

In FIG. 23, the encoding device 322C has encoders 341 and 342, and the DPB 43.

Accordingly, the encoding device 322C in FIG. 23 has in common with the encoding device 22C in FIG. 5 the point of having the DPB 43, and differs from the encoding device 22C in FIG. 5 in that the encoder 41 and encoder 42 has been replaced by the encoders 341 and 342.

The encoder 341 is supplied with, of the middle viewpoint color image and packed color image configuring the resolution-converted multi-viewpoint color image from the resolution converting device 321C, (the frame of) the middle viewpoint color image.

The encoder 342 is supplied with, of the middle viewpoint color image and packed color image configuring the resolution-converted multi-viewpoint color image from the resolution converting device 321C, (the frame of) the packed color image.

The encoders 341 and 342 are further supplied with resolution conversion information from the resolution converting device 321C.

The encoder 341 takes the middle viewpoint color image as the base view image and encodes by an extended format by extending MVC (AVC), and outputs encoded data of the middle viewpoint color image obtained as a result thereof, as with the encoder 41 in FIG. 5.

The encoder 342 takes the packed color image as a non base view image and encodes by an extended format, and outputs encoded data of the packed color image obtained as a result thereof, as with the encoder 42 in FIG. 5.

The encoders 341 and 342 perform encoding with an extended format as described above, with which of a field encoding mode to perform encoding with one field as one picture, and a frame encoding mode to perform encoding with one frame as one picture, will be employed as the encoding format, being set based on resolution conversion information from the resolution converting device 321C.

Now, AVC stipulates that with relation to slice headers existing within the same access unit, the field_pic_flag and bottom_field_flag must all be the same value, and accordingly, with MVC where AVC has been extended, the encoding mode needs to be the same between the base view image and non base view images.

With the extended format where MVC has been extended, the encoding mode does not need to be the same between the base view image and non base view images, but with the present embodiment, the encoding mode will be made to be the same between the base view image and non base view images, to achieve affinity with the original standard for the extended format (MVC here).

Accordingly, with the encoder 341 and encoder 342, when the encoding mode of one is set to the field encoding mode, the encoding mode of the other will be set to the field encoding mode, and when the encoding mode of one is set to the frame encoding mode, the encoding mode of the other will be set to the frame encoding mode.

The encoded data of the middle viewpoint color image output from the encoder 341 and the encoded data of the packed color image output from the encoder 342 are supplied to the multiplexing device 23 (FIG. 18) as multi-viewpoint color image encoded data.

Now, in FIG. 23, the DPB 43 is shared by the encoders 341 and 342.

That is to say, the encoders 341 and 342 perform prediction encoding of the image to be encoded in the same way as with MVC. Accordingly, in order to generate a prediction image to be used for prediction encoding, the encoders 341 and 342 encode the image to be encoded, and thereafter perform local decoding, thereby obtaining a decoded image.

The DPB 43 temporarily stores decoded images obtained from each of the encoders 341 and 342.

The encoders 341 and 342 each select reference images to reference when encoding images to encode, from decoded images stored in the DPB 43. The encoders 341 and 342 then each generate prediction images using reference images, and perform image encoding (prediction encoding) using these prediction images.

Accordingly, the encoders 341 and 342 can reference, in addition to decoded images obtained at itself, decoded images obtained at the other encoder.

Note however, the encoder 341 encodes the base view image, and accordingly only references a decoded image obtained at the encoder 341, as described above.

### Configuration Example of Encoder 342

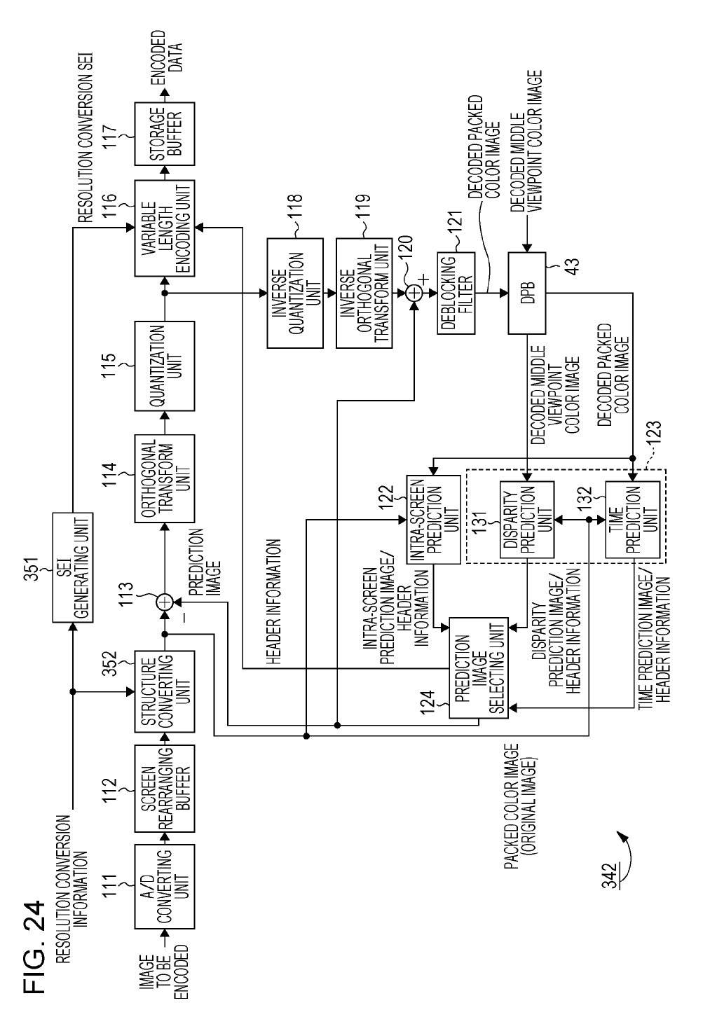

FIG. 24 is a block diagram illustrating a configuration example of the encoder 342 in FIG. 23.

Note that portions in the drawing corresponding to the case in FIG. 9 and FIG. 12 are denoted with the same symbols, and description hereinafter will be omitted as appropriate.

In FIG. 24, the encoder 342 has the A/D converting unit 111, screen rearranging buffer 112, computing unit 113, orthogonal transform unit 114, quantization unit 115, variable length encoding unit 116, storage buffer 117, inverse quantization unit 118, inverse orthogonal transform unit 119, computing unit 120, deblocking filter 121, intra-screen prediction unit 122, an inter prediction unit 123, a prediction image selecting unit 124, a SEI (Supplemental Enhancement Information) generating unit 351, and a structure converting unit 352.

Accordingly, the encoder 342 has in common with the encoder 42 in FIG. 9 the point of having the A/D converting unit 111 through the prediction image selecting unit 124.

Note however, the encoder 342 differs from the encoder 42 in FIG. 9 with regard to the point that the SEI generating unit 351 and the structure converting unit 352 have been newly provided.

The SEI generating unit 351 is supplied with the resolution conversion information regarding the resolution-converted multi-viewpoint color image from the resolution converting device 321C (FIG. 18).

The SEI generating unit 351 converts the format of the resolution conversion information supplied thereto into a SEI format according to MVC (AVC), and outputs the resolution conversion SEI obtained as a result thereof.

The resolution conversion SEI which the SEI generating unit 351 outputs is supplied to the variable length encoding unit 116.

At the variable length encoding unit 116, the resolution conversion SEI from the SEI generating unit 351 is transmitted included in the encoded data.

The structure converting unit 352 is provided on the output side of the screen rearranging buffer 112, and accordingly pictures are supplied from the screen rearranging buffer 112 to the structure converting unit 352.

Further, the structure converting unit 352 is supplied with resolution conversion information relating the resolution-converted multi-viewpoint color image from the resolution converting device 321C (FIG. 18).

Based on the resolution conversion information from the resolution converting device 321C, the structure converting unit 352 sets the encoding mode to the field encoding mode or frame encoding mode, and converts the structure (of the scanning format) of the picture form the screen rearranging buffer 112, based on that encoding mode.

That is to say, in the event that the picture from the screen rearranging buffer 112 is a frame (structure), the structure converting unit 352 outputs the frame serving as a picture from the screen rearranging buffer 112 as one picture as it is based on the encoding mode, or converts the frame serving as the picture from the screen rearranging buffer 112 into a top field and bottom field and outputs each field as one picture.

Also, in the event that the picture from the screen rearranging buffer 112 is a field (structure), the structure converting unit 352 outputs the field serving as a picture from the screen rearranging buffer 112 as one picture as it is based on the encoding mode, or converts a consecutive top field and bottom field of serving as the picture from the screen rearranging buffer 112 into a frame, and outputs the frame as one picture.

The picture output from the structure converting unit 352 also supplied to the computing unit 113, intra-screen prediction unit 122, and inter prediction unit 123.

Note that the encoder 341 in FIG. 23 is also configured in the same way as with the encoder 342 in FIG. 24. Note however, that the encoder 341 which encodes the base view image does not perform disparity prediction in the inter prediction which the inter prediction unit 123 performs, and only performs temporal prediction. Accordingly, the inter prediction unit 123 can be configured without providing a disparity prediction unit 131.

The encoder 341 which encodes the base view image performs the same processing as with the encoder 342 which encodes non base view images, except for not performing disparity prediction, so hereinafter description of the encoder 342 will be given, and description of the encoder 341 will be omitted as appropriate.

### Resolution Conversion SEI

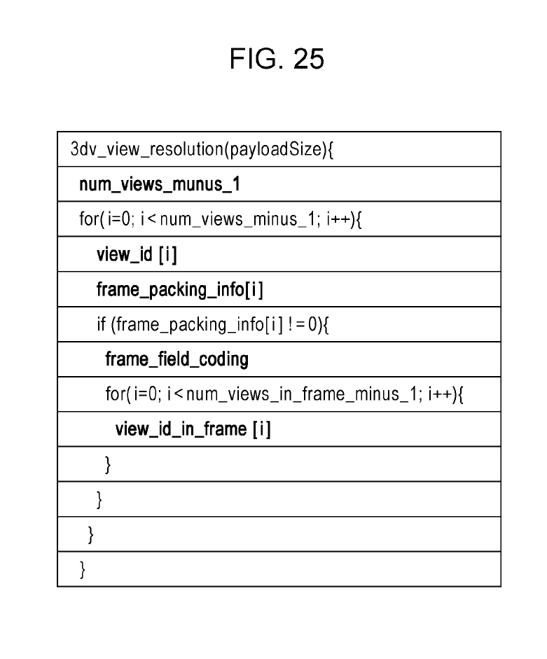

FIG. 25 is a diagram for describing the resolution conversion SEI generated at the SEI generating unit 351 in FIG. 24.

That is to say, FIG. 25 is a diagram illustrating an example of the syntax (syntax) of 3dv_view_resolution(payloadSize) serving as the resolution conversion SEI.

The 3dv_view_resolution(payloadSize) serving as the resolution conversion SEI has parameters num_views_minus_{—}1, view_id[i], frame_packing_info[i], frame_field_coding, and view_id_in_frame[i].

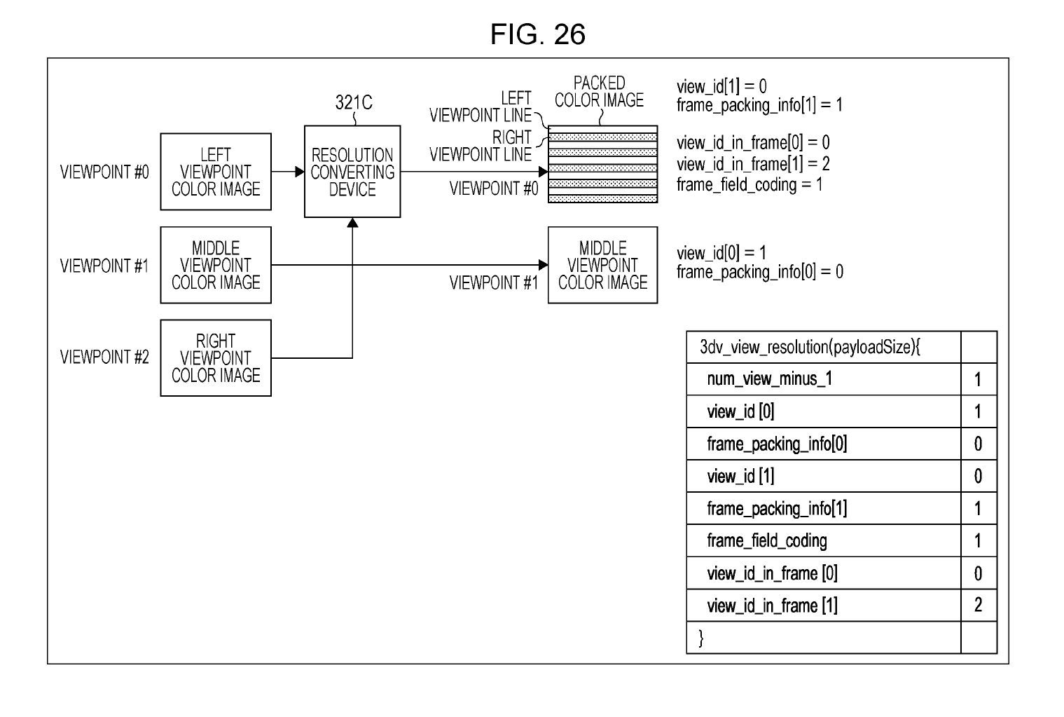

FIG. 26 is a diagram for describing values set to the resolution conversion SEI has parameters num_views_minus_{—}1, view_id[i], frame_packing_info[i], frame_field_coding, and view_id_in_frame[i], generated from the resolution conversion information regarding the resolution-converted multi-viewpoint color image, at the SEI generating unit 351 (FIG. 24).

The parameter num_views_minus_{—}1 represents a value obtained by subtracting 1 from the number of viewpoints making up the resolution-converted multi-viewpoint color image.

With the present embodiment, the resolution-converted multi-viewpoint color image is an image of two viewpoints, of the middle viewpoint color image, and a packed color image of the left viewpoint color image and right viewpoint color image packed into one viewpoint worth of image, so the parameter num_views_minus_{—}1=2−1=1 is set to num_views_minus_{—}1.

The parameter view_id[i] indicates an index identifying the i+1'th (i=0, 1, . . . ) image making up the resolution-converted multi-viewpoint color image.

That is, let us say that here, for example, the left viewpoint color image is an image of viewpoint #0 represented by No. 0 (left viewpoint), the middle viewpoint color image is an image of viewpoint #1 represented by No. 1 (middle viewpoint), and the right viewpoint color image is an image of viewpoint #2 represented by No. 2 (right viewpoint).

Also, let us say that at the resolution converting device 321C, the Nos. representing viewpoints are reassigned regarding the middle viewpoint color image and packed color image making up the resolution-converted multi-viewpoint color image obtained by performing resolution conversion on the middle viewpoint color image, left viewpoint color image, and right viewpoint color image, so that the middle viewpoint color image is assigned No. 1 representing viewpoint #1, and the packed color image is assigned No. 0 representing viewpoint #0, for example.

Further, let us say that the middle viewpoint color image is the 1st image configuring the resolution-converted multi-viewpoint color image (image of i=0), and that the packed color image is the 2nd image configuring the resolution-converted multi-viewpoint color image (image of i=1).

In this case, the parameter view_id[0] of the middle viewpoint color image which is the 1(=i+1=0+1)st image configuring the resolution-converted multi-viewpoint color image has the No. 1 representing viewpoint #1 of the middle viewpoint color image set (view_id[0]=1).

Also, the parameter view_id[1] of the packed color image which is the 2(=i+1=1+1)nd image configuring the resolution-converted multi-viewpoint color image has the No. 0 representing viewpoint #0 of the packed color image set (view_id[1]=0).

The parameter frame_packing_info[i] represents whether or not there is packing of the i+1'th image making up the resolution-converted multi-viewpoint color image, and the pattern of packing (packing pattern).

Now, the parameter frame_packing_info[i] of which the value is 0 indicates that there is no packing.

Also, the parameter frame_packing_info[i] of which the value is 1 indicates that there is packing.

The parameter frame_packing_info[i] of which the value is 1 indicates interlaced packing, where the vertical resolution of each of images of two viewpoints has been lowered to ½, and the lines of the left viewpoint color image and right viewpoint color image of which the resolution has been made to be ½ are alternately arrayed, thereby packing in an image of one viewpoint worth (of data amount).

With the present embodiment, the middle viewpoint color image which is the 1(=i+1=0+1)st image configuring the resolution-converted multi-viewpoint color image is not packed, so the value 0 is set to the parameter frame_packing_info[0] of the middle viewpoint color image, indicating that there is no packing (frame_packing_info[0]=0).

Also, with the present embodiment, the packed color image which is the 2(=i+1=1+1)nd image configuring the resolution-converted multi-viewpoint color image is packed by interlaced packing, so the value 1 is set to the parameter frame_packing_info[1] of the packed color image, indicating that there is interlaced packing (frame_packing_info[1]=1), i.e., a packing pattern where the lines of the left viewpoint color image and right viewpoint color image of which the resolution has been made to be ½ are alternately arrayed.

Now, in the resolution conversion SEI (3dv_view_resolution(payloadSize)) in FIG. 25, a variable num_views_in_frame_minus_{—}1 of the loop for(i=0;<num_views_in_frame_minus_{—}1;i++) indicates a value obtained by subtracting 1 from the number (of viewpoints) of images packed in the i+1'th image configuring the resolution-converted multi-viewpoint color image.

Accordingly, in the event that the parameter frame_packing_info[i] is 0, the i+1'th image configuring the resolution-converted multi-viewpoint color image is not packed (an image of one viewpoint is packed in the i+1'th image), so 0=1−1 is set to the variable num_views_in_frame_minus_{—}1.

Also, in the event that the parameter frame_packing_info[i] is 1, the i+1'th image configuring the resolution-converted multi-viewpoint color image has images of two viewpoints packed in the i+1'th image, so 1=2−1 is set to the variable num_views_in_frame_minus_{—}1.

The parameter frame_field_coding is transmitted in the event that an image of which the parameter frame_packing_info[i] is not 0 (frame_packing_info[i]!=0), i.e., the i+1'th image configuring the resolution-converted multi-viewpoint color image, has been packed, regarding that i+1'th image, and represents the encoding mode of the i+1'th image.

In the event that the encoding mode of the image (i+1'th image) where the parameter frame_packing_info[i] is 1 is frame encoding mode, the parameter frame_field_coding is set to 0, for example, representing frame encoding mode, and in the event that the encoding mode of an image where the parameter frame_packing_info[i] s 1 is the field encoding mode, the parameter frame_field_coding is set to 1, for example, representing the field encoding mode.

Here, with the present embodiment, an image of which the parameter frame_packing_info[i] is not 0 is an image where the parameter frame_packing_info[i] is 1, and is interlace packed.

On the other hand, the structure converting unit 352 recognizes whether or not a packed color image subjected to interlaced packing is included in the resolution-converted multi-viewpoint color image, based on the resolution conversion information.

In the event that a packed color image that has been subjected to interlaced packing is included in the resolution-converted multi-viewpoint color image, the structure converting unit 352 sets the encoding mode, for example, to the field encoding mode, and in the event that a packed color image that has been subjected to interlaced packing is not included in the resolution-converted multi-viewpoint color image, sets the encoding mode, for example, to the frame encoding mode, or the field encoding mode.

Accordingly, in the event that a packed color image that has been subjected to interlaced packing is included in the resolution-converted multi-viewpoint color image, the structure converting unit 352 always sets to the field encoding mode, so 1 which represents the field encoding mode is always set to a packed color image subjected to interlaced packing, i.e., to the parameter frame_field_coding transmitted only regarding an image where the parameter frame_packing_info[i] is 1.

Thus, with the present embodiment, 1 which represents the field encoding mode is always set to the parameter frame_field_coding transmitted only regarding an image where the parameter frame_packing_info[i] is 1. Accordingly, the parameter frame_field_coding can be uniquely recognized from the parameter frame_packing_info[i], and accordingly can be substituted by the parameter frame_packing_info[i], and thus does not have to be included in the 3dv_view_resolution(payloadSize) as the resolution conversion SEI.

Note that in the event that a packed floor image which has been subjected to interlaced packing is included in the resolution-converted multi-viewpoint color image, the frame encoding mode can be employed for the encoding mode to encode that packed color image, rather than the field encoding mode.

That is to say, the encoding mode to encode the packed color image can be switched between field encoding mode and frame encoding mode, in increments of pictures, for example. In this case, 1 which represents the field encoding mode or 0 which represents the frame encoding mode is set to he parameter frame_field_coding, in accordance with the encoding mode.

The parameter view_id_in_frame[i] represents an index identifying images packed in the packed color image.

Now, the argument i of the parameter view_id_in_frame[i] differs from the argument i of the other parameters view_id[i] and frame_packing_info[i], so we will notate the argument i of the parameter view_id_in_frame[i] as j to facilitate description, and thus notate the parameter view_id_in_frame[i] as view_id_in_frame[j].

The parameter view_id_in_frame[j] is transmitted only for images configuring the resolution-converted multi-viewpoint color image where the parameter frame_packing_info[i] is not 0, i.e., for packed color images, in the same way as with the parameter frame_field_coding.

In the event that the parameter frame_packing_info[i] of the packed color image is 1, i.e., in the event that the packed color image is an image subjected to interlaced packing where the lines of images of two viewpoints are alternately arrayed, the parameter view_id_in_frame[i] where the argument j=0 represents an index identifying, of the images subjected to interlaced packing in the packed color image, the image of lines situated as odd-numbered lines (top field lines), and the parameter view_id_in_frame[i] where the argument j=1 represents an index identifying, of the images subjected to interlaced packing in the packed color image, the image of lines situated as even-numbered lines (bottom field lines).

With the present embodiment, the packed color image is an image where interlaced packing has been performed in which (odd lines of) the left viewpoint color image are arrayed in the top field of the packed color image and (even lines of) the right viewpoint color image are arrayed in the bottom field of the packed color image, respectively, so the No. 0 representing viewpoint #0 of the left viewpoint color image is set to the parameter view_id_in_frame[0] of the argument j=0 representing the index identifying the image of the lines set to the top field, of the images subjected to interlaced packing in the packed color image, and the No. 2 representing viewpoint #2 of the right viewpoint color image is set to the parameter view_id_in_frame[1] of the argument j=1 representing the index identifying the image of the lines set to the bottom field.

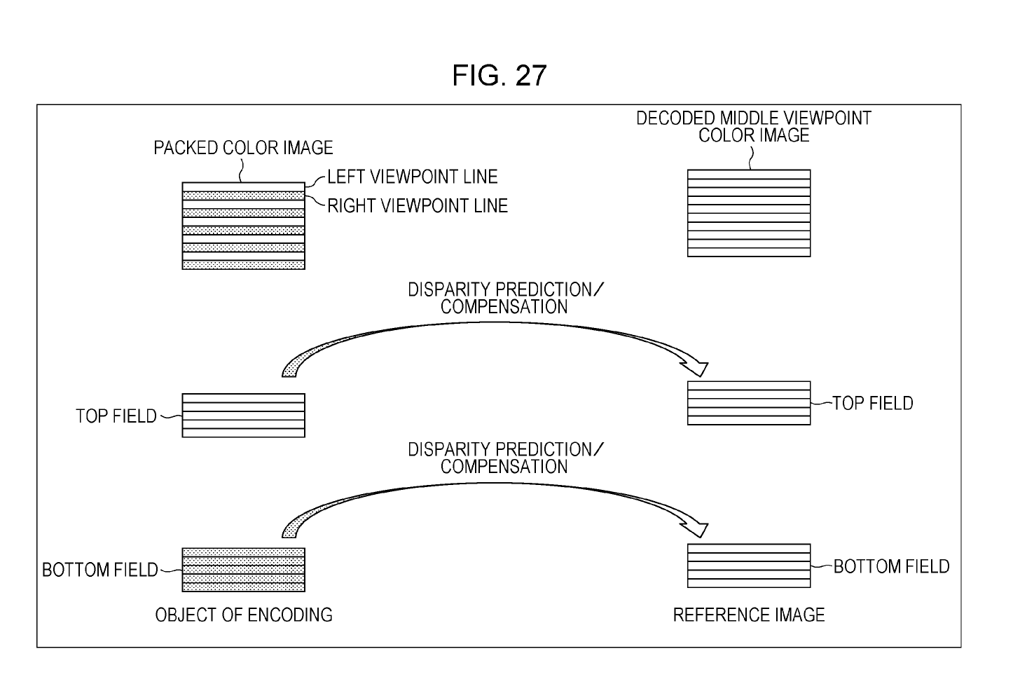

FIG. 27 is a diagram for describing disparity prediction of pictures (fields) of a packed color image performed at the disparity prediction unit 131 in FIG. 24.

As described in FIG. 26, at the encoder 342 (FIG. 24), in the event that a packed color image which has been subjected to interlaced packing is included in the resolution-converted multi-viewpoint color image, the structure converting unit 352 sets the encoding mode to the field encoding mode.

In the event of having set the encoding mode to the field encoding mode, the structure converting unit 352, upon being supplied with a frame as a picture of the packed color image from the screen rearranging buffer 112, then converts that frame into a top field and bottom field, and supplies each field as a picture to the computing unit 113, intra-screen prediction unit 122, and inter prediction unit 123.

In this case, the encoder 342 performs processing on fields (top field, bottom field) as pictures of the packed color image, in sequences as the current picture.

Accordingly, at the disparity prediction unit 131 of the inter prediction unit 123 (FIG. 24), disparity prediction (of the current block) of the filed serving as a picture of the packed color image is performed using a picture of a decoded middle viewpoint color image stored in the DPB 43 (picture of the same point-in-time as the current picture) as a reference image.

Now, with the present embodiment, as described with FIG. 23, in the event that the encoding mode of one of the encoder 341 and encoder 342 is set to the field encoding mode, the encoding mode of the other is set to the field encoding mode, as well.

Accordingly, in the event that the encoding mode is set to the field encoding mode at the encoder 342, the encoding mode is set to the field encoding mode at the encoder 341, as well. Then, in the same way as with the encoder 342, the frame of the middle viewpoint image which is the base view image is converted into fields (top field and bottom field), and the fields are encoded as pictures, at the encoder 341.

As a result, at the encoder 341, the fields serving as pictures of the decoded middle viewpoint color image are encoded and locally decoded, and fields serving as pictures of the decoded middle viewpoint color image obtained as a result are supplied to the DPB 43 and stored.

Then at the disparity prediction unit 131, disparity prediction (of a current block) of a field serving as the current picture of the packed color image from the structure converting unit 352 is performed, using the field serving as the picture of the decoded middle viewpoint color image stored in the DPB 43 as a reference image.

That is to say, with the encoder 342 (FIG. 24, the frame of the packed color image to be encoded is converted into a top field configured of odd lines of the frame of the left viewpoint color image (left viewpoint lines) and a bottom field configured of even lines of the frame of the right viewpoint color image (right viewpoint lines) and processed, at the structure converting unit 352.

On the other hand, with the encoder 341 in the same way as with the encoder 342, the frame of the middle viewpoint color image to be encoded is converted into a top field configured of odd lines of that frame and a bottom field configured of even lines and processed.

At the DPB 43, the fields (top field and bottom field) of the decoded middle viewpoint color image obtained by the processing at the encoder 341 are stored as pictures to serve as reference images for disparity prediction.

As a result, at the disparity prediction unit 131, disparity prediction of fields serving as current pictures of a packed color image is performed using fields of the decoded middle viewpoint color image stored in the DPB 43 as reference images.

That is to say, disparity prediction of the top field serving as the current picture of the packed color image is performed using the top field of the decoded middle viewpoint color image (at the same point-in-time as the current picture) stored in the DPB 43 as a reference image. Also, disparity prediction of the bottom field serving as the current picture of the packed color image is performed using the bottom field of the decoded middle viewpoint color image (at the same point-in-time as the current picture) stored in the DPB 43 as a reference image.

Accordingly, the resolution ratio of the field of the packed color image serving as the current picture, and the resolution ratio of the field of the decoded middle viewpoint color image serving as the picture of the reference image to be referenced at the time of generating a prediction image for the packed color image in the disparity prediction at the disparity prediction unit 131, agree (match).

That is to say, the vertical resolution of each of left viewpoint color image and right viewpoint color image making up the top field and bottom field of the packed color image to be encoded is ½ that of the original, and accordingly, the resolution ratio of the left viewpoint color image and right viewpoint color image forming the top field and bottom field of the packed color image is 2:1 for either.

On the other hand, the reference image is the fields (top field and bottom field) of the decoded middle viewpoint color image and the resolution ratio is 2:1, matching the resolution ratio of 2:1 of the left viewpoint color image and right viewpoint color image making up the top field and bottom field of the packed color image.

As described above, the resolution ratio of the fields (top field and bottom field) serving as the current picture of the packed color image and the resolution ratio of the fields of the middle viewpoint color image agree, so prediction precision of disparity prediction can be improved (the residual between the prediction image generated in disparity prediction and the current block becomes small), and encoding efficiency can be improved.

As a result, deterioration in image quality in the decoded image obtained at the reception device 12, due to resolution conversion where the base band data amount is reduced from the multi-viewpoint color image (and multi-viewpoint depth image) described above, can be prevented.

### Encoding Processing of Packed Color Image

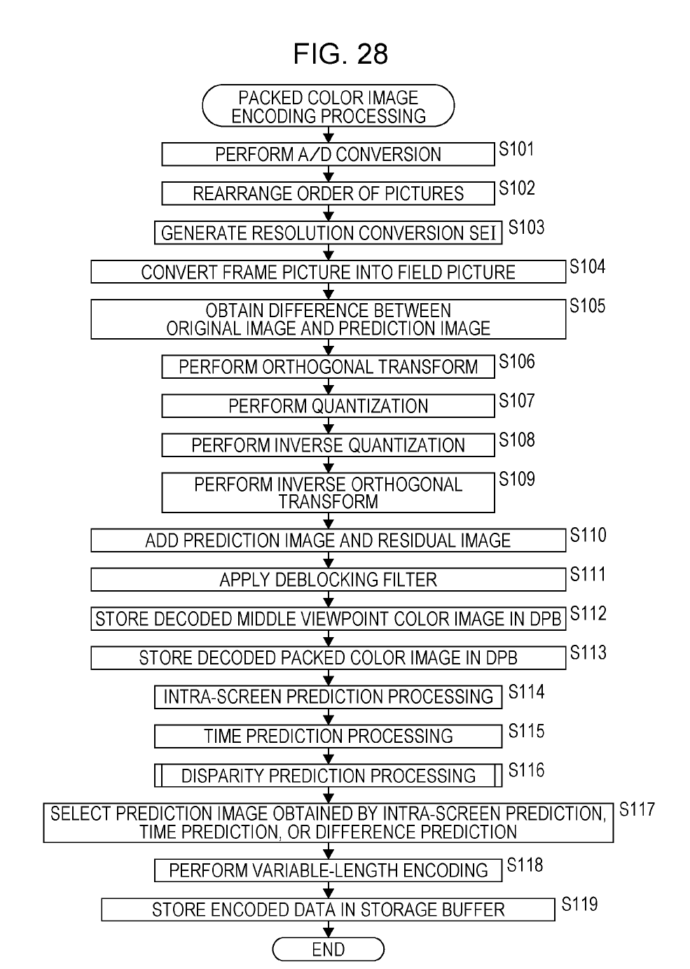

FIG. 28 is a flowchart for describing the encoding processing to encode the packed color image, which the encoder 342 in FIG. 24 performs.

In step S101, the A/D converting unit 111 performs A/D conversion of analog signals of frames serving as pictures of a packed color image supplied thereto, supplies to the screen rearranging buffer 112, and the flow advances to step S102.

In step S102, the screen rearranging buffer 112 temporarily stores the frame serving as the picture of the packed color image from the A/D converting unit 111, and performs rearranging where the order of pictures is rearranged from display order to encoding order (decoding order), by reading out the pictures in accordance with a predetermined GOP structure.

The frames serving as pictures read out from the screen rearranging buffer 112 are supplied to the structure converting unit 352, and the flow advances from step S102 to step S103.

In step S103, the SEI generating unit 351 generates the resolution conversion SEI described with FIG. 25 and FIG. 26 from the resolution conversion information supplied from the resolution converting device 321C (FIG. 18), supplies to the variable length encoding unit 116, and the flow advances to step S104.

In step S104, the structure converting unit 352 sets the encoding mode to field encoding mode based on the resolution conversion information supplied from the resolution converting device 321C (FIG. 18).

Further, in accordance with setting the encoding mode to the field encoding mode, the structure converting unit 352 converts the frame serving as the picture of the packed color image from the screen rearranging buffer 112 into the two fields of a top field and bottom field, supplies to the computing unit 113, intra-screen prediction unit 122, and disparity prediction unit 131 and temporal prediction unit 132 of the inter prediction unit 123, and the flow advances from step S104 to step S105.

In step S105, the computing unit 113 takes a field serving as a picture of a packed color image from the structure converting unit 352 to be a current picture to be encoded, and further, sequentially takes macroblocks configuring the current picture as current blocks to be encoded.

The computing unit 113 then computes the difference (residual) between the pixel values of the current block and pixel values of a prediction image supplied from the prediction image selecting unit 124 as necessary, supplies to the orthogonal transform unit 114, and the flow advances from step S105 to step S106.

In step S106, the orthogonal transform unit 114 subjects the current block from the computing unit 113 to orthogonal transform, supplies transform coefficients obtained as a result thereof to the quantization unit 115, and the flow advances to step S107.

In step S107, the quantization unit 115 performs quantization of the transform coefficients supplied from the orthogonal transform unit 114, supplies the quantization values obtained as a result thereof to the inverse quantization unit 118 and variable length encoding unit 116, and the flow advances to step S108.

In step S108, the inverse quantization unit 118 performs inverse quantization of the quantization values from the quantization unit 115 into transform coefficients, supplies to the inverse orthogonal transform unit 119, and the flow advances to step S109.

In step S109, the inverse orthogonal transform unit 119 performs inverse orthogonal transform of the transform coefficients from the inverse quantization unit 118, supplies to the computing unit 120, and the flow advances to step S110.

In step S110, the computing unit 120 adds the pixels values of the prediction image supplied from the prediction image selecting unit 124 to the data supplied from the inverse orthogonal transform unit 119 as necessary, thereby obtaining a decoded packed color image where the current block has been decoded (locally decoded). The computing unit 120 then supplies the decoded packed color image where the current block has been locally decoded to the deblocking filter 121, and the flow advances from step S110 to step S111.

In step S111, the deblocking filter 121 performs filtering of the decoded packed color image from the computing unit 120, supplies to the DPB 43, and the flow advances to step S112.

In step S112, the DPB 43 awaits supply of a decoded middle viewpoint color image obtained by encoding and locally decoding the middle viewpoint color image, from the encoder 341 (FIG. 23) which encodes the middle viewpoint color image, stores the decoded middle viewpoint color image, and the flow advances to step S113.

As described above, the encoder 341 performs the same encoding processing as with the encoder 342 except for not performing disparity prediction, i.e., encoding in the field encoding mode where a field of a middle viewpoint color image is taken as a picture. Accordingly, fields of the decoded middle viewpoint color image are stored in the DPB 43.

In step S113, the DPB 43 stores the field of the decoded packed color image from the deblocking filter 121, and the flow advances to step S114.

In step S114 the intra-screen prediction unit 122 performs intra prediction processing (intra-screen prediction processing) for the next current block.

That is to say, the intra-screen prediction unit 122 performs intra prediction processing (intra-screen prediction processing) to generate a prediction image (intra-predicted prediction image) from a field of the picture of the decoded packed color image stored in the DPB 43, for the next current block.

The intra-screen prediction unit 122 then uses the intra-predicted prediction image to obtain the encoding costs needed to encode the next current block, supplies this to the prediction image selecting unit 124 along with (information relating to intra-prediction serving as) header information and the intra-predicted prediction image, and the flow advances from step S114 to step S115.

In step S115, the temporal prediction unit 132 performs temporal prediction processing regarding the next current block, with the field serving as a picture of the decoded packed color image as a reference image.

That is to say, the temporal prediction unit 132 uses the field serving as a picture of the decoded packed color image stored in the DPB 43 to perform temporal prediction regarding the next current block, thereby obtaining prediction image, encoding cost, and so forth, for each inter prediction mode with different macroblock type and so forth.

Further, the temporal prediction unit 132 takes the inter prediction mode of which the encoding cost is the smallest as being the optimal inter prediction mode, supplies the prediction image of that optimal prediction mode to the prediction image selecting unit 124 along with (information relating to intra-prediction serving as) header information and the encoding cost, and the flow advances from step S115 to step S116.

In step S116, the disparity prediction unit 131 performs disparity prediction information of the next current block, with the field serving as a picture of the decoded middle viewpoint color image as a reference image.

That is to say, the disparity prediction unit 131 performs disparity prediction for the next current block, using the field serving as a picture of the decoded middle viewpoint color image stored in the DPB 43, thereby obtaining prediction image, encoding cost, and so forth, for each inter prediction mode of which the macro block type and so forth is different.

Further, the disparity prediction unit 131 takes the inter prediction mode of which the encoding cost is the smallest as the optimal inter prediction mode, supplies the prediction image of that optimal inter prediction mode to the prediction image selecting unit 124 along with (information relating to inter prediction serving as) header information and the encoding cost, and the flow advances from step S116 to step S117.

In step S117, the prediction image selecting unit 124 selects, from the prediction image from the intra-screen prediction unit 122 (intra-predicted prediction image), prediction image from the temporal prediction unit 132 (temporal prediction image), and prediction image from the disparity prediction unit 131 (disparity prediction image), the prediction image of which the encoding cost is the smallest for example, supplies this to the computing units 113 and 220, and the flow advances to step S118.

Now, the prediction image which the prediction image selecting unit 124 selects in step S117 is used in the processing of steps S105 and S110 performed for encoding of the next current block.

Also, the prediction image selecting unit 124 selects, of the header information supplied from the intra-screen prediction unit 122, temporal prediction unit 132, and disparity prediction unit 131, the header information supplied along with the prediction image of which the encoding cost is the smallest, and supplies to the variable length encoding unit 116.

In step S118, the variable length encoding unit 116 subjects the quantization values from the quantization unit 115 to variable-length encoding, and obtains encoded data.

Further, the variable length encoding unit 116 includes the header information from the prediction image selecting unit 124 and the resolution conversion SEI from the SEI generating unit 351, in the header of the encoded data.

The variable length encoding unit 116 then supplies the encoded data to the storage buffer 117, and the flow advances from step S118 to step S119.

In step S119, the storage buffer 117 temporarily stores the encoded data from the variable length encoding unit 116.

The encoded data stored at the storage buffer 117 is supplied (transmitted) to the multiplexing device 23 (FIG. 18) at a predetermined transmission rate.

The processing of steps S101 through S119 above is repeatedly performed as appropriate at the encoder 342.

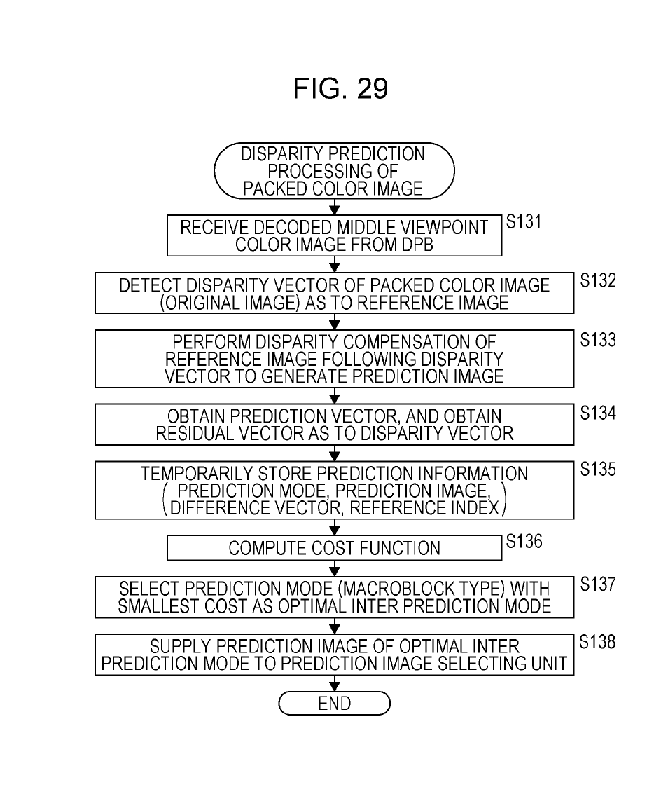

FIG. 29 is a flowchart for describing disparity prediction processing which the disparity prediction unit 131 (FIG. 13) performs in step S116 in FIG. 28.

In step S131, at the disparity prediction unit 131 (FIG. 13), the disparity detecting unit 141 and disparity compensation unit 142 receive the field serving as the picture of the decoded middle viewpoint color image from the DPB 43 as a reference image, and the flow advances to step S132.

In step S132, the disparity detecting unit 141 performs ME using the current block of the packed color image supplied from the structure converting unit 352 (FIG. 24) and the field of the decoded middle viewpoint color image serving as a reference image from the DPB 43, thereby detecting the disparity vector my representing the shift at the current block as to the converted reference image, for each macroblock type, which is supplied to the disparity compensation unit 142, and the flow advances to step S133.

In step S133, the disparity compensation unit 142 performs disparity compensation of the field of the decoded middle viewpoint color image serving as a reference image from the DPB 43 using the disparity vector my of the current block from the disparity detecting unit 141, thereby generating a prediction image of the current block, for each macroblock type, and the flow advances to step S134.

That is to say, the disparity compensation unit 142 obtains a corresponding block which is a block (region) in the field of the decoded middle viewpoint color image serving as a reference image, shifted by an amount equivalent to the disparity vector my from the position of the current block, as a prediction image.

In step S134, the disparity compensation unit 142 uses disparity vectors and so forth of macroblocks at the periphery of the current block, that have already been encoded, as necessary, thereby obtaining a prediction vector PMV of the disparity vector my of the current block.

Further, the disparity compensation unit 142 obtains a residual vector which is the difference between the disparity vector my of the current block and the prediction vector PMV.

The disparity compensation unit 142 then correlates the prediction image of the current block for each prediction mode, such as macroblock type, with the prediction mode, along with the residual vector of the current block and the reference index assigned to the reference image (field of the decoded middle viewpoint color image) used for generating the prediction image, and supplies to the prediction information buffer 143 and the cost function calculating unit 144, and the flow advances from step S134 to step S135.

In step S135, the prediction information buffer 143 temporarily stores the prediction image correlated with the prediction mode, residual vector, and reference index, from the disparity compensation unit 142, as prediction information, and the flow advances to step S136.

In step S136, the cost function calculating unit 144 obtains the encoding cost (cost function value) needed to encode the current block of the current picture from the structure converting unit 352 (FIG. 24) by calculating a cost function, for each macroblock type serving as a prediction mode, supplies this to the mode selecting unit 145, and the flow advances to step S137.

In step S137, the mode selecting unit 145 detects the smallest cost which is the smallest value, from the encoding costs for each prediction mode from the cost function calculating unit 144.

Further, the mode selecting unit 145 selects the prediction mode of which the smallest cost has been obtained, as the optimal inter prediction mode.

The flow then advances from step S137 to step S138, where the mode selecting unit 145 reads out the prediction image correlated with the prediction mode which is the optimal inter prediction mode, residual vector, and reference index, from the prediction information buffer 143, supplies to the prediction image selecting unit 124 as prediction information, and the processing returns.

### Configuration Example of Decoding Device 332C

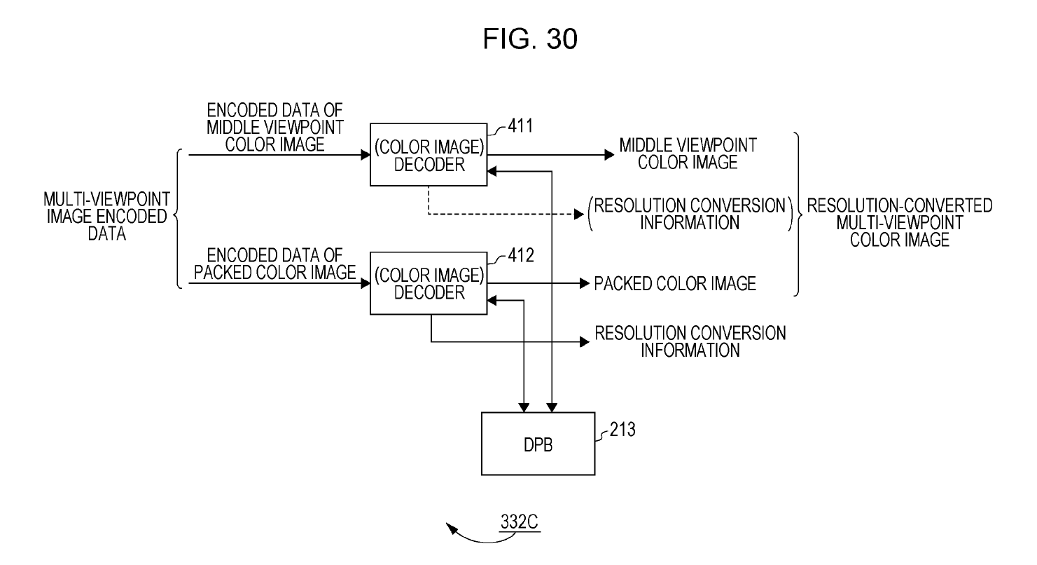

FIG. 30 is a block diagram illustrating a configuration example of the decoding device 332C in FIG. 19.

Note that portions in the drawing corresponding to the case in FIG. 14 are denoted with the same symbols, and description thereof will be omitted as appropriate hereinafter.

In FIG. 30, the decoding device 332C has decoders 411 and 412, and a DPB 213.

Accordingly, the decoding device 332C in FIG. 30 has in common with the decoding device 32C in FIG. 14 the point of sharing the DPB 213, but differs from the decoding device 32C in FIG. 14 in that the decoders 411 and 412 have been provided instead of the decoders 211 and 212.

The decoder 411 is supplied with, of the multi-viewpoint color image encoded data from the inverse multiplexing device 31 (FIG. 19), encoded data of the multi-viewpoint color image which is a base view image.

The decoder 411 decodes the encoded data of the middle viewpoint color image supplied thereto with an extended format, and outputs a middle viewpoint color image obtained as the result thereof.

The decoder 412 is supplied with, of the multi-viewpoint color image encoded data from the inverse multiplexing device 31 (FIG. 19), encoded data of the packed color image which is a non base view image.

The decoder 412 decodes the encoded data of the packed color image supplied thereto with an extended format, and outputs a packed color image obtained as the result thereof.

The middle viewpoint color image which the decoder 411 outputs and the packed color image which the decoder 412 outputs are then supplied to the resolution inverse converting device 333C (FIG. 19) as a resolution-converted multi-viewpoint color image.

Also, the decoders 411 and 412 each decode an image regarding which prediction encoding has been performed at the encoders 341 and 342 in FIG. 23.

In order to decode an image subjected to prediction encoding, the prediction image used for the prediction encoding is necessary, so the decoders 411 and 412 decode the images to be decoded, and thereafter temporarily store the decoded images to be used for generating of a prediction image, in the DPB 213, to generate the prediction image used in the prediction encoding.

The DPB 213 is shared by the decoders 411 and 412, and temporarily stores images after decoding (decoded images) obtained at each of the decoders 411 and 412.

Each of the decoders 411 and 412 select a reference image to reference to decode the image to be decoded, from the decoded images stored in the DPB 213, and generate prediction images using the reference images.

The DPB 213 is thus shared between the decoders 411 and 412, so the decoders 411 and 412 can each reference, besides decoded images obtained from itself, decoded images obtained at the other decoder as well.

Note however, the decoder 411 decodes base view images, so only references decoded images obtained at the decoder 411 (disparity prediction is not performed).

### Configuration Example of Decoder 412

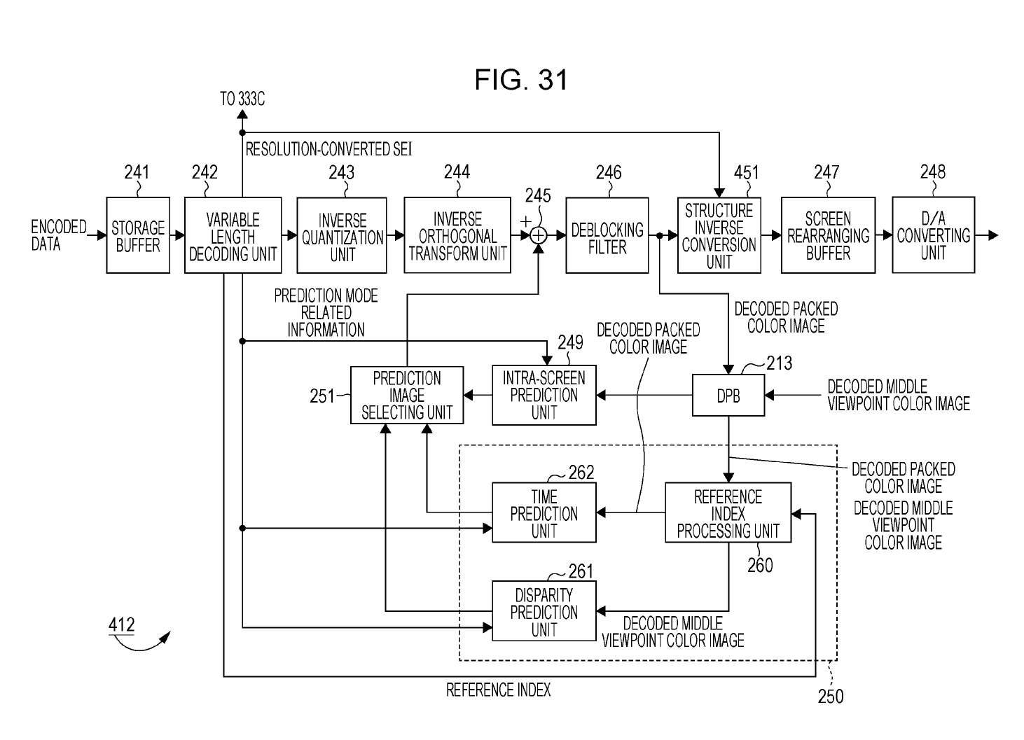

FIG. 31 is a block diagram illustrating a configuration example of the decoder 412 in FIG. 30.

Note that portions in the drawing corresponding to the case in FIG. 15 and FIG. 16 are denoted with the same symbols, and description thereof will be omitted as appropriate hereinafter.

In FIG. 31, the decoder 412 has a storage buffer 241, a variable length decoding unit 242, an inverse quantization unit 243, an inverse orthogonal transform unit 244, a computing unit 245, a deblocking filter 246, a screen rearranging buffer 247, a D/A conversion unit 248, an intra-screen prediction unit 249, an inter prediction unit 250, a prediction image selecting unit 251, and a structure inverse conversion unit 451.

Accordingly, the decoder 412 in FIG. 31 has in common with the decoder 212 in FIG. 15 the point of having the storage buffer 241 through the prediction image selecting unit 251.

However, the decoder 412 in FIG. 31 differs from the decoder 212 in FIG. 15 in the point that the structure inverse conversion unit 451 has been newly provided.

With the decoder 412 in FIG. 31, the variable length decoding unit 242 receives encoded data of the packed color image including the resolution conversion SEI from the storage buffer 241, and supplies the resolution conversion SEI included in that encoded data to the resolution inverse converting device 333C (FIG. 19) as resolution conversion information.

Also, the variable length decoding unit 242 supplies the resolution conversion SEI to the structure inverse conversion unit 451.

The structure inverse conversion unit 451 is provided to the output side of the deblocking filter 246, and accordingly the structure inverse conversion unit 451 is supplied with resolution conversion SEI from the variable length decoding unit 242, and also supplied with decoded images after filtering (decoded packed color images) from the deblocking filter 246.

The structure inverse conversion unit 451 performs inverse conversion which is the inverse of that performed at the structure converting unit 352 in FIG. 24, on the decoded packed color image from the deblocking filter 246, based on the resolution conversion SEI from the deblocking filter 246.

With the present embodiment, the structure converting unit 352 in FIG. 24 has converted the frames of the packed color image into fields of the packed color image (top field and bottom field), and accordingly fields are supplied as pictures of the decoded packed color image from the deblocking filter 246 to the structure inverse conversion unit 451.

Upon being supplied with the top field and bottom field configuring the frame of the decoded packed color image from the deblocking filter 246, the structure inverse conversion unit 451 alternately arrays the lines of the top field and bottom field, thereby (re)constructing the frame, which is supplied to the screen rearranging buffer 247.

Note that the decoder 411 in FIG. 30 is also configured in the same way as with the decoder 412 in FIG. 31. Note however, that with the decoder 411 for decoding the base view image, disparity prediction is not performed in inter prediction, and just temporal prediction is performed. Accordingly, the decoder 411 can be configured without providing a disparity prediction unit 261 to perform disparity prediction.

The decoder 411 which decodes the base view image performs processing the same as with the decoder 412 which decodes the no base view images, except for not performing disparity prediction, so hereinafter the decoder 412 will be described, and description of the decoder 411 will be omitted as appropriate.

### Decoding Processing of Packed Color Image

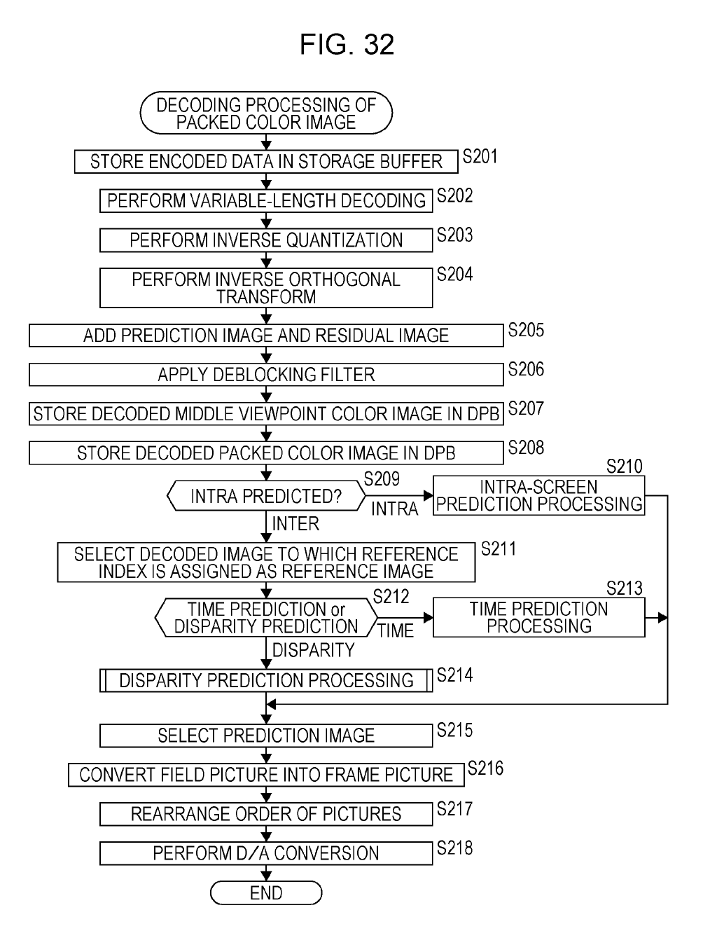

FIG. 32 is a flowchart for describing decoding processing to decode the encoded data of the packed color image, which the decoder 412 in FIG. 31 performs.

In step S201, the storage buffer 241 stores encoded data of the packed color image supplied thereto, and the flow advances to step S202.

In step S202, the variable length decoding unit 242 reads out and performs variable-length decoding on the encoded data stored in the storage buffer 241, thereby restoring the quantization value, prediction mode related information, and resolution conversion SEI. The variable length decoding unit 242 then supplies the quantization values to the inverse quantization unit 243, the prediction mode related information to the intra-screen prediction unit 249, and reference index processing unit 260, disparity prediction unit 261, and time prediction unit 262, of the inter prediction unit 250, and the resolution conversion SEI to the structure inverse conversion unit 451 and resolution inverse converting device 333C (FIG. 19), respectively, and the flow advances to step S203.

In step S203, The inverse quantization unit 243 performs inverse quantization of the quantization value from the variable length decoding unit 242 into transform coefficients, supplies to the inverse orthogonal transform unit 244, and the flow advances to step S204.

In step S204, the inverse orthogonal transform unit 244 performs inverse orthogonal transform of the transform coefficients from the inverse quantization unit 243, supplies to the computing unit 245 in increments of macroblocks, and the flow advances to step S205.

In step S205, the computing unit 245 takes the macroblock from the inverse orthogonal transform unit 244 as a current block (residual image) to be decoded, and adds the prediction image supplied from the prediction image selecting unit 251 to the current block as necessary, thereby obtaining a decoded image. The computing unit 245 then supplies the decoded image to the deblocking filter 246, and the flow advances from step S205 to step S206.

In step S206, the deblocking filter 246 performs filtering on the decoded image from the computing unit 245, supplies the decoded image after filtering (decoded packed color image) to the DPB 213 and the structure inverse conversion unit 451, and the flow advances to step S207.

In step S207, the DPB 213 awaits for the decoded middle viewpoint color image to be supplied from the decoder 411 (FIG. 30) which decodes the middle viewpoint color image, stores the decoded middle viewpoint color image, and the flow advances to step S208.

In step S208, the DPB 213 stores the decoded packed color image from the deblocking filter 246, and the flow advances to step S209.

Now, with the encoder 211 in FIG. 23, the middle viewpoint color image has the fields thereof encoded as the current picture, and with the encoder 212, the packed color image has the fields thereof encoded as the current picture.

Accordingly, at the decoder 411 which decodes the encoded data of the middle viewpoint color image, the middle viewpoint color image has the fields thereof decoded as the current picture. In the same way, at the decoder 412 which decodes the encoded data of the packed color image, the packed color image has the fields thereof decoded as the current picture.

Accordingly, the DPB 213 has stored therein the decoded middle viewpoint color image and decoded packed color image in fields (structure).

In step S209, the intra-screen prediction unit 249 and (the temporal prediction unit 261 and disparity prediction unit 262 making up) the inter prediction unit 250 determine which of intra prediction (intra-screen prediction) and inter prediction the prediction image has been generated with, that has been used to encode the next current block (the macroblock to be decoded next), based on the prediction mode related information supplied from the variable length decoding unit 242.

In the event that determination is then made in step S209 that the next current block has been encoded using a prediction image generated with intra-screen prediction, the flow advances to step S210, and the intra-screen prediction unit 249 performs intra prediction processing (intra screen prediction processing).

That is to say, with regard to the next current block, the intra-screen prediction unit 249 performs intra prediction (intra-screen prediction) to generated a prediction image (intra-predicted prediction image) from the decoded packed color image stored in the DPB 213, supplies that prediction image to the prediction image selecting unit 251, and the flow advances from step S210 to step S215.

Also, in the event that determination is made in step S209 that the next current block has been encoded using a prediction image generated in inter prediction, the flow advances to step S211, where the reference index processing unit 260 reads out the field serving as the picture of the decoded middle viewpoint color image to which (a reference index matching) a reference index for prediction included in the prediction mode related information from the variable length decoding unit 242 has been assigned, or the picture of the decoded packed color image, from the DPB 213, so as to be selected as a reference image, and the flow advances to step S212.

In step S212, the reference index processing unit 260 determines which of temporal prediction which format of intra prediction and disparity prediction the prediction image has been generated with, that has been used to encode the next current block, based on the reference index for prediction included in the prediction mode related information supplied from the variable length decoding unit 242.

In the event that determination is made in step S212 that the next current block has been determined to have been encoded using a prediction image generated by temporal prediction, i.e., in the event that the picture to which the reference index for prediction, for the (next) current block from the variable length decoding unit 242, has been assigned, is the picture of the decoded packed color image, and this picture of the decoded packed color image has been selected in step S211 as a reference image, the reference index processing unit 260 supplies the picture of the decoded packed color image to the temporal prediction unit 262 as a reference image, and the flow advances to step S213.

In step S213, the temporal prediction unit 262 performs temporal prediction processing.

That is to say, with regard to the next current block, the temporal prediction unit 262 performs motion compensation of the picture of the decoded packed color image serving as the reference image from the reference index processing unit 260, using the prediction mode related information from the variable length decoding unit 242, thereby generating a prediction image, supplies the prediction image to the prediction image selecting unit 251, and the processing advances from step S213 to step S215.

Also, in the event that determination is made in step S212 that the next current block has been encoded using a prediction image generated by disparity prediction, i.e., in the event that the picture to which the reference index for prediction, for the (next) current block from the variable length decoding unit 242, has been assigned, is a field serving as the picture of the decoded middle viewpoint color image, and the field serving as this picture of the decoded middle viewpoint color image has been selected as a reference image in step S211, the reference index processing unit 260 supplies the field serving as the picture of the decoded middle viewpoint color image to the disparity prediction unit 261 as a reference image, and the flow advances to step S214.

In step S214, the disparity prediction unit 261 performs disparity prediction processing.

That is to say, the disparity prediction unit 261 generates a prediction image by performing disparity compensation for the field serving as the picture of the decoded middle viewpoint color image serving as a reference image, for the next current block, using the prediction mode related information from the variable length decoding unit 242, supplies the prediction information thereof to the prediction image selecting unit 251, and the flow advances from step S214 to step S215.

In step S215, the prediction image selecting unit 251 selects a prediction image from the one of the intra-screen prediction unit 249, temporal prediction unit 262, and the disparity prediction unit 261, which was supplied a prediction image, supplies to the computing unit 245, and the flow advances to step S216.

Now, the prediction image which the prediction image selecting unit 251 selects in step S215 is used in the processing of step S205 performed for decoding of the next current block.

In step S216, in the event of having been supplied with a decoded packed color image of a top field and bottom field configuring a frame, from the deblocking filter 246, based on the resolution conversion SEI from the variable length decoding unit 242, the structure inverse conversion unit 451 performs inverse conversion of the top field and bottom field into frames, supplies to the screen rearranging buffer 247, and the flow advances to step S217.

In step S217, the screen rearranging buffer 247 temporarily stores and reads out frames serving as pictures of the decoded packed color image from the structure inverse conversion unit 451, whereby the order of pictures is rearranged to the original order, supplied to the D/A conversion unit 248, and the flow advances to step S218.

In step S218, in the event that it is necessary to output the pictures from the screen rearranging buffer 247 as analog signals, the D/A conversion unit 248 performs D/A conversion of the pictures and outputs.

At the decoder 412, the processing of the above steps S201 through S218 is repeatedly performed.

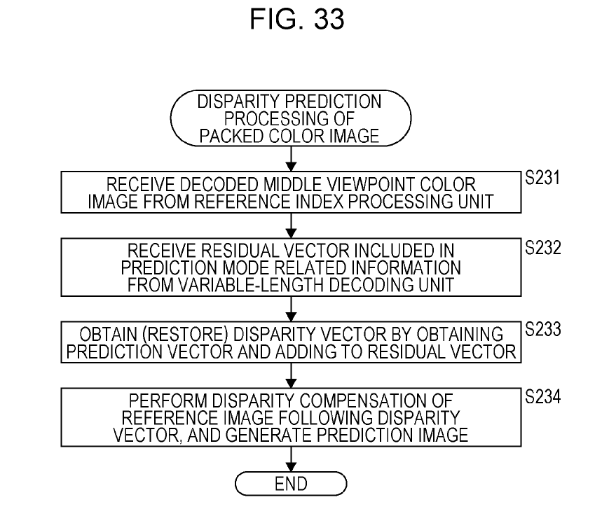

FIG. 33 is a flowchart for describing the disparity prediction processing which the disparity prediction unit 261 (FIG. 17) performs in step S214 in FIG. 32.

In step S231, at the disparity prediction unit 261 (FIG. 17), the disparity compensation unit 272 receives the fields serving as the picture of the decoded middle viewpoint color image serving as a reference image from the reference index processing unit 260, and the flow advances to step S232.

In step S232, the disparity compensation unit 272 receives the residual vector of the (next) current block included in the prediction mode related information from the variable length decoding unit 242, and the flow advances to step S233.

In step S233, the disparity compensation unit 272 uses the disparity vectors of already-decoded macroblocks in the periphery of the current block, and so forth, to obtain a prediction vector of the current block regarding the macroblock type which the prediction mode (optimal inter prediction mode) included in the prediction mode related information from the variable length decoding unit 242 indicates.

Further, the disparity compensation unit 272 adds the prediction vector of the current block and the residual vector from the variable length decoding unit 242, thereby restoring the disparity vector my of the current block, and the flow advances from step S233 to step S234.

In step S234, the disparity compensation unit 272 generates a prediction image of the current block by performing disparity compensation of the field serving as the picture of the decoded middle viewpoint color image serving as the reference image from the reference index processing unit 260, using the disparity vector my of the current block of the packed color image, supplies to the prediction image selecting unit 251, and the flow returns.

### Other Configuration Example of Encoding Device 322C

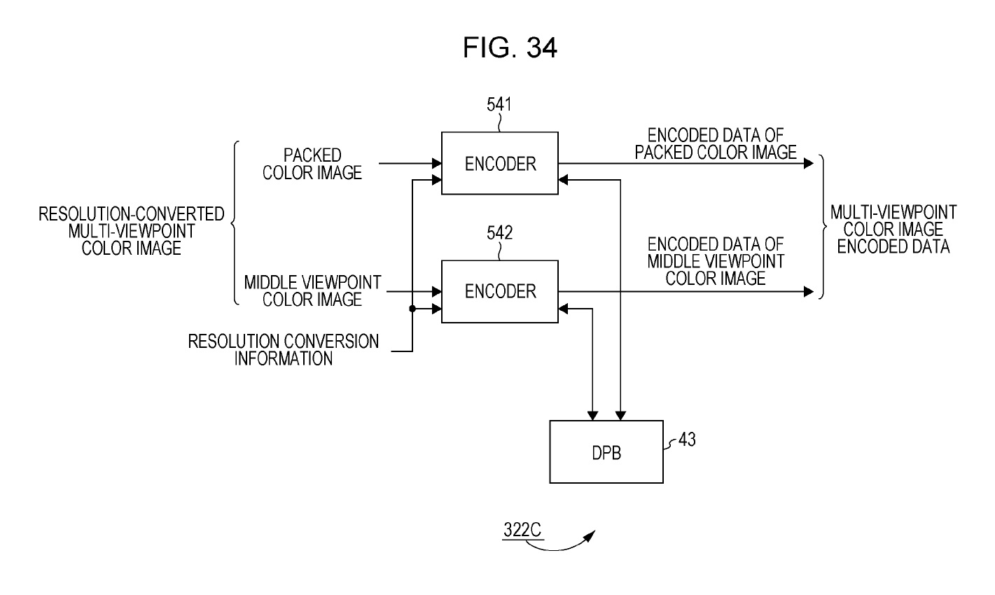

FIG. 34 is a block diagram illustrating another configuration example of the encoding device 322C in FIG. 18.

Note that portions corresponding to the case in FIG. 23 are denoted with the same symbols, and description hereinafter will be omitted as appropriate.

In FIG. 34, the encoding device 322C has encoders 541 and 542 and the DPB 43.

Accordingly, the encoding device 322C in FIG. 34 has in common with the case in FIG. 23 the point of having the DPB 43, and differs from the encoding device 322C in FIG. 23 in that the encoders 341 and 342 have been replaced by the encoders 541 and 542.

Now, in the event that the resolution ratio of the packed color image and the resolution ratio of the middle viewpoint color image do not match, in addition to cases where disparity prediction is performed on the packed color image as the object of encoding using the middle viewpoint color image as a reference image, in cases where disparity prediction is performed on the middle viewpoint color image as the object of encoding using the packed color image as a reference image as well, the prediction precision of the disparity prediction drops (the residual between the prediction image generated in disparity prediction and the current block becomes great), and encoding efficiency becomes poorer.

While FIG. 23 illustrates a middle viewpoint color image being encoded as a base view image and a packed color image being encoded as a non base view image, FIG. 34 illustrates a packed color image being encoded as a base view image at the encoder 541 which encodes base view images, and a middle viewpoint color image being encoded as a non base view image at the encoder 542 which encodes non base view images.

That is to say, the encoder 541 is supplied with, of the multi-viewpoint color image and packed color image making up the resolution-converted multi-viewpoint color image from the resolution converting device 321C, (frames of) the packed color image.

The encoder 542 is supplied with, of the middle viewpoint color image and packed color image making up the resolution-converted multi-viewpoint color image from the resolution converting device 321C, (the frame of) the middle viewpoint color image.

Further, the encoders 541 and 542 are supplied with resolution conversion information from the resolution converting device 321C.

The encoder 541 performs encoding the same as with the encoder 341 in FIG. 23, on the packed color image supplied thereto as the base view image, and outputs encoded data of the packed color image obtained as a result thereof.

The encoder 542 performs encoding the same as with the encoder 342 in FIG. 23, on the middle viewpoint color image supplied thereto as the non base view image, and outputs encoded data of the middle viewpoint color image obtained as a result thereof.

Now, the encoder 541 performs the same processing as with the encoder 341 in FIG. 23 other than that the object of encoding is not the middle viewpoint color image but the packed color image. The encoder 542 also performs the same processing as with the encoder 342 in FIG. 23 other than that the object of encoding is not the packed color image but the middle viewpoint color image.

Accordingly, at the encoders 541 and 542, the encoding mode is set to the field encoding mode or frame encoding mode, with the setting of the encoding made being performed based on the resolution conversion information from the resolution converting device 321C, in the same way as with the encoders 341 and 342 in FIG. 23.

The encoded data of the packed color image which the encoder 541 outputs, and the encoded data of the middle viewpoint color image which the encoder 542 outputs, are supplied to the multiplexing device 23 (FIG. 18) as multi-viewpoint color image encoded data.

Note that the encoders 541 and 542 perform prediction encoding of an image to be encoded in the same way as with MVC, similar to the encoders 341 and 342 in FIG. 23, so to generate a prediction image to be used for prediction encoding thereof, the image to be encoded is encoded and thereafter locally decoded, and a decoded image is obtained.

The DPB 43 is shared between the encoders 541 and 542, and temporarily stores decoded images obtained at each of the encoders 541 and 542.

The encoders 541 and 542 each select a reference image to be referenced to encode images to be encoded, from decoded images stored in the DPB 43. The encoders 541 and 542 each use reference images to generate prediction images, and perform encoding (prediction encoding) of images using the prediction images.

Accordingly, the encoders 541 and 542 each can reference not only decoded images obtained at themselves, but also decoded images obtained at the other encoder.

Note however, that the encoder 541 encodes base view images as described above, and accordingly only references decoded images obtained at the encoder 541.

### Configuration Example of Encoder 542

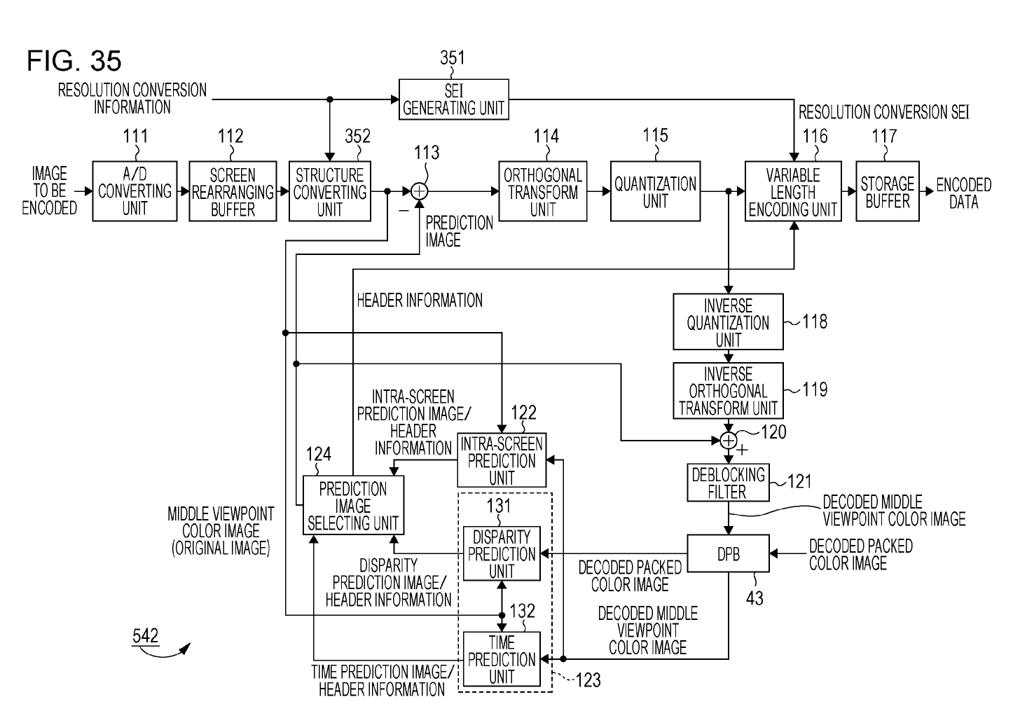

FIG. 35 is a block diagram illustrating a configuration example of the encoder 542 in FIG. 34.

Note that portions in the drawing corresponding to the case in FIG. 24 are denoted with the same symbols, and description hereinafter will be omitted as appropriate.

In FIG. 35, the encoder 542 has the A/D converting unit 111, screen rearranging buffer 112, computing unit 113, orthogonal transform unit 114, quantization unit 115, variable length encoding unit 116, storage buffer 117, inverse quantization unit 118, inverse orthogonal transform unit 119, computing unit 120, deblocking filter 121, intra-screen prediction unit 122, inter prediction unit 123, a prediction image selecting unit 124, a SEI generating unit 351, and a structure converting unit 352.

Accordingly, the encoder 542 is configured in the same way as with the encoder 342 in FIG. 24.

However, the encoder 542 differs from the encoder 342 in FIG. 24 with regard to the point that the object of encoding is the middle viewpoint color image and not the packed color image.

Accordingly, at the encoder 542, disparity prediction of the middle viewpoint color image which is the object of encoding is performed by the disparity prediction unit 131 using the packed color image which is images of other viewpoints, as a reference image.

That is to say, in FIG. 35, the DPB 43 stores a decoded middle viewpoint color image serving as a non base view image encoded at the encoder 542 and locally decoded, supplied from the deblocking filter 121, and also stores a decoded packed color image serving as a base view image encoded at the encoder 541 and locally decoded, supplied from that encoder 541.

The disparity prediction unit 131 then performs disparity prediction of the middle viewpoint color image which is the object of encoding, using the decoded packed color image stored in the DPB 43 as the reference image.

Note that the encoder 541 in FIG. 34 is configured in the same way as with the encoder 542 in FIG. 35. Note however, that the encoder 541 which encodes base view images does not perform disparity prediction in inter prediction, and only performs temporal prediction. Accordingly, the encoder 541 can be configured without providing a disparity prediction unit 131 which performs disparity prediction.

The encoder 541 which encodes base view images performs the same processing as with the encoder 542 which encodes non base view images, except for not performing disparity prediction, so hereinafter, the encoder 542 will be described, and description of the encoder 541 will be omitted as appropriate.

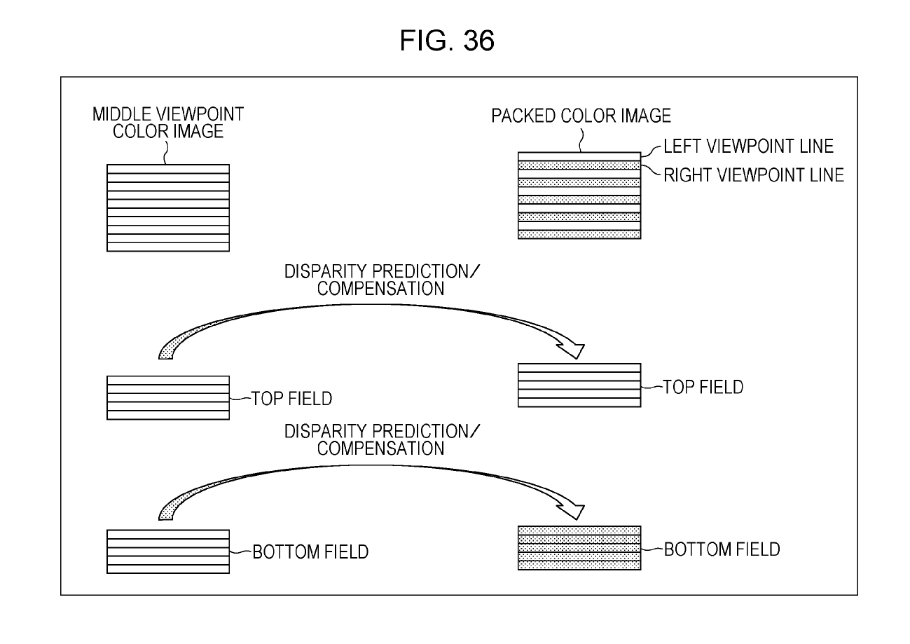

FIG. 36 is a diagram for describing disparity prediction of a picture (field) of a middle viewpoint color image performed at the disparity prediction unit 131 in FIG. 35.

The structure converting unit 352 of the encoder 542 (FIG. 35) sets the encoding mode to field encoding mode in the event that a packed color image which has been subjected to interlaced packing is included in a resolution-converted multi-viewpoint color image, as described with FIG. 26.

In a case of having set the encoding mode to the field encoding mode, a upon a frame serving as a picture being supplied from the screen rearranging buffer 112 the structure converting unit 352 converts this frame into a top field and bottom field, and supplies each field as a picture to the computing unit 113, intra-screen prediction unit 122, and inter prediction unit 123.

That is to say, at the encoder 542 (FIG. 35), the structure converting unit 352 is supplied by the screen rearranging buffer 112 with frames serving as pictures of the middle viewpoint color image to be encoded.

The structure converting unit 352 converts the frames serving as pictures of the middle viewpoint color image from the screen rearranging buffer 112 into top field and bottom field, and supplies each field as a picture to the computing unit 113, intra-screen prediction unit 122, and inter prediction unit 123.

In this case, at the encoder 542, the fields (top field, bottom field) serving as pictures of the middle viewpoint color image are sequentially processed as current pictures.

Accordingly, at the disparity prediction unit 131 of the inter prediction unit 123 (FIG. 35), disparity prediction (of the current block) of a field serving as a picture of the middle viewpoint color image is performed using a picture of the decoded packed color image stored in the DPB 43 (picture at same point-in-time as the current picture) as a reference image.

Now, with the encoder 541 and encoder 542, in the event that the encoding mode of one is set to the field encoding mode, the encoding mode of the other is also set to the field encoding mode, in the same way as with the encoders 341 and 342 (FIG. 23).

Accordingly, in the event that the encoding mode is set to the field encoding mode at the encoder 542, the encoding mode is set to the field encoding mode at the encoder 541 as well. At the encoder 541, the frame of the packed color image which is the base view image is converted into fields (top field and bottom field), and encoding is performed with these fields as a picture.

As a result, the fields serving as a picture of the decoded packed color image are encoded and locally decoded at the encoder 541, and the fields serving as the picture of the decoded packed color image obtained thereby are supplied to the DPB 43 and stored.

At the disparity prediction unit 131, disparity prediction (of the current block) of a field serving as the current picture of the middle viewpoint color image from the structure converting unit 352 is then performed, using a field serving as a picture of the decoded packed color image stored in the DPB 43 as a reference image.

That is to say, at the encoder 542 (FIG. 35), the structure converting unit 352 converts the frame of the middle viewpoint color image to be encoded into a top field configured of odd lines of that frame and a bottom field configured of even lines, and is processed.

On the other hand, at the encoder 541 as well, the frame of the packed color image to be encoded is converted into a top field configured of odd lines of the frame of the left viewpoint color image (left viewpoint lines) and a bottom field configured of even lines of the frame of the right viewpoint color image (right viewpoint lines), and processed, in the same way as with the encoder 542.

The DPB 43 then stores the fields (top field, bottom field) of the decoded packed color image obtained by the processing at the encoder 541, as pictures to serve as a reference image for disparity prediction.

As a result, at the disparity prediction unit 131, disparity prediction a field serving as the current picture of the middle viewpoint color image is performed using a field of the decoded packed color image stored in the DPB 43 as a reference image.

That is to say, disparity prediction of a top field serving as the current picture of the middle viewpoint color image is performed using the top field (at the same point-in-time as the current picture) of the decoded packed color image stored in the DPB 43 as a reference image. Also, disparity prediction of a bottom field serving as the current picture of the middle viewpoint color image is performed using the bottom field (at the same point-in-time as the current picture) of the decoded packed color image stored in the DPB 43 as a reference image.

Accordingly, the resolution ratio of the field of the middle viewpoint color image serving as the current picture, and the resolution ratio of the field of the decoded packed color image which serves as the picture of the reference image to be referenced at the time of generating a prediction image of that packed color image at the disparity prediction unit 131, agree (match).

That is to say, the resolution ratio of each of the top field and bottom field of the middle viewpoint color image to be encoded is 2:1.

On the other hand, with regard to reference images, the vertical resolution of the left viewpoint color image and right viewpoint color image configuring the top field and bottom field of the decoded packed color image is each ½ of the original, and accordingly the resolution ratio of the left viewpoint color image and right viewpoint color image serving as the top field and bottom field of the decoded packed color image is 2:1.

Accordingly, resolution of each of the left viewpoint color image and right viewpoint color image configuring the top field and bottom field of the decoded packed color image, and the resolution ratio of each of the top field and bottom field of the middle viewpoint color image to be encoded, agree at 2:1.

Thus, the resolution ratio of the fields (top field and bottom field) serving as the current picture of the middle viewpoint color image, and the resolution ratio of the field of the decoded packed color image to serve as a reference image agree, so the prediction precision of disparity prediction can be improved (the residual between the prediction image generated in disparity prediction and the current block becomes small), and encoding efficiency can be improved.

As a result, deterioration in image quality of the decoded image obtained at the reception device 12, due to resolution conversion where the data amount at the baseband of a multi-viewpoint color image (and multi-viewpoint depth image) is reduced, can be prevented.

### Encoding Processing of Middle Viewpoint Color Image

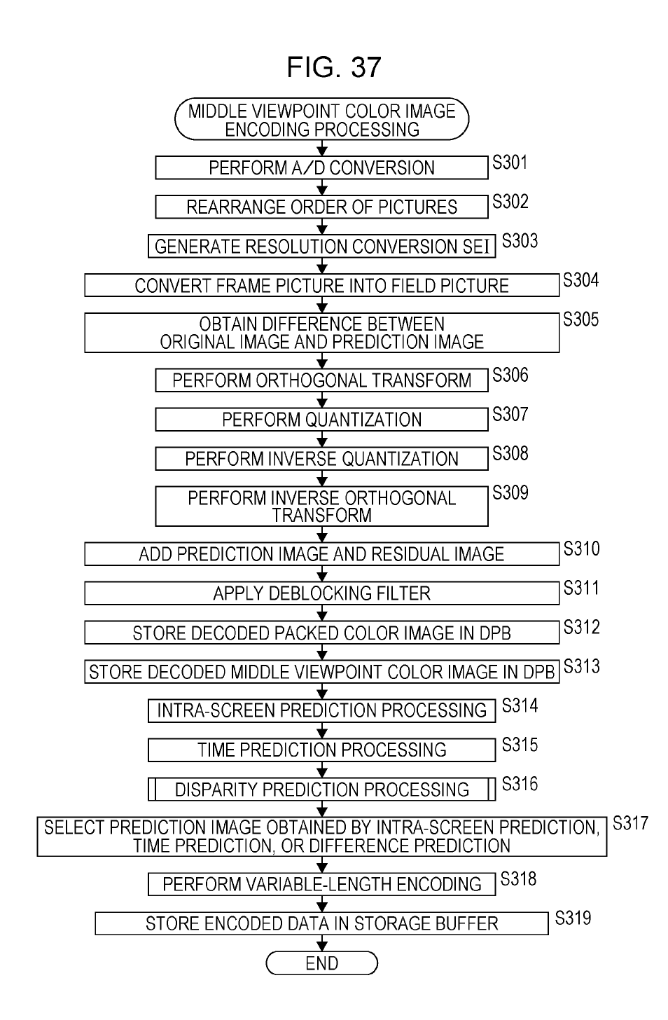

FIG. 37 is a flowchart for describing encoding processing to encode a middle viewpoint color image, which the encoder 542 in FIG. 35 performs.

In steps S301 through S319, the encoder 542 performs the same processing as with the steps S101 through S119 in FIG. 28, except that the object of encoding is a middle viewpoint color image rather than a packed color image, and further that accordingly, the disparity prediction of the middle viewpoint color image to be encoded is performed using the packed color image as a reference image.

That is to say, in step S301, the A/D converting unit 111 performs A/D conversion of analog signals of the frame serving as the picture of the middle viewpoint color image supplied thereto, supplies to the screen rearranging buffer 112, and the flow advances to step S302.

In step S302, the screen rearranging buffer 112 temporarily stores the frame serving as the picture of the middle viewpoint color image from the A/D converting unit 111, and reads out pictures in accordance with a GOP structure decided beforehand, thereby performing rearranging in which the order of pictures is rearranged from display order to encoding order (decoding order).

The frame serving as the picture read out from the screen rearranging buffer 112 is supplied to the structure converting unit 352, and the flow advances from step S302 to step S303.

In step S303, the SEI generating unit 351 generates the resolution conversion SEI described with FIG. 25 and FIG. 26 from the resolution conversion information supplied from the resolution converting device 321C (FIG. 18), supplies to the variable length encoding unit 116, and the flow advances to step S304.

In step S304, the structure converting unit 352 sets the encoding mode to the field encoding mode, based on the resolution conversion information supplied from the resolution converting device 321C (FIG. 18).

Further, upon having set the encoding mode to the field encoding mode, the structure converting unit 352 converts the frame serving as the picture of the middle viewpoint color image from the screen rearranging buffer 112 into the two fields of a top field and bottom field, supplies to the computing unit 113, intra-screen prediction unit 122, and disparity prediction unit 131 and temporal prediction unit 132 of the inter prediction unit 123, and the flow advances from step S304 to step S305.

In step S305, the computing unit 113 takes the field serving as the picture of the middle viewpoint color image from the structure converting unit 352 as the current picture to be encoded, and further, sequentially takes macroblocks configuring the current picture as the current block to be encoded.

The computing unit 113 then computes the difference (residual) between the pixel values of the current block and the pixel values of the prediction image supplied from the prediction image selecting unit 124 as necessary, supplies to the orthogonal transform unit 114, and the flow advances from step S305 to step S306.

In step S306, the orthogonal transform unit 114 subjects the current block from the computing unit 113 to orthogonal transform, supplies the transform coefficient obtained as a result thereof to the quantization unit 115, and the flow advances to step S307.

In step S307, the quantization unit 115 quantizes the transform coefficients supplied from the orthogonal transform unit 114, supplies the quantization values obtained as the result thereof to the inverse quantization unit 118 and variable length encoding unit 116, and the flow advances to step S308.

In step S308, the inverse quantization unit 118 performs inverse quantization of the quantization values from the quantization unit 115 into transform coefficients, supplies to the inverse orthogonal transform unit 119, and the flow advances to step S309.

In step S309, the inverse orthogonal transform unit 119 performs inverse orthogonal transform of the transform coefficients from the inverse quantization unit 118, supplies to the computing unit 120, and the flow advances to step S310.

In step S310, The computing unit 120 adds the pixel values of the prediction image supplied from the prediction image selecting unit 124 to the data supplied from the inverse orthogonal transform unit 119 as necessary, thereby obtaining a decoded middle viewpoint color image where the current block has been decoded (locally decoded). The computing unit 120 then supplies the decoded middle viewpoint color image where the current block has been locally decoded to the deblocking filter 121, and the flow advances from step S310 to step S311.

In step S311, the deblocking filter 121 filters the decoded middle viewpoint color image from the computing unit 120 and supplies to the DPB 43, and the flow advances to step S312.

In step S312, the DPB 43 awaits for the encoder 541 (FIG. 34) which encodes the packed color image to supply thereto a decoded packed color image obtained by encoding and locally decoding the packed color image, stores the decoded packed color image, and the flow advances to step S313.

As described above, the encoder 541 performs the same processing as with the encoder 542 except that disparity prediction is not performed, i.e., encoding is performed in the field encoding mode with the field of the packed color image as a picture. Accordingly, the DPB 43 stores the top field configured of odd lines of the left viewpoint color image, and the bottom field configured of even lines of the right viewpoint color image.

In step S313, the DPB 43 stores the (field of the) decoded middle viewpoint color image from the deblocking filter 121, and the flow advances to step S314.

In step S314 the intra-screen prediction unit 122 performs intra prediction processing (intra-screen prediction processing) for the next current block.

That is to say, the intra-screen prediction unit 122 performs intra prediction processing (intra-screen prediction) to generate a prediction image (intra-predicted prediction image) from the field serving as the picture of the decoded middle viewpoint color image stored in the DPB 43, for the next current block.

The intra-screen prediction unit 122 then uses the intra-predicted prediction image to obtain the encoding costs needed to encode the next current block, supplies this to the prediction image selecting unit 124 along with (information relating to intra-prediction serving as) header information and the intra-predicted prediction image, and the flow advances from step S314 to step S315.

In step S315, the temporal prediction unit 132 performs temporal prediction processing regarding the next current block, with the field serving as the picture of the decoded middle viewpoint color image as a reference image.

That is to say, the temporal prediction unit 132 uses the field serving as the picture of the decoded middle viewpoint color image stored in the DPB 43 to perform temporal prediction regarding the next current block, thereby obtaining prediction image, encoding cost, and so forth, for each inter prediction mode with different macroblock type and so forth.

Further, the temporal prediction unit 132 takes the inter prediction mode of which the encoding cost is the smallest as being the optimal inter prediction mode, supplies the prediction image of that optimal inter-prediction mode to the prediction image selecting unit 124 along with (information relating to inter-prediction serving as) header information and the encoding cost, and the flow advances from step S315 to step S316.

In step S316, the disparity prediction unit 131 performs disparity prediction processing of the next current block, with the field serving as the picture of the decoded packed color image as a reference image.

That is to say, the disparity prediction unit 131 performs disparity prediction for the next current block using the field serving as the picture of the decoded packed color image stored in the DPB 43, thereby obtaining a prediction image, encoding cost, and so forth, for each inter prediction mode of which the macroblock type and so forth differ.

Further, the disparity prediction unit 131 takes the inter prediction mode of which the encoding cost is the smallest as the optimal inter prediction mode, supplies the prediction image of that optimal inter prediction mode to the prediction image selecting unit 124 along with (information relating to inter prediction serving as) header information and the encoding cost, and the flow advances from step S316 to step S317.

In step S317, the prediction image selecting unit 124 selects, from the prediction image from the intra-screen prediction unit 122 (intra-predicted prediction image), prediction image from the temporal prediction unit 132 (temporal prediction image), and prediction image from the disparity prediction unit 131 (disparity prediction image), the prediction image of which the encoding cost is the smallest for example, supplies this to the computing units 113 and 220, and the flow advances to step S318.

Now, the prediction image which the prediction image selecting unit 124 selects in step S317 is used in the processing of steps S305 and S310 performed for encoding of the next current block.

Also, the prediction image selecting unit 124 selects, of the header information supplied from the intra-screen prediction unit 122, temporal prediction unit 132, and disparity prediction unit 131, the header information supplied along with the prediction image of which the encoding cost is the smallest, and supplies to the variable length encoding unit 116.

In step S318, the variable length encoding unit 116 subjects the quantization values from the quantization unit 115 to variable-length encoding, and obtains encoded data.

Further, the variable length encoding unit 116 includes the header information from the prediction image selecting unit 124 and the resolution conversion SEI from the SEI generating unit 351, in the header of the encoded data.

The variable length encoding unit 116 then supplies the encoded data to the storage buffer 117, and the flow advances from step S318 to step S319.

In step S319, the storage buffer 117 temporarily stores the encoded data from the variable length encoding unit 116.

The encoded data stored at the storage buffer 117 is supplied (transmitted) to the multiplexing device 23 (FIG. 18) at a predetermined transmission rate.

The processing of steps S301 through S319 above is repeatedly performed as appropriate at the encoder 542.

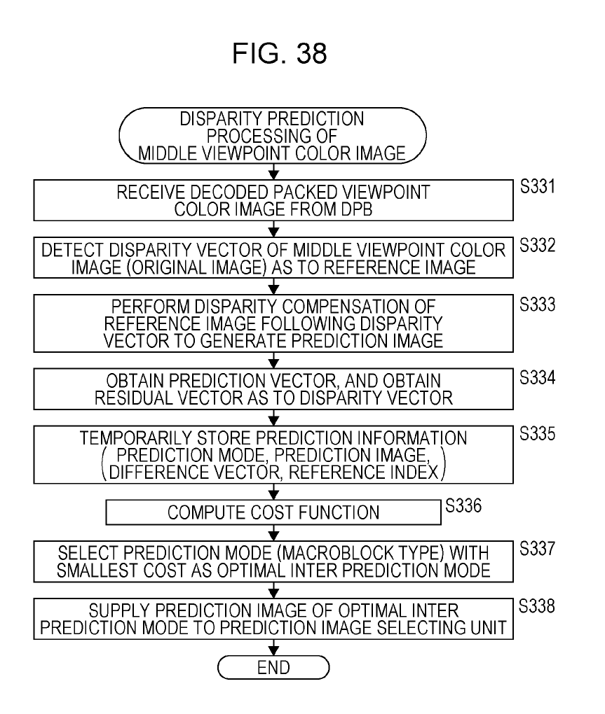

FIG. 38 is a flowchart for describing disparity prediction processing of a middle viewpoint color image which the disparity prediction unit 131 (FIG. 13) of the encoder 542 performs in step S316 in FIG. 37.

At the disparity prediction unit 131 of the encoder 542, processing the same as with steps S131 through S138 in FIG. 29 is performed in steps S331 through S338, except that the object of encoding is the middle viewpoint color image instead of the packed color image, and the disparity prediction of the middle viewpoint color image which is the object of encoding is used as a reference image for the packed color image.

That is to say, in step S331, at the disparity prediction unit 131 (FIG. 13), the disparity detecting unit 141 and disparity compensation unit 142 receive the field serving as the picture of the decoded packed color image as a reference image from the DPB 43, and the flow advances to step S332.

In step S332, the disparity detecting unit 141 performs ME using the current block of the field serving as the current picture of the middle viewpoint color image supplied from the structure converting unit 352 (FIG. 35) and the field of the decoded packed color image serving as a reference image from the DPB 43, thereby detecting the disparity vector my representing the disparity at the current block as to the reference image, for each macroblock type, which is supplied to the disparity compensation unit 142, and the flow advances to step S333.

In step S333, the disparity compensation unit 142 performs disparity compensation of the field of the decoded packed color image serving as a reference image from the DPB 43 using the disparity vector my of the current block from the disparity detecting unit 141, thereby generating a prediction image of the current block, for each macroblock type, and the flow advances to step S334.

That is to say, the disparity compensation unit 142 obtains a corresponding block which is a block (region) in the field of the decoded packed color image serving as a reference image, shifted by an amount equivalent to the disparity vector my from the position of the current block, as a prediction image.

In step S334, the disparity compensation unit 142 uses disparity vectors and so forth of macroblocks at the periphery of the current block, that have already been encoded, as necessary, thereby obtaining a prediction vector PMV of the disparity vector my of the current block.

Further, the disparity compensation unit 142 obtains a residual vector which is the difference between the disparity vector my of the current block and the prediction vector PMV.

The disparity compensation unit 142 then correlates the prediction image of the current block for each prediction mode, such as macroblock type, with the prediction mode, along with the residual vector of the current block and the reference index assigned to the reference image (field of the decoded packed color image) used for generating the prediction image, and supplies to the prediction information buffer 143 and the cost function calculating unit 144, and the flow advances from step S334 to step S335.

In step S335, the prediction information buffer 143 temporarily stores the prediction image correlated with the prediction mode, residual vector, and reference index, from the disparity compensation unit 142, as prediction information, and the flow advances to step S336.

In step S336, the cost function calculating unit 144 obtains the encoding cost (cost function value) needed to encode the current block of the current picture from the structure converting unit 352 (FIG. 35) by calculating a cost function, for each macroblock type serving as a prediction mode, supplies this to the mode selecting unit 145, and the flow advances to step S337.

In step S337, the mode selecting unit 145 detects the smallest cost which is the smallest value, from the encoding costs for each macroblock type from the cost function calculating unit 144.

Further, the mode selecting unit 145 selects the macroblock type of which the smallest cost has been obtained, as the optimal inter prediction mode.

The flow then advances from step S337 to step S338, where the mode selecting unit 145 reads out the prediction image correlated with the prediction mode which is the optimal inter prediction mode, residual vector, and reference index, from the prediction information buffer 143, supplies to the prediction image selecting unit 124 as prediction information, as well as the prediction mode which is the optimal inter prediction mode, and the processing returns.

### Another Configuration Example of Decoding Device 332C

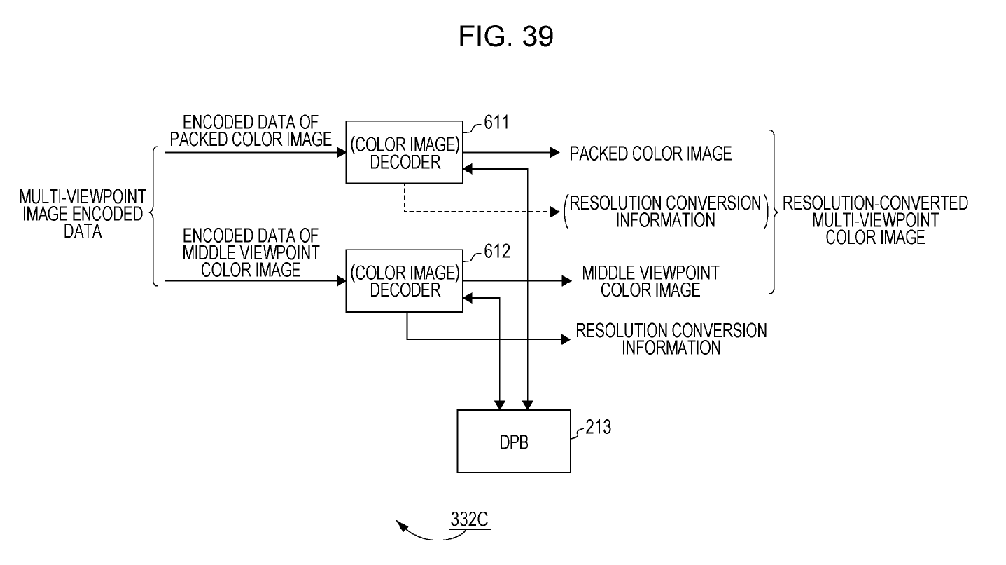

FIG. 39 is a block diagram illustrating a configuration example of the decoding device 332C in FIG. 19.

That is to say, FIG. 39 is a block diagram illustrating a configuration example of the decoding device 332C in a case where the encoding device 322C is configured as illustrated in FIG. 34.

Note that portions in FIG. 39 corresponding to the case in FIG. 30 are denoted with the same symbols, and description thereof will be omitted as appropriate hereinafter.

In FIG. 39, the decoding device 332C has decoders 611 and 612, and the DPB 213.

Accordingly, the decoding device 332C in FIG. 39 has in common with the case in FIG. 30 the point of having the DPB 213, but differs from the case in FIG. 30 in that the decoders 611 and 612 have been provided instead of the decoders 411 and 412.

FIG. 30 and FIG. 39 differ in that, while in FIG. 30, the decoder 411 performs processing with the middle viewpoint color image as a base view image, and the decoder 412 performs processing with the packed color image as a non base view image, in FIG. 39, the decoder 611 performs processing with the packed color image as a base view image, and the decoder 612 performs processing with the middle viewpoint color image as a non base view image.

The decoder 611 is supplied with, of the multi-viewpoint color image encoded data from the inverse multiplexing device 31 (FIG. 19), encoded data of the packed color image.

The decoder 611 decodes the encoded data of the packed color image supplied thereto, as encoded data of the base view image, in the same way as with the decoder 411 in FIG. 30, and outputs a packed color image obtained as the result thereof.

The decoder 612 is supplied with, of the multi-viewpoint color image encoded data from the inverse multiplexing device 31 (FIG. 19), encoded data of the middle viewpoint color image.

The decoder 612 decodes the encoded data of the middle viewpoint color image supplied thereto, as encoded data of a non base view image, in the same way as with the decoder 412 in FIG. 30, and outputs a middle viewpoint color image obtained as the result thereof.

The packed color image which the decoder 611 outputs and the middle viewpoint color image which the decoder 612 outputs are then supplied to the resolution inverse converting device 333C (FIG. 19) as a resolution-converted multi-viewpoint color image.

Now, the decoders 611 and 612 decode prediction-encoded images in the same way as with the decoders 411 and 412 in FIG. 30, and in order to generate a prediction image used in the prediction encoding thereof, after decoding an image to be decoded, the image after decoding which is to be used for generating a prediction image is temporarily stored in the DPB 213.

The DPB 213 is shared by the decoders 611 and 612, and temporarily stores images after decoding (decoded images) obtained at each of the decoders 611 and 612.

Each of the decoders 611 and 612 select a reference image to reference to decode the image to be decoded, from the decoded images stored in the DPB 213, and generate prediction images using the reference images.

The DPB 213 is thus shared between the decoders 611 and 612, so the decoders 611 and 612 can each reference, besides decoded images obtained from itself, decoded images obtained at the other decoder as well.

Note however, the decoder 611 decodes base view images, so only references decoded images obtained at the decoder 611 (disparity prediction is not performed).

### Configuration Example of Decoder 612

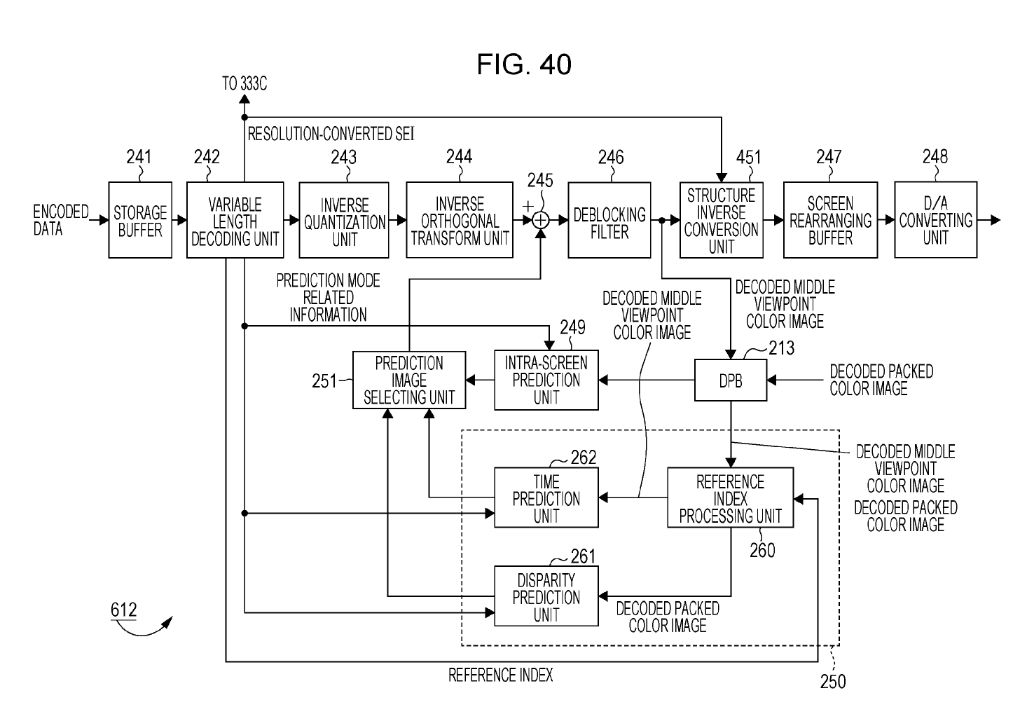

FIG. 40 is a block diagram illustrating a configuration example of the decoder 612 in FIG. 39.

Note that portions in the drawing corresponding to the case in FIG. 31 are denoted with the same symbols, and description thereof will be omitted as appropriate hereinafter.

In FIG. 40, the decoder 612 has a storage buffer 241, a variable length decoding unit 242, an inverse quantization unit 243, an inverse orthogonal transform unit 244, a computing unit 245, a deblocking filter 246, a screen rearranging buffer 247, a D/A conversion unit 248, an intra-screen prediction unit 249, an inter prediction unit 250, a prediction image selecting unit 251, and a structure inverse conversion unit 451.

Thus, the decoder 612 in FIG. 40 is configured in the same way as with the decoder 412 in FIG. 31.

However, the decoder 612 differs from the decoder 412 in FIG. 31 in the point that the object of decoding is the middle viewpoint color image rather than the packed color image.

Accordingly, with the decoder 612, disparity prediction of the middle viewpoint color image to be decoded is performed at the disparity prediction unit 261 using the packed color image, which is an image of other viewpoints, as a reference image.

That is to say, in FIG. 40, the DPB 213 stores the decoded middle viewpoint color image serving as the non base view image decoded at the decoder 612, which is supplied from the deblocking filter 246, and stores the decoded packed color image serving as the base view image decoded at the decoder 611, which is supplied from that decoder 611.

The disparity prediction unit 261 then performs disparity prediction of the middle viewpoint color image which is to be decoded, using the decoded packed color image stored in the DPB 213 as the reference image.

Note that the decoder 611 in FIG. 39 is a also configured in the same way as with the decoder 612 in FIG. 40. Note however, that with the decoder 611 which decodes the base view image, disparity prediction is not performed in inter prediction, and only temporal prediction is performed. Accordingly, the decoder 611 can be configured without providing a disparity prediction unit 261 to perform disparity prediction.

The decoder 611 which decodes base view images performs processing basically the same as with the decoder 612 which decodes non base view images, except for not performing disparity prediction, so hereinafter the decoder 612 will be described, and description of the decoder 611 will be omitted as appropriate.

### Decoding Processing of Middle Viewpoint Color Image

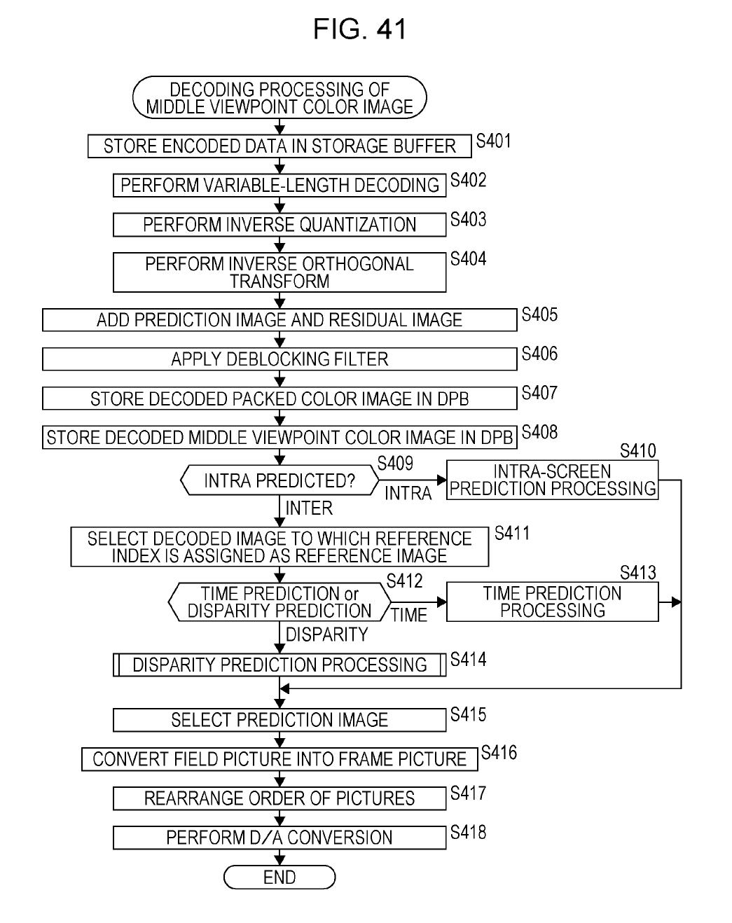

FIG. 41 is a flowchart for describing decoding processing for decoding encoded data of a middle viewpoint color image, which the decoder 612 in FIG. 40 performs.

With the decoder 612, processing the same as the steps S201 through S218 in FIG. 32 is performed in steps S401 through S418, except that the object of decoding is a middle viewpoint color image rather than a packed color image, and further that disparity prediction for the middle viewpoint color image to be decoded is accordingly performed with the packed color image as a reference image.

That is to say, in step S401, the storage buffer 241 stores encoded data of the middle viewpoint color image supplied thereto, and the processing advances to step S402.

In step S402, the variable length decoding unit 242 reads out the encoded data stored in the storage buffer 241 and performs variable length decoding, thereby restoring prediction mode related information and the resolution conversion SEI. The variable length decoding unit 242 then supplies the quantization values to the inverse quantization unit 243, the prediction mode related information to the intra-screen prediction unit 249, and reference index processing unit 260 and disparity prediction unit 261 and temporal prediction unit 262 of the inter prediction unit 250, and supplies the resolution conversion SEI to the structure inverse conversion unit 451 and resolution inverse converting device 333C (FIG. 19), and the flow advances to step S403.

In step S403, the inverse quantization unit 243 performs inverse quantization of quantization values from the variable length decoding unit 242 into transform coefficients, supplies to the inverse orthogonal transform unit 244, and the flow advances to step S404.

In step S404, the inverse orthogonal transform unit 244 performs inverse orthogonal transform on the transform coefficients from the inverse quantization unit 243, supplies to the computing unit 245 in increments of macroblocks, and the flow advances to step S405.

In step S405, the computing unit 245 takes the macroblock from the inverse orthogonal transform unit 244 as a current block (residual image) to be decoded, and adds the prediction image supplied from the prediction image selecting unit 251 to the current block as necessary, thereby obtaining a decoded image. The computing unit 245 then supplies the decoded image to the deblocking filter 246, and the flow advances from step S405 to step S406.

In step S406, the deblocking filter 246 performs filtering on the decoded image from the computing unit 245, supplies the decoded image after filtering (decoded middle viewpoint color image) to the DPB 213 and the structure inverse conversion unit 451, and the flow advances to step S407.

In step S407, the DPB 213 awaits for the decoded packed color image to be supplied from the decoder 611 (FIG. 39) which decodes the packed color image, stores the decoded packed color image, and the flow advances to step S408.

In step S408, the DPB 213 stores the decoded middle viewpoint color image from the deblocking filter 246, and the flow advances to step S409.

Now, with the encoder 541 in FIG. 34, the packed color image has the fields thereof encoded as the current picture, and with the encoder 542, the middle viewpoint color image has the fields thereof encoded as the current picture.

Accordingly, at the decoder 611 which decodes the encoded data of the packed color image, the packed color image has the fields thereof decoded as the current picture. In the same way, at the decoder 612 which decodes the encoded data of the middle viewpoint color image, the middle viewpoint color image has the fields thereof decoded as the current picture.

Accordingly, the DPB 213 has stored therein the decoded packed color image in fields (structure) and decoded middle viewpoint color image.

In step S409, the intra-screen prediction unit 249 and (the temporal prediction unit 262 and disparity prediction unit 261 making up) the inter prediction unit 250 determine which prediction method of intra prediction (intra-screen prediction) and inter prediction the prediction image has been generated with, that has been used to encode the next current block (the macroblock to be decoded next), based on the prediction mode related information supplied from the variable length decoding unit 242.

In the event that determination is then made in step S409 that the next current block has been encoded using a prediction image generated with intra-screen prediction, the flow advances to step S410, and the intra-screen prediction unit 249 performs intra prediction processing (intra screen prediction).

That is to say, the intra-screen prediction unit 249 performs intra prediction (intra-screen prediction) to generated a prediction image (intra-predicted prediction image) from the decoded middle viewpoint color image stored in the DPB 213 for the next current block, supplies that prediction image to the prediction image selecting unit 251, and the flow advances from step S410 to step S415.

Also, in the event that determination is made in step S409 that the next current block has been encoded using a prediction image generated in inter prediction, the flow advances to step S411, where the reference index processing unit 260 reads out the field serving as the picture of the decoded packed color image to which a reference index for prediction included in the prediction mode related information from the variable length decoding unit 242 has been assigned, or the field serving as the picture of the decoded middle viewpoint color image, from the DPB 213, as a reference image, and the flow advances to step S412.

In step S412, the reference index processing unit 260 determines which prediction method of temporal prediction which is inter prediction and disparity prediction the prediction image has been generated with, that has been used to encode the next current block, based on the reference index for prediction included in the prediction mode related information supplied from the variable length decoding unit 242.

In the event that determination is made in step S412 that the next current block has been determined to have been encoded using a prediction image generated by temporal prediction, i.e., in the event that the picture to which the reference index for prediction, for the (next) current block from the variable length decoding unit 242, has been assigned, is the picture of the decoded middle viewpoint color image, and this picture of the decoded middle viewpoint color image has been selected in step S411 as a reference image, the reference index processing unit 260 supplies the picture of the decoded middle viewpoint color image to the temporal prediction unit 262 as a reference image, and the flow advances to step S413.

In step S413, the temporal prediction unit 262 performs temporal prediction processing.

That is to say, with regard to the next current block, the temporal prediction unit 262 performs motion compensation of the picture of the decoded middle viewpoint color image serving as the reference image from the reference index processing unit 260, using the prediction mode related information from the variable length decoding unit 242, thereby generating a prediction image, supplies the prediction image to the prediction image selecting unit 251, and the processing advances from step S413 to step S415.

Also, in the event that determination is made in step S412 that the next current block has been encoded using a prediction image generated by disparity prediction, i.e., in the event that the picture to which the reference index for prediction, for the (next) current block from the variable length decoding unit 242, has been assigned, is a field serving as the picture of the decoded packed color image, and this field serving as the picture of the decoded packed color image has been selected as a reference image in step S411, the reference index processing unit 260 supplies the field serving as the picture of the decoded packed color image to the disparity prediction unit 261 as a reference image, and the flow advances to step S414.

In step S414, the disparity prediction unit 261 performs disparity prediction processing.

That is to say, the disparity prediction unit 261 performs disparity compensation of the field serving as the picture of the decoded packed color image serving as the reference image for the next current block, using prediction mode related information from the variable length decoding unit 242, so as to generate a prediction image, and supplies that prediction image to the prediction image selection unit 251, and the flow advances from step S414 to step S415.

In step S415, the prediction image selecting unit 251 selects the prediction image from the one of the intra-screen prediction unit 249, temporal prediction unit 262, and disparity prediction unit 261, from which the prediction image is supplied, supplies this to the computing unit 245, and the flow advances to step S416.

The prediction image which the prediction image selecting unit 251 selects here in step S415 is used in the processing in step S405 performed in the decoding of the next current block.

In step S416, in the event that a decoded middle viewpoint color image of top field and bottom field making up a frame has been supplied from the deblocking filter 246, based on the resolution conversion SEI from the variable length decoding unit 242 the structure inverse conversion unit 451 performs inverse conversion of the top field and bottom field into a frame, and supplies this to the screen rearranging buffer 247, and the flow advances to step S417.

In step S417, the screen rearranging buffer 247 temporarily stores and reads out the frame serving as the picture of the decoded middle viewpoint color image from the structure inverse conversion unit 451, thereby rearranging the order of pictures to the original order, which are supplied to the D/A conversion unit 248, and the flow advances to step S418.

In step S418, in the event that there is need to output a picture from the screen rearranging buffer 247 in analog, the D/A conversion unit 248 performs D/A conversion of that picture and outputs.

The above-described processing of steps S401 through S418 is repeatedly performed at the decoder 612.

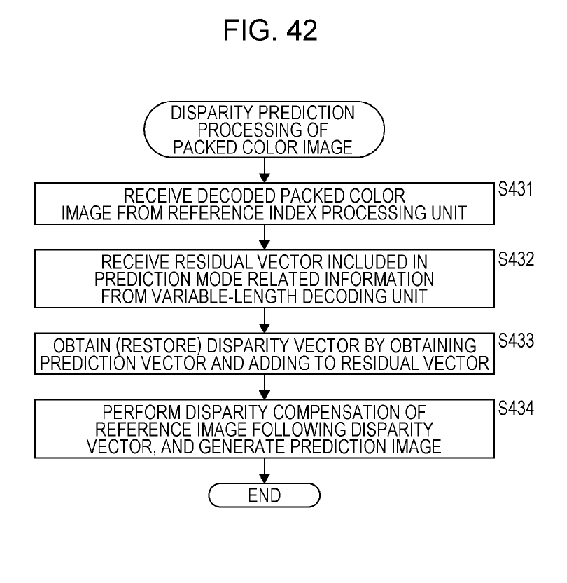

FIG. 42 is a flowchart for describing disparity prediction processing which the disparity prediction unit 261 (FIG. 17) performs in step S414 in FIG. 41.

In steps S431 through S434, the disparity prediction unit 261 of the decoder 612 performs the same processing as the processing in steps S231 through S234 in FIG. 33, except that the object of decoding is a middle viewpoint color image rather than a packed color image, and that a packed color image is used as a reference image for disparity prediction of the middle viewpoint color image which is to be decoded.

In step S431, at the disparity prediction unit 261 (FIG. 17), the disparity compensation unit 272 receives the field serving as the picture of the decoded packed color image serving as a reference image from the reference index processing unit 260, and the flow advances to step S432.

In step S432, the disparity compensation unit 272 receives the residual vector of the (next) current block included in the prediction mode related information from the variable length decoding unit 242, and the flow advances to step S433.

In step S433, the disparity compensation unit 272 uses the disparity vectors of already-decoded macroblocks in the periphery of the current block of the field serving as the picture of the middle viewpoint color image, and so forth, to obtain a prediction vector of the current block regarding the macroblock type which the prediction mode (optimal inter prediction mode) included in the prediction mode related information from the variable length decoding unit 242 indicates.

Further, the disparity compensation unit 272 adds the prediction vector of the current block and the residual vector from the variable length decoding unit 242, thereby restoring the disparity vector my of the current block, and the flow advances from step S433 to step S434.

In step S434, the disparity compensation unit 272 generates a prediction image of the current block by performing disparity compensation of the field serving as the picture of the decoded packed color image serving as the reference image from the reference index processing unit 260, using the disparity vector my of the current block, supplies to the prediction image selecting unit 251, and the flow returns.

### Configuration Example of Transmission Device 11

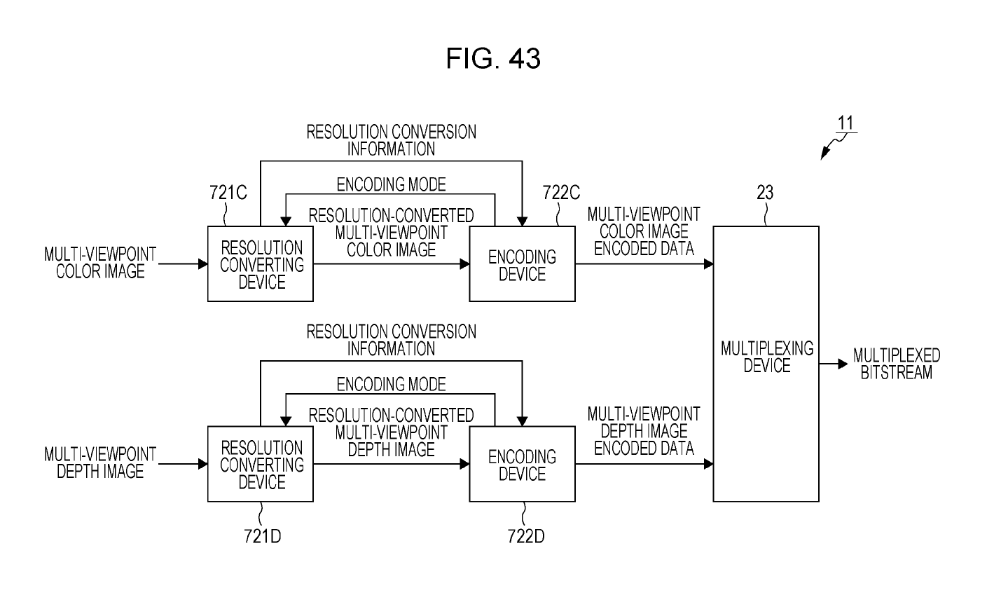

FIG. 43 is a block diagram illustrating another configuration example of the transmission device 11 in FIG. 1.

Note that portions in the drawing corresponding to the case in FIG. 18 are denoted with the same symbols, and description hereinafter will be omitted as appropriate.

In FIG. 43, the transmission device 11 has resolution converting devices 721C and 721D, encoding devices 722C and 722D, and a multiplexing device 23.

Accordingly, the transmission device 11 in FIG. 43 has in common with the case in FIG. 18 the point of having the multiplexing device 23, and differs from the case in FIG. 18 regarding the point that the resolution converting devices 721C and 721D and encoding devices 722C and 722D have been provided instead of the resolution converting devices 321C and 321D and encoding devices 322C and 322D.

A multi-viewpoint color image is supplied to the resolution converting device 721C.

The resolution converting device 721C performs processing the same as each of the resolution converting devices 321C in FIG. 18, for example.

That is to say, the resolution converting device 721C performs resolution conversion of converting a multi-viewpoint color image supplied thereto into a resolution-converted multi-viewpoint color image having a low resolution lower than the original resolution, and supplies the resolution-converted multi-viewpoint color image obtained as a result thereof to the encoding device 722C.

Further, the resolution converting device 721C generates resolution conversion information, and supplies to the encoding device 722C.

Now, the resolution converting device 721C is supplied from the encoding device 722C with an encoding mode representing the field encoding mode or the frame encoding mode.

The resolution converting device 721C decides a packing pattern for packing the left viewpoint color image and right viewpoint color image included in the multi-viewpoint color image supplied thereto, in accordance with the encoding mode supplied from the encoding device 722C.

That is to say, in the event that the encoding mode supplied from the encoding device 722C is the field encoding mode, the resolution converting device 721C decides the interlaced packing pattern (hereinafter also referred to as interlace pattern) as the packing pattern for packing the left viewpoint color image and right viewpoint color image included in the multi-viewpoint color image.

Now, the packing pattern corresponds to the parameter frame_packing_info[i] described with FIG. 25 and FIG. 26.

Upon deciding the packing pattern, the resolution converting device 721C packs the left viewpoint color image and right viewpoint color image included in the multi-viewpoint color image following that packing pattern, and supplies the resolution-converted multi-viewpoint color image including the packed color image obtained as the result thereof to the encoding device 722C.

Other than supplying the encoding mode to the resolution converting device 721C, the encoding device 722C performs processing the same as with the encoding device 322C in FIG. 18.

That is to say, the encoding device 722C encodes the resolution-converted multi-viewpoint color image supplied from the resolution converting device 721C with an extended format, and supplies multi-viewpoint color image encoded data which is encoded data obtained as the result thereof, to the multiplexing device 23.

The resolution converting device 721D is supplied with a multi-viewpoint depth image.

The resolution converting device 721D and encoding device 722D perform the same processing as with the resolution converting device 721C and encoding device 722C, other than that the object of processing is a depth image (multi-viewpoint depth image) rather than a color image (multi-viewpoint color image).

Note that the multiplexed bitstream obtained at the transmission device 11 in FIG. 43 can be decoded into multi-viewpoint color images and multi-viewpoint depth images at the reception device 12 in FIG. 19.

### Configuration Example of Encoding Device 722C

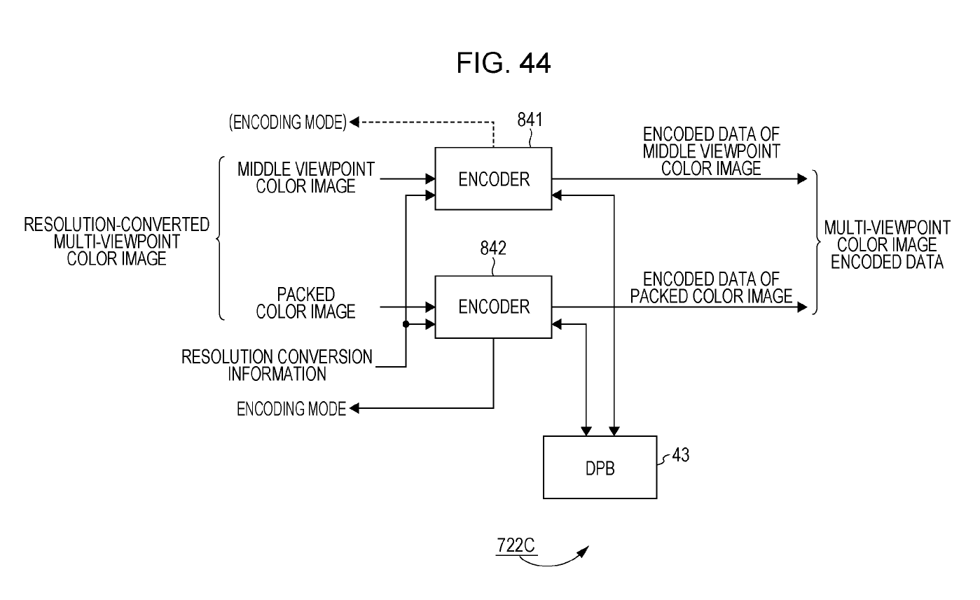

FIG. 44 is a block diagram illustrating a configuration example of the encoding device 722C in FIG. 43.

Note that portions in the drawing corresponding to the case in FIG. 23 are denoted with the same symbols, and description hereinafter will be omitted as appropriate.

In FIG. 44, the encoding device 722C has encoders 841 and 842, and the DPB 43.

Accordingly, the encoding device 722C in FIG. 44 has in common with the encoding device 322C in FIG. 23 the point of having the DPB 43, and differs from the encoding device 322C in FIG. 23 in that the encoders 341 and 342 have been replaced by the encoders 841 and 842.

The encoder 841 is supplied with, of the middle viewpoint color image and packed color image configuring the resolution-converted multi-viewpoint color image from the resolution converting device 721C, (the frame of) the middle viewpoint color image.

The encoder 842 is supplied with, of the middle viewpoint color image and packed color image configuring the resolution-converted multi-viewpoint color image from the resolution converting device 721C, (the frame of) the packed color image.

The encoders 841 and 842 are further supplied with resolution conversion information from the resolution converting device 721C.

In the same way as with the encoder 341 in FIG. 23, the encoder 841 encodes the middle viewpoint color image as the base view image, and outputs encoded data of the middle viewpoint color image obtained as a result thereof.

In the same way as with the encoder 342 in FIG. 23, the encoder 842 encodes the packed color image as the non base view image, and outputs encoded data of the packed color image obtained as a result thereof.

The encoder 842 (and the encoder 841 as well) sets the encoding mode to the field encoding mode or frame encoding mode in accordance with user operations or the like, for example, (or, in accordance with encoding cost, sets the one of field encoding mode and frame encoding mode of which the encoding cost is smaller) and performs encoding in that encoding mode.

Also, upon setting the encoding mode, the encoder 842 supplies that encoding mode to the resolution converting device 721C.

Now, upon the encoding mode being supplied from the encoder 842 of the encoding device 722C, the resolution converting device 721C decides the packing pattern to pack the left viewpoint color image and right viewpoint color image included in the multi-viewpoint color image, in accordance with that encoding mode, as described with FIG. 43.

The encoded data of the middle viewpoint color image which the encoder 841 outputs, and the encoded data of the packed color image which the encoder 842 outputs, are supplied to the multiplexing device 23 (FIG. 43) as multi-viewpoint color image encoded data.

Now, in FIG. 44, the DPB 43 is shared by the encoders 841 and 842.

That is to say, the encoders 841 and 842 perform prediction encoding of the image to be encoded in the same way as with MVC. Accordingly, in order to generate a prediction image to be used for prediction encoding, the encoders 841 and 842 encode the image to be encoded, and thereafter perform local decoding, thereby obtaining a decoded image.

The DPB 43 then temporarily stores decoded images obtained from each of the encoders 841 and 842.

The encoders 841 and 842 each select reference images to reference when encoding images to encode, from decoded images stored in the DPB 43. The encoders 841 and 842 then each generate prediction images using reference images, and perform image encoding (prediction encoding) using these prediction images.

Accordingly, the encoders 841 and 842 can reference, in addition to decoded images obtained at itself, decoded images obtained at the other encoder.

Note however, the encoder 841 encodes the base view image, and accordingly only references a decoded image obtained at the encoder 841, as described above.

### Configuration Example of Encoder 842

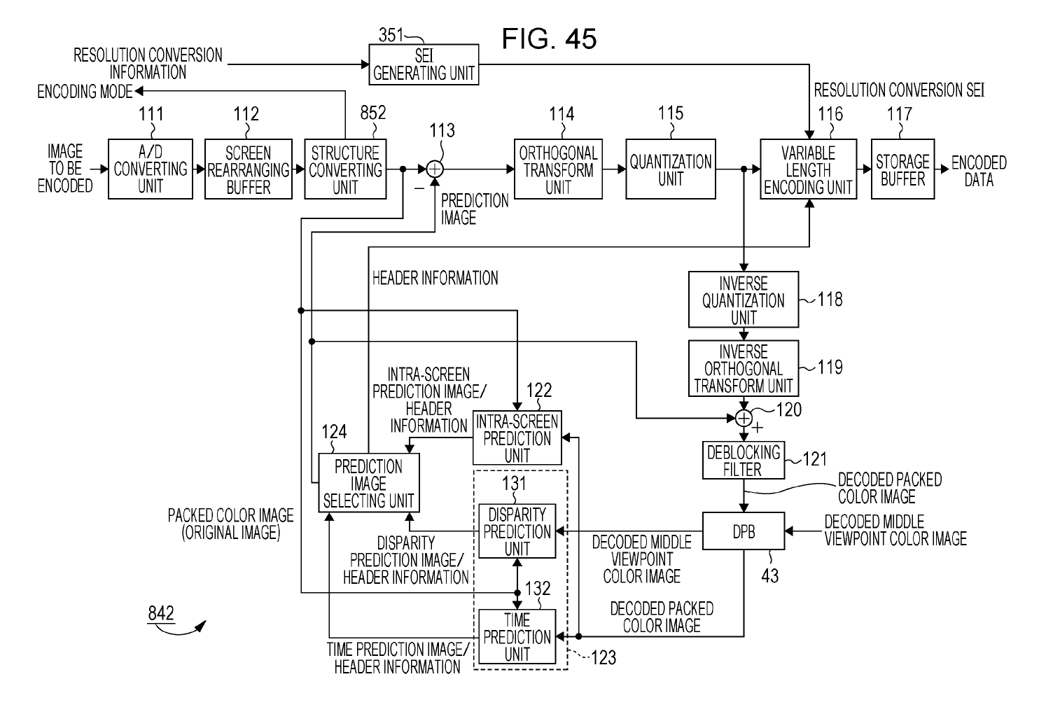

FIG. 45 is a block diagram illustrating a configuration example of the encoder 842 in FIG. 44.

Note that portions in the drawing corresponding to the case in FIG. 24 are denoted with the same symbols, and description hereinafter will be omitted as appropriate.

In FIG. 45, the encoder 842 has the A/D converting unit 111, screen rearranging buffer 112, computing unit 113, orthogonal transform unit 114, quantization unit 115, variable length encoding unit 116, storage buffer 117, inverse quantization unit 118, inverse orthogonal transform unit 119, computing unit 120, deblocking filter 121, intra-screen prediction unit 122, inter prediction unit 123, prediction image selecting unit 124, SEI generating unit 351, and a structure converting unit 852.

Accordingly, the encoder 842 has in common with the encoder 342 in FIG. 24 the point of having the A/D converting unit 111 through the prediction image selecting unit 124, and the SEI generating unit 351.

Note however, the encoder 842 differs from the encoder 342 in FIG. 24 with regard to the point that the structure converting unit 852 has been provided instead of the structure converting unit 352.

The structure converting unit 852 is provided to the output side of the screen rearranging buffer 112, and performs the same processing as with the structure converting unit 352 in FIG. 24.

Note however, that the structure converting unit 352 in FIG. 24 sets the encoding mode to the field encoding mode or frame encoding mode, based on the resolution conversion information from the resolution converting device 321C (FIG. 18), but the resolution converting unit 852 in FIG. 45 sets the encoding mode in accordance with user operations or the like, for example, other than resolution conversion information from the resolution converting device 721C (FIG. 43), and supplies that encoding mode to the resolution converting device 721C.

As described with FIG. 43, at the resolution converting device 721C, the packing pattern is decided in accordance with the encoding mode supplied from the encoder 842 (of the encoding device 722C), and the left viewpoint color image and right viewpoint color image included in the multi-viewpoint color image are packed following that packing pattern.

### Description of Computer to which the Present Technology has been Applied

The above-described series of processing may be executed by hardware, or may be executed by software. In the event of executing the series of processing by software, a program making up the software thereof is installed in a general-purpose computer or the like.

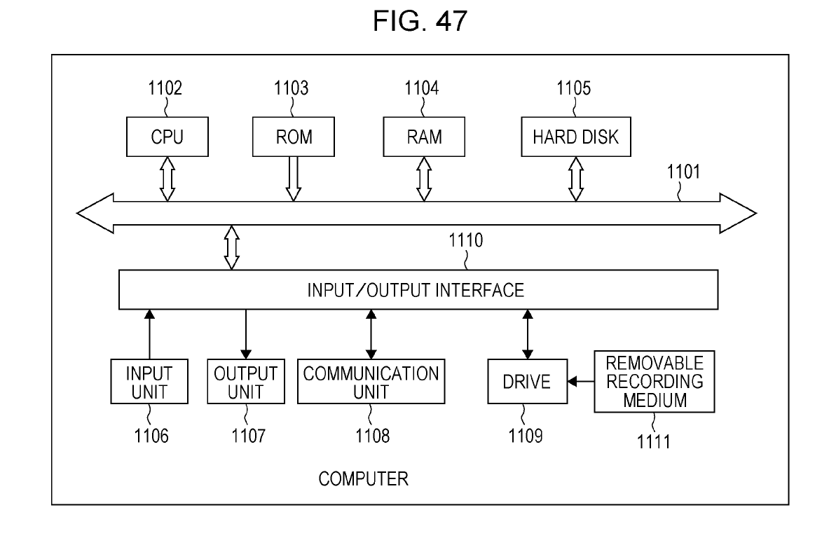

Accordingly, FIG. 47 illustrates a configuration example of an embodiment of a computer to which a program to execute the above-described series of the processing is installed.

The program can be recorded beforehand in a hard disk 1105 or ROM 1103 serving as a recording medium built into the computer.

Alternatively, the program may be stored in a removable recording medium 1111. Such a removable recording medium 1111 can be provided as so-called packaged software. Examples of the removable recording medium 1111 here include a flexible disk, CD-ROM (Compact Disc Read Only Memory), MO (Magneto Optical) disk, DVD (Digital Versatile Disc), magnetic disk, semiconductor memory, and so forth.

Note that besides from being installed in the computer from a removable recording medium 1111 such as described above, the program can be downloaded to the computer via a communication network or broadcast network, and installed in a built-in hard disk 1105. That is, the program can be wirelessly transmitted to the computer from a download site via satellite for digital satellite broadcasting, or transmitted to the computer over cable via a network such as a LAN (Local Area Network), or the Internet, for example.

The computer has a CPU (Central Processing Unit) 1102 built in, with an input/output interface 1110 connected to the CPU 1102 via a bus 1101.

Upon an instruction being input via the input/output interface 1110, by a user operating an input unit 1107 or the like, the CPU 1102 accordingly executes a program stored in ROM (Read Only Memory) 1103. Alternatively, the CPU 1102 loads a program stored in the hard disk 1105 to RAM (Random Access Memory) 1104 and executes this.

Accordingly, the CPU 1102 performs processing following the above-described flowcharts, or processing performed by the configuration of the block diagrams described above. The CPU 1102 then outputs the processing results from an output unit 1106, or transmits from a communication unit 1108, or further records in the hard disk 1105, or the like, via the input/output interface 1110, for example, as necessary.

Note that the input unit 1107 is configured of a keyboard, mouse, microphone, and so forth. Also, the output unit 1106 is configured of an LCD (Liquid Crystal Display) and speaker or the like.

Now, with the Present Specification, processing which the computer performs following the program does not necessarily have to be performed in the time sequence following the order described in the flowcharts. That is to say, the processing which the computer performs following the program includes processing executed in parallel or individually (e.g., parallel processing or object-oriented processing).

Also, the program may be processed by one computer (processor), or may be processed in a decentralized manner by multiple computers. Further, the program may be transferred to and executed by a remote computer.

The present technology may be applied to an image processing system used in communicating via network media such as cable TV (television), the Internet, and cellular phones or the like, or in processing on recording media such as optical or magnetic disks, flash memory, or the like.

Also note that at least part of the above-described image processing system may be applied to optionally selected electronic devices. The following is a description of examples thereof.

### Configuration Example of TV

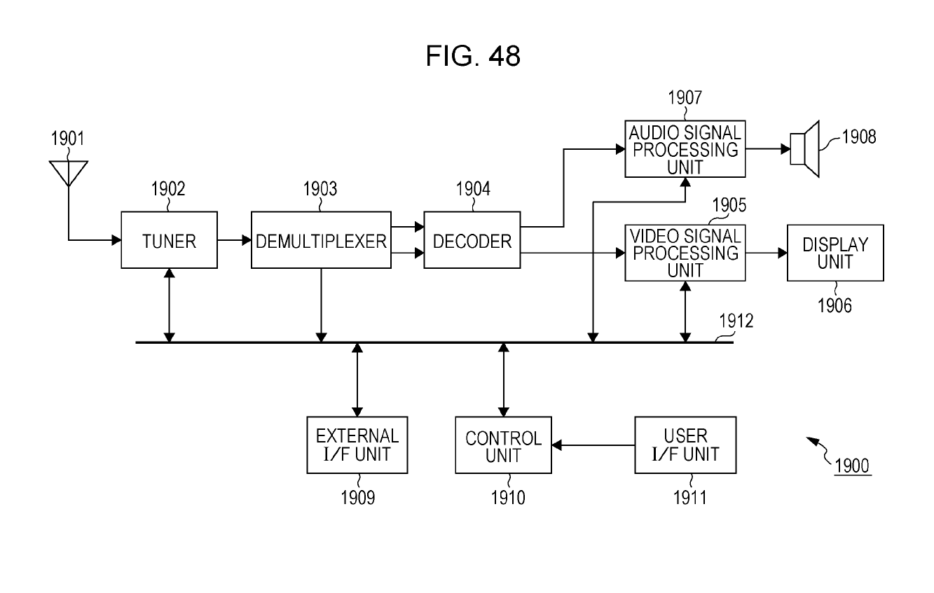

FIG. 48 shows an example of a schematic configuration of a TV to which the present technology has been applied.

The TV 1900 is configured of an antenna 1901, a tuner 1902, a demultiplexer 1903, a decoder 1904, an image signal processing unit 1905, a display unit 1906, an audio signal processing unit 1907, a speaker 1908, and an external interface unit 1909. The TV 1900 further has a control unit 1910, a user interface unit 1911, and so forth.

The tuner 1902 tunes to a desired channel from the broadcast signal received via the antenna 1901, and performs demodulation, and outputs an obtained encoded bit stream to the demultiplexer 1903.

The demultiplexer 1903 extracts packets of images and audio which are a program to be viewed, from the encoded bit stream, and outputs data of the extracted packets to the decoder 1904. Also, the demultiplexer 1903 supplies packets of data such as EPG (Electronic Program Guide) to the control unit 1910. Note that the demultiplexer or the like may perform descrambling when scrambled.

The decoder 1904 performs packet decoding processing, and outputs image data generated by decoding processing to the image signal processing unit 1905, and audio data to the audio signal processing unit 1907.

The image signal processing unit 1905 performs noise reduction and image processing according to user settings on the image data. The image signal processing unit 1905 generates image data of programs to display on the display unit 1906, image data according to processing based on applications supplied via a network, and so forth. Also, the image signal processing unit 1905 generates image data for displaying a menu screen or the like for selecting items or the like, and superimpose these on the program image data. The image signal processing unit 1905 performs generates driving signals based on the image data generated in this way, and drives the display unit 1906.

The display unit 1906 is driven by driving signals supplied from the image signal processing unit 1905, and drives a display device (e.g., liquid crystal display device or the like) to display images of the program and so forth.

The audio signal processing unit 1907 subjects audio data to predetermined processing such as noise removal and the like, performs D/A conversion processing and amplification processing on the processed audio data, and performs audio output by supplying to the speaker 1908.

The external interface unit 1909 is an interface to connect to external devices or a network, and performs transmission/reception of data such as image data, audio data, and so forth.

The user interface unit 1911 is connected to the control unit 1910. The user interface unit 1911 is configured of operating switches, a remote control signal receiver unit, and so forth, and supplies operating signals corresponding to user operations to the control unit 1910.

The control unit 1910 is configured of a CPU (Central Processing Unit), and memory and so forth. The memory stores programs to be executed by the CPU, various types of data necessary for the CPU to perform processing, EPG data, data acquired through a network, and so forth. Programs stored in the memory are read and executed by the CPU at a predetermined timing, such as starting up the TV 1900. The CPU controls each part such that the operation of the TV 1900 is according to user operations, by executing programs.

The TV 1900 is further provided with a bus 1912 connecting the tuner 1902, demultiplexer 1903, image signal processing unit 1905, audio signal processing unit 1907, external interface unit 1909, and so forth, with the control unit 1910.

With the TV 1900 thus configured, the decoder 1904 is provided with a function of the present technology.

### Configuration Example of Cellular Telephone

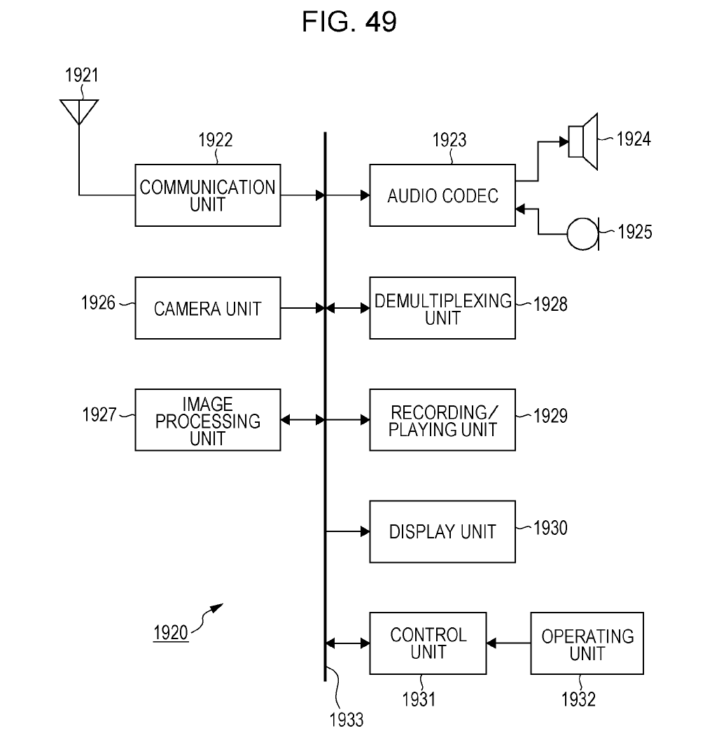

FIG. 49 is a diagram illustrating an example of a schematic configuration of the cellular telephone to which the present technology has been applied.

The cellular telephone 1920 is configured of a communication unit 1922, an audio codec 1923, a camera unit 1926, an image processing unit 1927, a multiplex separating unit 1928, a recording/playback unit 1929, a display unit 1930, and a control unit 1931. These are mutually connected via a bus 1933.

An antenna 1921 is connected to the communication unit 1922, and a speaker 1924 and a microphone 1925 are connected to the audio codec 1923. Further, an operating unit 1932 is connected to the control unit 1931.

The cellular telephone 1920 performs various operations such as transmission and reception of audio signals, transmission and reception of e-mails or image data, imaging of an image, recording of data, and so forth, in various operation modes including a voice call mode, a data communication mode, and so forth.

In voice call mode, the audio signal generated by the microphone 1925 is converted at the audio codec 1923 into audio data and subjected to data compression, and is supplied to the communication unit 1922. The communication unit 1922 performs modulation processing and frequency conversion processing and the like of the audio data, and generates transmission signals. The communication unit 1922 also supplies the transmission signals to the antenna 1921 so as to be transmitted to an unshown base station. The communication unit 1922 also performs amplifying, frequency conversion processing, demodulation processing, and so forth, of reception signals received at the antenna 1921, and supplies the obtained audio data to the audio codec 1923. The audio codec 1923 decompresses the audio data and performs conversion to analog audio signals, and outputs to the speaker 1924.

Also, in the data communication mode, in the event of performing e-mail transmission, the control unit 1931 accepts character data input by operations at the operating unit 1932, and displays the input characters on the display unit 1930. Also, the control unit 1931 generates e-mail data based on user instructions at the operating unit 1932 and so forth, and supplies to the communication unit 1922. The communication unit 1922 performs modulation processing and frequency conversion processing and the like of the e-mail data, and transmits the obtained transmission signals from the antenna 1921. Also, the communication unit 1922 performs amplifying and frequency conversion processing and demodulation processing and so forth as to reception signals received at the antenna 1921, and restores the e-mail data. This e-mail data is supplied to the display unit 1930 and the contents of the e-mail are displayed.

Note that cellular telephone 1920 may store received e-mail data in a recording medium at the recording/playback unit 1929. The storage medium may be any storage medium that is rewritable. For example, the storage medium may be semiconductor memory such as RAM or built-in flash memory, or a hard disk, a magnetic disk, magneto-optical disk, optical disc, USB memory, or a memory card or like removable media.

In the event of transmitting image data in the data communication mode, image data generated at the camera unit 1926 is supplied to the image processing unit 1927. The image processing unit 1927 performs encoding processing of the image data, and generates encoded data.

The multiplex separation unit 1928 multiplexes encoded data generated at the image processing unit 1927 and audio data supplied from the audio codec 1923, according to a predetermined format, supplies to the communication unit 1922. The communication unit 1922 performs modulation processing and frequency conversion processing and so forth of the multiplexed data, and transmits the obtained transmission signals from the antenna 1921. Also, the communication unit 1922 performs amplifying and frequency conversion processing and demodulation processing and so forth as to reception signals received at the antenna 1921, and restores the multiplexed data. This multiplexed data is supplied to the multiplex separation unit 1928. The multiplex separation unit 1928 separates the multiplexed data, and supplies the encoded data to the image processing unit 1927, and the audio data to the audio codec 1923. This image processing unit 1927 performs decoding processing of the encoded data and generates image data. This image data is supplied to the display unit 1930 and the received image is displayed. The audio codec 1923 converts the audio data into analog audio signals and supplies to the speaker 1924 to output the received audio.

With the cellular telephone device 1920 thus configured, the image processing unit 1927 is provided with a function of the present technology.

### Configuration Example of Recording/Playback Device

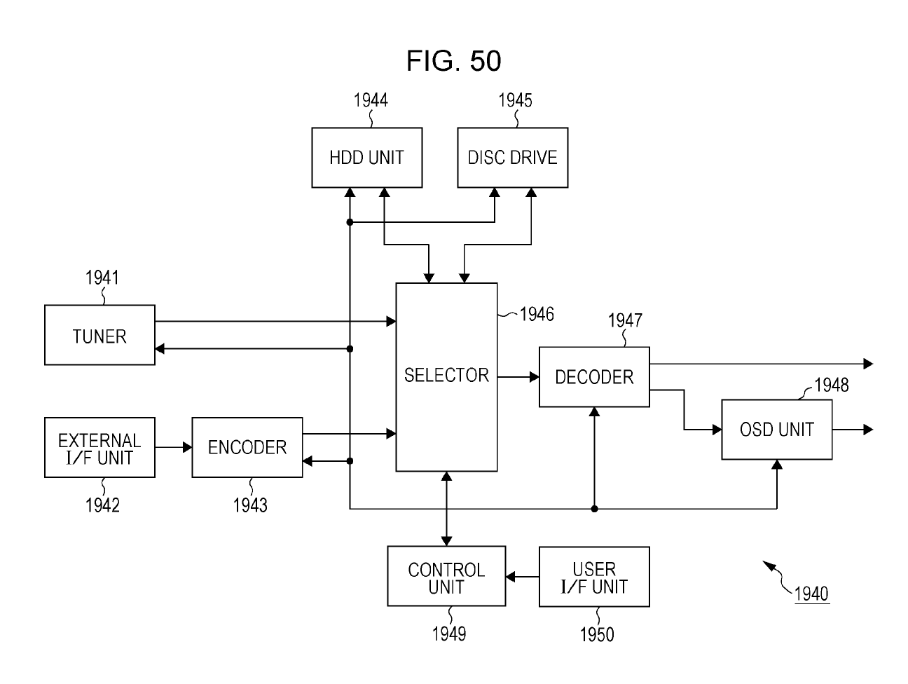

FIG. 50 is a diagram illustrating a schematic configuration example of a recording/playback device to which the present technology has been applied.

The recording/playback device 1940 records audio data and video data of a received broadcast program, for example, in a recording medium, and provide the recorded data to the user at a timing instructed by the user. Also, the recording/playback device 1940 may acquire audio data and video data from other devices, for example, and may record these to the recording medium. Further, the recording/playback device 1940 can decode and output audio data and video data recorded in the recording medium, so that image display and audio output can be performed at a monitor device or the like.

The recording/playback device 1940 includes a tuner 1941, an external interface unit 1942, an encoder 1943, an HDD (Hard Disk Drive) unit 1944, a disc drive 1945, a selector 1946, a decoder 1947, an OSD (On-Screen Display) unit 1948, a control unit 1949 and an user interface unit 1950.

The tuner 1941 tunes a desired channel from broadcast signals received via an unshown antenna. The tuner 1941 outputs to the selector 1946 an encoded bit stream obtained by demodulation of reception signals of a desired channel.

The external interface 1942 is configured of at least one of an IEEE1394 interface, network interface unit, USB interface, and flash memory interface or the like. The external interface unit 1942 is an interface to connect to external deices and network, memory cards, and so forth, and receives data such s image data and audio data and so forth to be recorded.

When the image data and audio data supplied from the external interface unit 1942 are not encoded, the encoder 1943 performs encoding with a predetermined format, and outputs an encoded bit stream to the selector 1946.

The HDD unit 1944 records content data of images and audio and so forth, various programs, other data, and so forth, an internal hard disk, and also reads these from the hard disk at the time of playback or the like.

The disc drive 1945 performs recording and playing of signals to and from the mounted optical disc. The optical disc, for example, DVD disc (DVD-Video, DVD-RAM, DVD-R, DVD-RW, DVD+R, DVD+RW or the like) or Blu-ray disc or the like.

The selector 1946 selects an encoded bit stream input either from the tuner 1941 or the encoder 1943 at the time of the recording of images and audio, and supplies to the HDD unit 1944 or the disc drive 1945. Also, the selector 1946 supplies the encoded bit stream output from the HDD unit 1944 or the disc drive 1945 to the decoder 1947 at the time of the playback of images or audio.

The decoder 1947 performs decoding processing of the encoded bit stream. The decoder 1947 supplies image data generated by performing decoding processing to the OSD unit 1948. Also, the decoder 1947 outputs audio data generated by performing decoding processing.

The OSD unit 1948 generates image data to display menu screen and the like of item selection and so forth, and superimposes on image data output from the decoder 1947, and outputs.

The user interface unit 1950 is connected to the control unit 1949. The user interface unit 1950 is configured of operating switches and a remote control signal reception unit and so forth, and operation signals in accordance with user operations are supplied to the control unit 1949.

The control unit 1949 is configured of a CPU and memory and so forth. The memory stores programs executed by the CPU, and various types of data necessary for the CPU to perform processing. Programs stored by memory are read out by the CPU at a predetermined timing, such as at the time of startup of the recording/playback device 1940, and executed. The CPU controls each part so that the operation of the recording/playback device 1940 is in accordance with the user operations, by executing the programs.

With the recording/playback device 1940 thus configured, the decoder 1947 is provided with a function of the present technology.

### Configuration Example of Imaging Apparatus

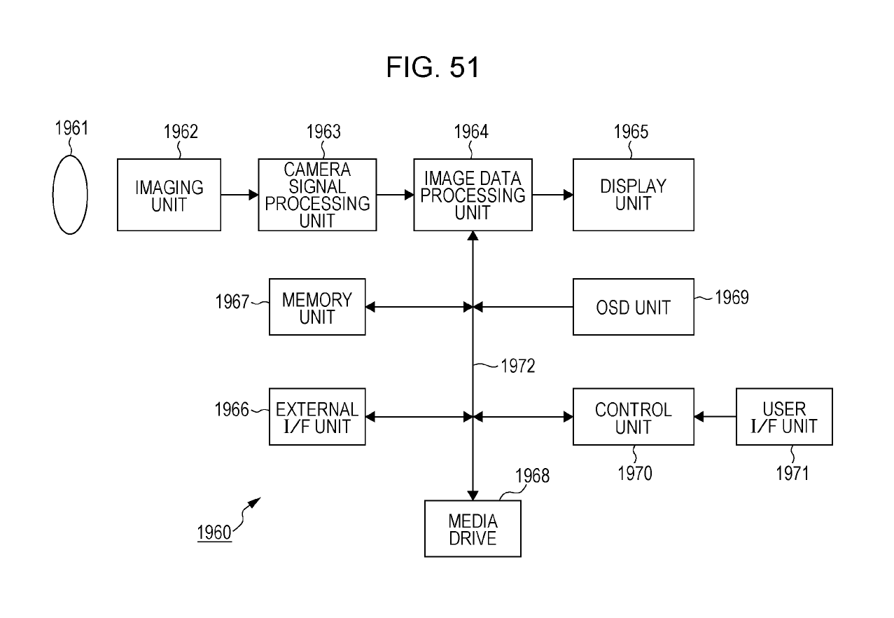

FIG. 51 is a diagram illustrating a schematic configuration example of an imaging apparatus to which the present technology has been applied.

The imaging apparatus 1960 images a subject, and displays an image of the subject on a display unit, or records this as image data to a recording medium.

The imaging apparatus 1960 is configured of an optical block 1961, an imaging unit 1962, a camera signal processing unit 1963, an image data processing unit 1964, a display unit 1965, an external interface unit 1966, a memory unit 1967, a media drive 1968, an OSD unit 1969, and a control unit 1970. Also, a user interface unit 1971 is connected to the control unit 1970. Further, the image data processing unit 1964, external interface unit 1966, memory unit 1967, media drive 1968, OSD unit 1969, control unit 1970, and so forth, are connected via a bus 1972.

The optical block 1961 is configured using a focusing lens and diaphragm mechanism and so forth. The optical block 1961 images an optical image of the subject on an imaging face of the imaging unit 1962. The imaging unit 1962 is configured of an image sensor such as a CCD or a CMOS, generates electric signals in accordance to a light image by photoelectric conversion, and supplies to the camera signal processing unit 1963.

The camera signal processing unit 1963 performs various kinds of camera signal processing such as KNEE correction, gamma correction, color correction, and so forth, on electric signals supplied from the imaging unit 1962. The camera signal processing unit 1963 supplies image data after the camera signal processing to the image data processing unit 1964.

The image data processing unit 1964 performs encoding processing on the image data supplied from the camera signal processing unit 1963. The image data processing unit 1964 supplies the encoded data generated by performing the encoding processing to the external interface unit 1966 or media drive 1968. Also, the image data processing unit 1964 performs decoding processing of encoded data supplied from the external interface unit 1966 or the media drive 1968. The image data processing unit 1964 supplies the image data generated by performing the decoding processing to the display unit 1965. Also, the image data processing unit 1964 performs processing of supplying image data supplied from the camera signal processing unit 1963 to the display unit 1965, and superimposes data for display acquired from the OSD unit 1969 on image data, and supplies to the display unit 1965.

The OSD unit 1969 generates data for display such as a menu screen or icons or the like, formed of symbols, characters, and shapes, and outputs to the image data processing unit 1964.

The external interface unit 1966 is configured, for example, as a USB input/output terminal, and connects to a printer at the time of printing of an image. Also, a drive is connected to the external interface unit 1966 as necessary, removable media such as a magnetic disk or an optical disc or the like is mounted on the drive as appropriate, and a computer program read out from the removable media is installed as necessary. Furthermore, the external interface unit 1966 has a network interface which is connected to a predetermined network such as a LAN or the Internet or the like. The control unit 1970 can read out encoded data from the memory unit 1967 following instructions from the user interface unit 1971, for example, and supply this to another device connected via network from the external interface unit 1966. Also, the control unit 1970 can acquire encoded data and image data supplied from another device via network by way of the external interface unit 1966, and supply this to the image data processing unit 1964.

For example, the recording medium driven by the media drive 1968 may be any readable/writable removable media, such as a magnetic disk, a magneto-optical disk, an optical disc, semiconductor memory, or the like. Also, for the recording media, the type of removable media is optional, and may be a tape device, or may be a disk, or may be a memory card. As a matter of course, this may be a contact-free IC card or the like.

Also, the media drive 1968 and recording media may be integrated, and configured of a non-portable storage medium, such as a built-in hard disk drive or SSD (Solid State Drive) or the like, for example.

The control unit 1970 is configured using CPU and memory and the like. The memory stores programs to be executed by the CPU, and various types of data necessary for the CPU to perform the processing. A program stored in memory is read out by the CPU at a predetermined timing such as at startup of the imaging apparatus 1960, and is executed. The CPU controls the parts as that the operations of the imaging apparatus 1960 correspond to the user operations, by executing the program.

With the imaging apparatus 1960 thus configured, the image data processing unit 1964 is provided with a function of the present technology.

Note that embodiments of the present technology are not restricted to the above-described embodiments, and that various modifications can be made without departing from the essence of the present technology.

That is to say, while an arrangement has been made with the present embodiment in which a filter (AIF) used for filter processing at the time of performing disparity prediction in decimal prediction is controlled at the MVC, thereby converting a reference image into a converted reference image of a resolution ratio matching the resolution ratio of an image to be encoded, but a dedicated interpolation filter may be provided for the filter used for conversion of the converted reference image, and performing filter processing on the reference image using the dedicated interpolation filter, thereby converting into a converted reference image.

Also, a converted reference image of a resolution ratio matching the resolution ratio of an image to be encoded includes, as a matter of course, a converted reference image where horizontal and vertical resolution matches the resolution of an image to be encoded.

Note that the present technology may assume the following configurations.

[1]

An image processing device, comprising:

a converting unit configured to convert images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded;

a compensating unit configured to generate a prediction image of the image to be encoded, by performing disparity compensation with the packed image converted by the converting unit as the image to be encoded or a reference image; and

an encoding unit configured to encode the image to be encoded in the encoding mode, using the prediction image generated by the compensating unit.

[2]

The image processing device according to [1], wherein, in the event that the encoding mode is a field encoding mode, the converting unit converts the images of two viewpoints into a packed image where the lines of the images of two viewpoints of which the resolution in the vertical direction has been made to be ½, are alternately arrayed.

[3]

The image processing device according to either [1] or [2], further comprising:

a deciding unit configured to decide the packing pattern in accordance with the encoding mode.

[4]

The image processing device according to any one of [1] through [3], further comprising:

a transmission unit configured to transmit information representing the packing pattern, and an encoded stream encoded by the encoding unit.

[5]

An image processing method, comprising the steps of:

converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded;

generating a prediction image of the image to be encoded, by performing disparity compensation with the packed image as the image to be encoded or a reference image; and

encoding the image to be encoded in the encoding mode, using the prediction image.

[6]

An image processing device, comprising:

a compensating unit configured to generate, by performing disparity compensation, a prediction image of an image to be decoded which is to be decoded, used to decode an encoded stream obtained by
converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded,
generating a prediction image of the image to be encoded, by performing disparity compensation with the packed image as the image to be encoded or a reference image, and
encoding the image to be encoded in the encoding mode, using the prediction image;

a decoding unit configured to decode the encoded stream in the encoding mode, using the prediction image generated by the compensating unit; and

an inverse converting unit configured to, in the event that the image to decode obtained by decoding the encoded stream by the decoding unit is a packed image, perform inverse conversion of the packed image into the original images of two viewpoints or more by separating following the packing pattern.

[7]

The image processing device according to [6], wherein, in the event that the encoding mode is a field encoding mode;

the packed image is one viewpoint worth of image where the lines of the images of two viewpoints of which the resolution in the vertical direction has been made to be ½, have been alternately arrayed;

and wherein the inverse converting unit performs inversion conversion of the packed image into the original images of two viewpoints.

[8]

The image processing device according to either [6] or [7], further comprising:

a reception unit configured to receive information representing the packing pattern, and the encoded stream encoded by the encoding unit.

[9]

An image processing method, comprising the steps of:

generating, by performing disparity compensation, a prediction image of an image to be decoded which is to be decoded, used to decode an encoded stream obtained by
converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded,
generating a prediction image of the image to be encoded, by performing disparity compensation with the packed image as the image to be encoded or a reference image, and
encoding the image to be encoded in the encoding mode, using the prediction image;

decoding the encoded stream in the encoding mode, using the prediction image; and

in the event that the image to decode obtained by decoding the encoded stream is a packed image, performing inverse conversion of the packed image into the original images of two viewpoints or more by separating following the packing pattern.

### REFERENCE SIGNS LIST

11 transmission device
12 reception device
21C, 21D resolution converting device
22C, 22D encoding device
23 multiplexing device
31 inverse multiplexing device
32C, 32D decoding device
33C, 33D resolution inverse converting device
41, 42 encoder
43 DPB
111 A/D converting unit
112 screen rearranging buffer
113 computing unit
114 orthogonal transform unit
115 quantization unit
116 variable length encoding unit
117 storage buffer
118 inverse quantization unit
119 inverse orthogonal transform unit
120 computing unit
121 deblocking filter
122 intra-screen prediction unit
123 inter prediction unit
124 prediction image selecting unit
131 disparity prediction unit
132 temporal prediction unit
141 disparity detecting unit
142 disparity compensation unit
143 prediction information buffer
144 cost function calculating unit
145 mode selecting unit
211, 212 decoder
213 DPB
241 storage buffer
242 variable length decoding unit
243 inverse quantization unit
244 inverse orthogonal transform unit
245 computing unit
246 deblocking filter
247 screen rearranging unit
248 D/A conversion unit
249 intra-screen prediction unit
250 inter prediction unit
251 prediction image selecting unit
260 reference index processing unit
261 disparity prediction unit
262 temporal prediction unit
272 disparity compensation unit
321C, 321D resolution converting device
322C, 322D encoding device
323 multiplexing device
332C, 332D decoding device
333C, 333D resolution inverse converting device
341, 342 encoder
351 SEI generating unit
352 structure converting unit
411, 412 decoder
451 structure inverse conversion unit
541, 542 encoder
611, 612 decoder
721C, 721D resolution converting device
722C, 722D encoding device
841, 842 encoder
852 structure converting unit
1101 bus
1103 ROM
1104 RAM
1105 hard disk
1106 output unit
1107 input unit
1108 communication unit
1109 drive
1110 input/output interface
1111 removable recording medium

1. An image processing device, comprising:
a converting unit configured to convert images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded;
a compensating unit configured to generate a prediction image of the image to be encoded, by performing disparity compensation with the packed image converted by the converting unit as the image to be encoded or a reference image; and
an encoding unit configured to encode the image to be encoded in the encoding mode, using the prediction image generated by the compensating unit.

2. The image processing device according to claim 1, wherein, in the event that the encoding mode is a field encoding mode, the converting unit converts the images of two viewpoints into a packed image where the lines of the images of two viewpoints of which the resolution in the vertical direction has been made to be ½, are alternately arrayed.

3. The image processing device according to claim 2, further comprising:
a deciding unit configured to decide the packing pattern in accordance with the encoding mode.

4. The image processing device according to claim 2, further comprising:
a transmission unit configured to transmit information representing the packing pattern, and an encoded stream encoded by the encoding unit.

5. An image processing method, comprising the steps of:
converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded;
generating a prediction image of the image to be encoded, by performing disparity compensation with the packed image as the image to be encoded or a reference image; and
encoding the image to be encoded in the encoding mode, using the prediction image.

6. An image processing device, comprising:
a compensating unit configured to generate, by performing disparity compensation, a prediction image of an image to be decoded which is to be decoded, used to decode an encoded stream obtained by
converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded,
generating a prediction image of the image to be encoded, by performing disparity compensation with the packed image as the image to be encoded or a reference image, and
encoding the image to be encoded in the encoding mode, using the prediction image;
a decoding unit configured to decode the encoded stream in the encoding mode, using the prediction image generated by the compensating unit; and
an inverse converting unit configured to, in the event that the image to decode obtained by decoding the encoded stream by the decoding unit is a packed image, perform inverse conversion of the packed image into the original images of two viewpoints or more by separating following the packing pattern.

7. The image processing device according to claim 6, wherein, in the event that the encoding mode is a field encoding mode;
the packed image is one viewpoint worth of image where the lines of the images of two viewpoints of which the resolution in the vertical direction has been made to be ½, have been alternately arrayed;
and wherein the inverse converting unit performs inversion conversion of the packed image into the original images of two viewpoints.

8. The image processing device according to claim 7, further comprising:
a reception unit configured to receive information representing the packing pattern, and the encoded stream encoded by the encoding unit.

9. An image processing method, comprising the steps of:
generating, by performing disparity compensation, a prediction image of an image to be decoded which is to be decoded, used to decode an encoded stream obtained by
converting images of two viewpoints or more, out of images of three viewpoints or more, into a packed image, by performing packing following a packing pattern in which images of two viewpoints or more are packed into one viewpoint worth of image, in accordance with an encoding mode at the time of encoding an image to be encoded which is to be encoded,
generating a prediction image of the image to be encoded, by performing disparity compensation with the packed image as the image to be encoded or a reference image, and
encoding the image to be encoded in the encoding mode, using the prediction image;
decoding the encoded stream in the encoding mode, using the prediction image; and
in the event that the image to decode obtained by decoding the encoded stream is a packed image, performing inverse conversion of the packed image into the original images of two viewpoints or more by separating following the packing pattern.
